(19) United States
(12) Patent Application Publication
(10) Pub. No.: US 2003/0003594 A1
(43) Pub. Date: Jan. 2, 2003

(54) Method for producing biochemical analysis data and scanner used therefor

(75) Inventor: Nobuhiko Ogura, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO. LTD.

(21) Appl. No.: 10/173,840

(22) Filed: Jun. 19, 2002

(30) Foreign Application Priority Data
Jun. 28, 2001 (JP) 2001-196065

(51) Int. Cl. G01N 21/76

(52) U.S. Cl. 436/172; 422/82.05; 422/82.08; 436/164; 436/165; 435/288.3; 435/288.4; 435/288.7; 250/458.1; 250/459.1; 250/461.2

(57) ABSTRACT

A method for producing biochemical analysis data by photoelectrically detecting light released from a plurality of light releasable regions two-dimensionally formed so as to be spaced apart from each other in a sample placed on a sample stage, the method for producing biochemical analysis data including the steps of intermittently moving a light guide member for leading light released from the plurality of light releasable regions to a light detector and the sample stage relative to each other in a main scanning direction and a sub-scanning direction perpendicular to the main scanning direction, leading light released from the plurality of light releasable regions two-dimensionally formed so as to be spaced apart from each other in the sample to a light detector through the light guide member, and photoelectrically detecting light by the light detector. According this method, it is possible to produce biochemical analysis data having high quantitative characteristics by detecting light emitted from a plurality of light releasable regions even in the case where the plurality of light releasable regions labeled with a labeling substance such as a radioactive labeling substance are formed in a biochemical analysis unit at a high density.

### BACKGROUND OF THE INVENTION

The present invention relates to a method for producing biochemical analysis data and a scanner used therefor and, particularly, to a method for producing biochemical analysis data and a scanner used therefor which can produce biochemical analysis data having high quantitative characteristics by photoelectrically detecting light emitted from a plurality of spot-like regions even in the case where the plurality of spot-like regions labeled with a labeling substance are formed in a biochemical analysis unit at high density.

### DESCRIPTION OF THE PRIOR ART

An autoradiographic analyzing system using as a detecting material for detecting radiation a stimulable phosphor which can absorb, store and record the energy of radiation when it is irradiated with radiation and which, when it is then stimulated by an electromagnetic wave having a specified wavelength, can release stimulated emission whose light amount corresponds to the amount of radiation with which it was irradiated is known, which comprises the steps of introducing a radioactively labeled substance into an organism, using the organism or a part of the tissue of the organism as a specimen, superposing the specimen and a stimulable phosphor sheet formed with a stimulable phosphor layer for a certain period of time, storing and recording radiation energy in a stimulable phosphor contained in the stimulable phosphor layer, scanning the stimulable phosphor layer with an electromagnetic wave to excite the stimulable phosphor, photoelectrically detecting the stimulated emission released from the stimulable phosphor to produce digital image signals, effecting image processing on the obtained digital image signals, and reproducing an image on displaying means such as a CRT or the like or a photographic film (see, for example, Japanese Patent Publication No. 1-60784, Japanese Patent Publication No. 1-60782, Japanese Patent Publication No. 4-3952 and the like).

There is further known chemiluminescence analysis system comprising the steps of employing, as a detecting material for light, a stimulable phosphor which can absorb and store the energy of light upon being irradiated therewith and release a stimulated emission whose amount is proportional to that of the received light upon being stimulated with an electromagnetic wave having a specific wavelength range, selectively labeling a fixed high molecular substance such as a protein or a nucleic acid sequence with a labeling substance which generates chemiluminescence emission when it contacts a chemiluminescent substance, contacting the high molecular substance selectively labeled with the labeling substance and the chemiluminescent substance, storing and recording the chemiluminescence emission in the wavelength of visible light generated by the contact of the chemiluminescent substance and the labeling substance in the stimulable phosphor contained in a stimulable phosphor layer formed on a stimulable phosphor sheet, scanning the stimulable phosphor layer with an electromagnetic wave to excite the stimulable phosphor, photoelectrically detecting the stimulated emission released from the stimulable phosphor to produce digital signals, effecting data processing on the obtained digital signals, and reproducing data on displaying means such as a CRT or a recording material such as a photographic film (see for example, U.S. Pat. No. 5,028,793, UK Patent Application 2,246,197 A and the like).

Unlike the system using a photographic film, according to these systems using the stimulable phosphor as a detecting material, development, which is chemical processing, becomes unnecessary. Further, it is possible reproduce a desired image by effecting image processing on the obtained image data and effect quantitative analysis using a computer. Use of a stimulable phosphor in these processes is therefore advantageous.

On the other hand, a fluorescence analyzing system using a fluorescent substance as a labeling substance instead of a radioactive labeling substance in the autoradiographic analyzing system is known. According to this system, it is possible to study a genetic sequence, study the expression level of a gene, and to effect separation or identification of protein or estimation of the molecular weight or properties of protein or the like. For example, this system can perform a process including the steps of distributing a plurality of DNA fragments on a gel support by means of electrophoresis after a fluorescent dye was added to a solution containing a plurality of DNA fragments to be distributed, or distributing a plurality of DNA fragments on a gel support containing a fluorescent dye, or dipping a gel support on which a plurality of DNA fragments have been distributed by means of electrophoresis in a solution containing a fluorescent dye, thereby labeling the electrophoresed DNA fragments, exciting the fluorescent dye by a stimulating ray to cause it to release fluorescence emission, detecting the released fluorescence emission to produce an image and detecting the distribution of the DNA fragments on the gel support. This system can also perform a process including the steps of distributing a plurality of DNA fragments on a gel support by means of electrophoresis, denaturing the DNA fragments, transferring at least a part of the denatured DNA fragments onto a transfer support such as a nitrocellulose support by the Southern-blotting method, hybridizing a probe prepared by labeling target DNA and DNA or RNA complementary thereto with the denatured DNA fragments, thereby selectively labeling only the DNA fragments complementary to the probe DNA or probe RNA, exciting the fluorescent dye by a stimulating ray to cause it to release fluorescence emission, detecting the released fluorescence emission to produce an image and detecting the distribution of the target DNA on the transfer support. This system can further perform a process including the steps of preparing a DNA probe complementary to DNA containing a target gene labeled by a labeling substance, hybridizing it with DNA on a transfer support, combining an enzyme with the complementary DNA labeled by a labeling substance, causing the enzyme to contact a fluorescent substance, transforming the fluorescent substance to a fluorescent substance having fluorescence emission releasing property, exciting the thus produced fluorescent substance by a stimulating ray to release fluorescence emission, detecting the fluorescence emission to produce an image and detecting the distribution of the target DNA on the transfer support. This fluorescence detecting system is advantageous in that a genetic sequence or the like can be easily detected without using a radioactive substance.

Similarly, there is known a chemiluminescence detecting system comprising the steps of fixing a substance derived from a living organism such as a protein or a nucleic acid sequence on a support, selectively labeling the substance derived from a living organism with a labeling substance which generates chemiluminescence emission when it contacts a chemiluminescent substrate, contacting the substance derived from a living organism and selectively labeled with the labeling substance and the chemiluminescent substrate, photoelectrically detecting the chemiluminescence emission in the wavelength of visible light generated by the contact of the chemiluminescent substrate and the labeling substance to produce digital image signals, effecting image processing thereon, and reproducing a chemiluminescent image on a display means such as a CRT or a recording material such as a photographic film, thereby obtaining information relating to the high molecular substance such as genetic information

Further, a micro-array analyzing system has been recently developed, which comprises the steps of using a spotting device to drop at different positions on the surface of a carrier such as a slide glass plate, a membrane filter or the like specific binding substances, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, thereby forming a number of independent spots, specifically binding the specific binding substances using a hybridization method or the like with a substance derived from a living organism such as a cell, virus, hormone, tumor marker, enzyme, antibody, antigen, abzyme, other protein, a nuclear acid, cDNA, DNA or mRNA by extraction, isolation or the like and optionally further subjected to chemical processing, chemical modification or the like and which is labeled with a labeling substance such as a fluorescent substance, dye or the like, thereby forming a micro-array, irradiating the micro-array with a stimulating ray, photoelectrically detecting light such as fluorescence emission released from a labeling substance such as a fluorescent substance, dye or the like, and analyzing the substance derived from a living organism. This micro-array analyzing system is advantageous in that a substance derived from a living organism can be analyzed in a short time period by forming a number of spots of specific binding substances at different positions of the surface of a carrier such as a slide glass plate at high density and hybridizing them with a substance derived from a living organism and labeled with a labeling substance.

In addition, a macro-array analyzing system using a radioactive labeling substance as a labeling substance has been further developed, which comprises the steps of using a spotting device to drop at different positions on the surface of a carrier such as a membrane filter or the like specific binding substances, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, thereby forming a number of independent spots, specifically binding the specific binding substance using a hybridization method or the like with a substance derived from a living organism such as a cell, virus, hormone, tumor marker, enzyme, antibody, antigen, abzyme, other protein, a nuclear acid, cDNA, DNA or mRNA by extraction, isolation or the like and optionally further subjected to chemical processing, chemical modification or the like and which is labeled with a radioactive labeling substance, thereby forming a macro-array, superposing the macro-array and a stimulable phosphor sheet formed with a stimulable phosphor layer, exposing the stimulable phosphor layer to a radioactive labeling substance, irradiating the stimulable phosphor layer with a stimulating ray to excite the stimulable phosphor, photoelectrically detecting the stimulated emission released from the stimulable phosphor to produce biochemical analysis data, and analyzing the substance derived from a living organism.

However, in the macro-array analyzing system using a radioactive labeling substance as a labeling substance, when the stimulable phosphor layer is exposed to a radioactive labeling substance, since the radiation energy of the radioactive labeling substance contained in spot-like regions formed on the surface of a carrier such as a membrane filter is very large, electron beams (β rays) released from the radioactive labeling substance contained in the individual spot-like regions are scattered in the carrier such as a membrane filter, thereby impinging on regions of the stimulable phosphor layer that should be exposed only to the radioactive labeling substance contained in neighboring spot-like regions, to generate noise in biochemical analysis data produced by photoelectrically detecting stimulated emission, thus making data of neighboring spot-like regions hard to separate and lowering resolution, and to lower the accuracy of biochemical analysis data when a substance derived from a living organism is analyzed by quantifying the radiation amount of each spot. The degradation of the resolution and accuracy of biochemical analysis is particularly pronounced when spots are formed close to each other at high density.

In order to solve these problems by preventing noise caused by the scattering of electron beams released from radioactive labeling substance contained in neighboring spot-like regions, it is inevitably required to increase the distance between neighboring spot-like regions and this makes the density of the spot-like regions lower and the test efficiency lower.

Furthermore, in the field of biochemical analysis, it is often required to analyze a substance derived from a living organism by forming a plurality of spot-like regions containing specific binding substances at different positions on the surface of a carrier such as a membrane filter or the like, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, specifically binding, using a hybridization method or the like, the specific binding substances contained in the plurality of spot-like regions with a substance derived from a living organism labeled with a labeling substance which generates chemiluminescence emission when it contacts a chemiluminescent substrate, thereby selectively labeling the plurality of spot-like regions, causing the plurality of spot-like regions to come into contact with a chemiluminescent substrate, exposing the stimulable phosphor layer of a stimulable phosphor sheet to chemiluminescence emission in the wavelength of visible light generated by the contact of the chemiluminescent substance and the labeling substance, thereby storing the energy of chemiluminescence emission in the stimulable phosphor layer, irradiating the stimulable phosphor layer with a stimulating ray, and photoelectrically detecting stimulated emission released from the stimulable phosphor layer, thereby effecting biochemical analysis. In this case, chemiluminescence emission released from any particular spot-like region is scattered in the carrier such as a membrane filter, thereby impinging on regions of the stimulable phosphor layer that should be exposed only to the chemiluminescence emission released from neighboring spot-like regions to generate noise in biochemical analysis data produced by photoelectrically detecting stimulated emission, thus making data of neighboring spot-like regions hard to separate and lowering resolution, and to lower the quantitative characteristics of biochemical analysis data.

Further, in the field of biochemical analysis, it is often required to analyze a substance derived from a living organism by forming a plurality of spot-like regions containing specific binding substances spot-like formed at different positions on the surface of a carrier such as a membrane filter or the like, which can specifically bind with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, specifically binding, using a hybridization method or the like, the specific binding substances contained in the plurality of spot-like regions with a substance derived from a living organism labeled with a labeling substance which generates chemiluminescence emission when it contacts a chemiluminescent substrate and/or a fluorescent substance, thereby selectively labeling the plurality of spot-like regions, and causing it to contact a chemiluminescent substrate, thereby photoelectrically detecting the chemiluminescence emission in the wavelength of visible light, or irradiating it with a stimulating ray, thereby photoelectrically detecting fluorescence emission released from a fluorescent substance. In these cases, chemiluminescence emission or fluorescence emission released from the plurality of spot-like regions is scattered in the carrier such as a membrane filter or chemiluminescence emission or fluorescence emission released from any particular spot-like region is scattered and mixed with chemiluminescence emission or fluorescence emission released from neighboring spot-like regions, thereby generating noise in biochemical analysis data produced by photoelectrically detecting chemiluminescence emission and/or fluorescence emission.

### SUMMARY OF THE INVENTION

It is therefore an object of the present invention to provide a method for producing biochemical analysis data and a scanner used therefor which can produce biochemical analysis data having high quantitative characteristics by photoelectrically detecting light emitted from a plurality of spot-like regions even in the case where the plurality of spot-like regions labeled with a labeling substance are formed in a biochemical analysis unit at high density.

The above other objects of the present invention can be accomplished by a method for producing biochemical analysis data by photoelectrically detecting light released from a plurality of light releasable regions two-dimensionally formed so as to be spaced apart from each other in a sample placed on a sample stage, the method for producing biochemical analysis data comprising the steps of intermittently moving a light guide member for leading light released from the plurality of light releasable regions to a light detector and the sample stage relative to each other in a main scanning direction and a sub-scanning direction perpendicular to the main scanning direction, leading light released from the plurality of light releasable regions two-dimensionally formed so as to be spaced apart from each other in the sample to a light detector through the light guide member, and photoelectrically detecting light by the light detector.

According to one application of the present invention, even in the case where a plurality of spot-like regions selectively labeled with a radioactive labeling substance are formed in a biochemical analysis unit such as a membrane filter at a high density, biochemical analysis data having high quantitative characteristics can be produced with high resolution by superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to a radioactive labeling substance contained in the plurality of spot-like regions while preventing electron beams (β rays) released from the radioactive labeling substance contained in any particular spot-like region from entering stimulable phosphor layer regions other than that to be exposed to electron beams (β rays) released from the radioactive labeling substance contained in the spot-like region, thereby storing radiation energy therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this application of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is considerably close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release radiation energy stored therein, biochemical analysis data having high quantitative characteristics can be produced with high resolution.

According to another application of the present invention, even in the case where a plurality of spot-like regions selectively labeled with a labeling substance which generates chemiluminescence emission when it contacts a chemiluminescent substrate are formed in a biochemical analysis unit such as a membrane filter at a high density, biochemical analysis data having high quantitative characteristics can be produced with high resolution by bringing the plurality of spot-like regions of the biochemical analysis unit into contact with a chemiluminescent substrate, thereby causing the spot-like regions to selectively release chemiluminescence emission, superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to chemiluminescence emission selectively released from the spot-like regions of the biochemical analysis unit while preventing chemiluminescence emission released from any particular spot-like region of the biochemical analysis unit from entering stimulable phosphor layer regions other than that to be exposed to chemiluminescence emission released from the spot-like region, thereby storing the energy of chemiluminescence emission therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this application of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release the energy of chemiluminescence emission stored therein, biochemical analysis data having high quantitative characteristics can be produced with high resolution.

According to a further application of the present invention, even in the case where a plurality of spot-like regions selectively labeled with a fluorescent substance such as a fluorescent dye are formed in a biochemical analysis unit such as a membrane filter at a high density, biochemical analysis data having high quantitative characteristics can be produced with high resolution by placing the biochemical analysis unit on the sample stage, sequentially irradiating the plurality of spot-like regions of the biochemical analysis unit with a stimulating ray while intermittently moving the light guide member and the sample stage relative to each other in a main scanning direction and a sub-scanning direction perpendicular to the main scanning direction, sequentially exciting a fluorescent substance contained the plurality of spot-like regions of the biochemical analysis unit, leading fluorescence emission released from the spot-like regions through the light guide member to the light detector, and photoelectrically detecting the fluorescence emission by the light detector.

More specifically, according to this application of the present invention, it is possible to reliably project a stimulating ray led through the light guide member onto only the spot-like region of the biochemical analysis unit to be irradiated therewith, excite a fluorescent substance contained in the spot-like regions to cause it to release fluorescence emission, receive fluorescence emission by the light receiving end portion of the light guide member to lead it to the light detector and photoelectrically detect fluorescence emission by the light detector by positioning the light guide member so that the light receiving end portion thereof is sufficiently close to the spot-like region when biochemical analysis data are to be produced by irradiating the plurality of spot-like regions two-dimensionally formed to be spaced apart from each other in the biochemical analysis unit with the stimulating ray to excite fluorescent substance contained in the spot-like regions and photoelectrically detecting fluorescence emission released from the spot-like regions. Therefore, since it is possible to effectively prevent a stimulating ray from impinging onto neighboring spot-like regions next to the spot-like region which should be irradiated with the stimulating ray and causing the spot-like regions to release fluorescence emission, biochemical analysis data having high quantitative characteristics can be produced with high resolution.

In a further application of the present invention, even in the case where a plurality of spot-like regions selectively labeled with a labeling substance which generates chemiluminescence emission when it contacts a chemiluminescent substrate are formed in a biochemical analysis unit such as a membrane filter at a high density, biochemical analysis data having high quantitative characteristics can be produced with high resolution by bringing the plurality of spot-like regions of the biochemical analysis unit into contact with a chemiluminescent substrate, thereby causing the spot-like regions to selectively release chemiluminescence emission, placing the biochemical analysis unit on the sample stage, intermittently moving the light guide member and the sample stage relative to each other in a main scanning direction and a sub-scanning direction perpendicular to the main scanning direction, sequentially leading chemiluminescence emission released from the plurality of spot-like regions of the biochemical analysis unit placed on the sample stage through the light guide member to the light detector, and photoelectrically detecting the chemiluminescence emission by the light detector.

More specifically, according to this application of the present invention, it is possible to reliably receive only chemiluminescence emission released from a spot-like region of the biochemical analysis unit and to be detected by the light detector, lead it to the light detector through the light guide member and photoelectrically detect it by the light detector by positioning the light guide member so that the light receiving end portion thereof is sufficiently close to the spot-like region when biochemical analysis data are to be produced by photoelectrically detecting chemiluminescence emission released from the spot-like regions of the biochemical analysis unit. Therefore, since it is possible to effectively prevent the light detector from photoelectrically detecting chemiluminescence emission released from neighboring spot-like regions next to the spot-like region which release chemiluminescence emission to be detected, biochemical analysis data having high quantitative characteristics can be produced with high resolution.

In a preferred aspect of the present invention, the light guide member has flexibility.

According to this preferred aspect of the present invention, since the light guide member has flexibility, it is possible to extremely easily move the light guide member in the main scanning direction and the sub-scanning direction and lead light released from the plurality of light releasable regions to the light detector through the light guide member, thereby photoelectrically detecting light to produce biochemical analysis data.

In a preferred aspect of the present invention, the light guide member is formed of at least one optical fiber.

In a further preferred aspect of the present invention, the light guide member is formed of a bundle of optical fibers.

In a preferred aspect of the present invention, the sample is regularly formed with the plurality of light releasable regions at a predetermined pitch in the main scanning direction and the sub-scanning direction and the method for producing biochemical data comprises the step of intermittently moving the light guide member and the sample stage relative to each other by the predetermined pitch to photoelectrically detect light released from the plurality of light releasable regions two-dimensionally formed to be spaced form each other in the sample, thereby producing biochemical analysis data.

In a further preferred aspect of the present invention, the method for producing biochemical data comprises the step of moving the light guide member in the main scanning direction and the sub-scanning direction to photoelectrically detect light released from the plurality of light releasable regions two-dimensionally formed to be spaced form each other in the sample, thereby producing biochemical analysis data.

In another preferred aspect of the present invention, the method for producing biochemical data comprises the step of moving the light guide member in the main scanning direction and the sample stage in the sub-scanning direction to photoelectrically detect light released from the plurality of light releasable regions two-dimensionally formed to be spaced form each other in the sample, thereby producing biochemical analysis data.

In another preferred aspect of the present invention, the method for producing biochemical data comprises the step of moving the light guide member in the sub-scanning direction and the sample stage in the main scanning direction to photoelectrically detect light released from the plurality of light releasable regions two-dimensionally formed to be spaced form each other in the sample, thereby producing biochemical analysis data.

In a preferred aspect of the present invention, the sample is constituted as a stimulable phosphor including a support two-dimensionally formed with a plurality of stimulable phosphor layer regions spaced apart from each other and selectively storing radiation energy and the method for producing biochemical data comprises the steps of leading a stimulating ray through the light guide member, irradiating the individual stimulable phosphor layer regions with the stimulating ray, leading stimulated emission released from the individual stimulable phosphor layer regions through the light guide member to the light detector and photoelectrically detecting the stimulated emission by the light detector to produce biochemical analysis data.

According to this preferred aspect of the present invention, even in the case where a plurality of spot-like regions selectively labeled with a radioactive labeling substance are formed in a biochemical analysis unit such as a membrane filter at a high density, biochemical analysis data having high quantitative characteristics can be produced with high resolution by superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to a radioactive labeling substance contained in the plurality of spot-like regions while preventing electron beams (β rays) released from the radioactive labeling substance contained in any particular spot-like region from entering stimulable phosphor layer regions other than that to be exposed to electron beams (β rays) released from the radioactive labeling substance contained in the spot-like region, thereby storing radiation energy therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this preferred aspect of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release radiation energy stored therein, biochemical analysis data having high quantitative characteristics can be produced with high resolution.

In a further preferred aspect of the present invention, radiation energy is selectively stored in the plurality of stimulable phosphor layer regions of the stimulable phosphor sheet by forming a plurality of spot-like regions selectively containing a radioactive labeling substance and spaced apart from each other in a biochemical analysis unit in the same pattern as that of the plurality of stimulable phosphor layer regions formed in the stimulable phosphor sheet, superposing the stimulable phosphor sheet on the biochemical analysis unit in such a manner that each of the plurality of stimulable phosphor layer regions formed in the stimulable phosphor sheet faces the corresponding spot-like region of the biochemical analysis unit, and exposing the plurality of stimulable phosphor layer regions of the stimulable phosphor sheet to a radioactive labeling substance selectively contained in the plurality of spot-like regions of the biochemical analysis unit.

In a further preferred aspect of the present invention, radiation energy is selectively stored in the plurality of stimulable phosphor layer regions of the stimulable phosphor sheet by spotting a solution containing specific binding substances which can specifically bind with a substance derived from a living organism and whose sequence, base length, composition and the like are known onto the biochemical analysis unit to form a plurality of spot-like regions spaced apart from each other in the biochemical analysis unit in the same pattern as that of the plurality of stimulable phosphor layer regions formed in the stimulable phosphor sheet, specifically binding a substance derived from a living organism and labeled with a radioactive labeling substance with specific binding substances contained in the plurality of spot-like regions of the biochemical analysis unit, thereby selectively labeling the plurality of spot-like regions with a radioactive labeling substance, superposing the stimulable phosphor sheet on the biochemical analysis unit in such a manner that each of the plurality of stimulable phosphor layer regions formed in the stimulable phosphor sheet faces the corresponding spot-like region of the biochemical analysis unit, and exposing the plurality of stimulable phosphor layer regions of the stimulable phosphor sheet to a radioactive labeling substance selectively contained in the plurality of spot-like regions of the biochemical analysis unit.

In a preferred aspect of the present invention, the sample is constituted as a stimulable phosphor including a support two-dimensionally formed with a plurality of stimulable phosphor layer regions spaced apart from each other and selectively storing the energy of chemiluminescence emission and the method for producing biochemical data comprises the steps of leading a stimulating ray through the light guide member, irradiating the individual stimulable phosphor layer regions with the stimulating ray, leading stimulated emission released from the individual stimulable phosphor layer regions through the light guide member to the light detector and photoelectrically detecting the stimulated emission by the light detector to produce biochemical analysis data.

According to this preferred aspect of the present invention, even in the case where a plurality of spot-like regions selectively labeled with a labeling substance which generates chemiluminescence emission when it contacts a chemiluminescent substrate are formed in a biochemical analysis unit such as a membrane filter at a high density, biochemical analysis data having high quantitative characteristics can be produced with high resolution by bringing the plurality of spot-like regions of the biochemical analysis unit into contact with a chemiluminescent substrate, thereby causing the spot-like regions to selectively release chemiluminescence emission, superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to chemiluminescence emission selectively released from the spot-like regions of the biochemical analysis unit while preventing chemiluminescence emission released from any particular spot-like region of the biochemical analysis unit from entering stimulable phosphor layer regions other than that to be exposed to chemiluminescence emission released from the spot-like region, thereby storing the energy of chemiluminescence emission therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this preferred aspect of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release the energy of chemiluminescence emission stored therein, biochemical analysis data having high quantitative characteristics can be produced with high resolution.

In a further preferred aspect of the present invention, the energy of chemiluminescence emission is selectively stored in the plurality of stimulable phosphor layer regions of the stimulable phosphor sheet by forming a plurality of spot-like regions selectively containing a labeling substance which generates chemiluminescence emission when it contacts a chemiluminescent substrate and spaced apart from each other in a biochemical analysis unit in the same pattern as that of the plurality of stimulable phosphor layer regions formed in the stimulable phosphor sheet, bringing the plurality of spot-like regions of the biochemical analysis unit into contact with a chemiluminescent substrate, thereby causing the spot-like regions of the biochemical analysis unit to selectively release chemiluminescence emission, superposing the stimulable phosphor sheet on the biochemical analysis unit in such a manner that each of the plurality of stimulable phosphor layer regions formed in the stimulable phosphor sheet faces the corresponding spot-like region of the biochemical analysis unit, and exposing the plurality of stimulable phosphor layer regions of the stimulable phosphor sheet to chemiluminescence emission selectively released from the plurality of spot-like regions of the biochemical analysis unit.

In a further preferred aspect of the present invention, radiation energy is selectively stored in the plurality of stimulable phosphor layer regions of the stimulable phosphor sheet by spotting a solution containing specific binding substances which can specifically bind with a substance derived from a living organism and whose sequence, base length, composition and the like are known onto the biochemical analysis unit to form a plurality of spot-like regions spaced apart from each other in the biochemical analysis unit in the same pattern as that of the plurality of stimulable phosphor layer regions formed in the stimulable phosphor sheet, specifically binding a substance derived from a living organism and labeled with a labeling substance which generates chemiluminescence emission when it contacts a chemiluminescent substrate with specific binding substances contained in the plurality of spot-like regions of the biochemical analysis unit, thereby selectively labeling the plurality of spot-like regions with a labeling substance which generates chemiluminescence emission when it contacts a chemiluminescent substrate, bringing the plurality of spot-like regions of the biochemical analysis unit into contact with a chemiluminescent substrate, thereby causing the spot-like regions of the biochemical analysis unit to selectively release chemiluminescence emission, superposing the stimulable phosphor sheet on the biochemical analysis unit in such a manner that each of the plurality of stimulable phosphor layer regions formed in the stimulable phosphor sheet faces the corresponding spot-like region of the biochemical analysis unit, and exposing the plurality of stimulable phosphor layer regions of the stimulable phosphor sheet to chemiluminescence emission selectively released from the plurality of spot-like regions of the biochemical analysis unit.

In a preferred aspect of the present invention, the support of the stimulable phosphor sheet has a property of attenuating light energy.

According to this preferred aspect of the present invention, since the support of the stimulable phosphor sheet has a property of attenuating light energy, it is possible to effectively prevent a stimulating ray from scattering in the support of the stimulable phosphor sheet, entering a stimulable phosphor layer region to be next irradiated with a stimulating ray to excite stimulable phosphor contained therein and causing the stimulable phosphor to release radiation energy or the energy of chemiluminescence emission. Therefore, biochemical analysis data having high quantitative characteristics can be produced with high resolution by scanning the plurality of stimulable phosphor layer regions of the stimulable phosphor sheet selectively exposed to a radioactive labeling substance or chemiluminescence emission with a stimulating ray and photoelectirically detecting stimulated emission released from the plurality of stimulable phosphor layer regions.

Further, according to this preferred aspect of the present invention, since the support of the stimulable phosphor sheet has a property of attenuating light energy, it is possible to effectively prevent stimulated emission released from any particular stimulable phosphor layer region in response to the excitation of stimulable phosphor with a stimulating ray from scattering in the support of the stimulable phosphor sheet and being mixed with stimulated emission released from neighboring stimulable phosphor layer regions. Therefore, biochemical analysis data having high quantitative characteristics can be produced with high resolution by scanning the plurality of stimulable phosphor layer regions of the stimulable phosphor sheet selectively exposed to a radioactive labeling substance or chemiluminescence emission with a stimulating ray and photoelectirically detecting stimulated emission released from the plurality of stimulable phosphor layer regions.

In a preferred aspect of the present invention, the support of the stimulable phosphor sheet has a property of reducing the energy of light to ⅕ or less when the light travels in the support by a distance equal to that between neighboring stimulable phosphor layer regions.

In a further preferred aspect of the present invention, the support of the stimulable phosphor sheet has a property of reducing the energy of light to 1/10 or less when the light travels in the support by a distance equal to that between neighboring stimulable phosphor layer regions.

In a further preferred aspect of the present invention, the support of the stimulable phosphor sheet has a property of reducing the energy of light to 1/50 or less when the light travels in the support by a distance equal to that between neighboring stimulable phosphor layer regions.

In a further preferred aspect of the present invention, the support of the stimulable phosphor sheet has a property of reducing the energy of light to 1/100 or less when the light travels in the support by a distance equal to that between neighboring stimulable phosphor layer regions.

In a further preferred aspect of the present invention, the support of the stimulable phosphor sheet has a property of reducing the energy of light to 1/500 or less when the light travels in the support by a distance equal to that between neighboring stimulable phosphor layer regions.

In a further preferred aspect of the present invention, the support of the stimulable phosphor sheet has a property of reducing the energy of light to 1/1,000 or less when the light travels in the support by a distance equal to that between neighboring stimulable phosphor layer regions.

In a preferred aspect of the present invention, the support of the stimulable phosphor sheet has a property of attenuating radiation energy.

According to this preferred aspect of the present invention, since the support of the stimulable phosphor sheet has a property of attenuating radiation energy, when the stimulable phosphor sheet is superposed on the biochemical analysis unit so that the plurality of stimulable phosphor layer regions formed in the stimulable phosphor sheet are exposed to a radioactive labeling substance selectively contained in the plurality of spot-like regions of the biochemical analysis unit, electron beams (β rays) released from the radioactive labeling substance contained in the individual spot-like regions can be effectively prevented from scattering in the support of the stimulable phosphor sheet and entering stimulable phosphor layer regions other than that to be exposed to electron beams (β rays) released from the radioactive labeling substance contained in the spot-like region and, therefore, it is possible to produce biochemical analysis data having an excellent quantitative characteristic with high resolution by scanning the plurality of the thus exposed stimulable phosphor layer regions with a stimulating ray and photoelectrically detecting stimulated emission released from the plurality of stimulable phosphor layer regions.

In a preferred aspect of the present invention, the support of the stimulable phosphor sheet has a property of reducing the radiation energy to ⅕ or less when the radiation travels in the support by a distance equal to that between neighboring stimulable phosphor layer regions.

In a further preferred aspect of the present invention, the support of the stimulable phosphor sheet has a property of reducing the radiation energy to 1/10 or less when the radiation travels in the support by a distance equal to that between neighboring stimulable phosphor layer regions.

In a further preferred aspect of the present invention, the support of the stimulable phosphor sheet has a property of reducing the radiation energy to 1/50 or less when the radiation travels in the support by a distance equal to that between neighboring stimulable phosphor layer regions.

In a further preferred aspect of the present invention, the support of the stimulable phosphor sheet has a property of reducing the radiation energy to 1/100 or less when the radiation travels in the support by a distance equal to that between neighboring stimulable phosphor layer regions.

In a further preferred aspect of the present invention, the support of the stimulable phosphor sheet has a property of reducing the radiation energy to 1/500 or less when the radiation travels in the support by a distance equal to that between neighboring stimulable phosphor layer regions.

In a further preferred aspect of the present invention, the support of the stimulable phosphor sheet has a property of reducing the radiation energy to 1/1,000 or less when the radiation travels in the support by a distance equal to that between neighboring stimulable phosphor layer regions.

In the present invention, the material for forming the support of the stimulable phosphor sheet is preferably capable of attenuating radiation energy and/or light energy but is not particularly limited. The material for forming the support of the stimulable phosphor sheet may be any type of inorganic compound material or organic compound material and the support of the stimulable phosphor sheet can preferably be formed of a metal material, a ceramic material or a plastic material.

Illustrative examples of inorganic compound materials preferably usable for forming the support of the stimulable phosphor sheet in the present invention include metals such as gold, silver, copper, zinc, aluminum, titanium, tantalum, chromium, iron, nickel, cobalt, lead, tin, selenium and the like; alloys such as brass, stainless steel, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. These may have either a monocrystal structure or a polycrystal sintered structure such as amorphous, ceramic or the like.

In the present invention, a high molecular compound can preferably be used as an organic compound material preferably usable for forming the support of the stimulable phosphor sheet. Illustrative examples of high molecular compounds preferably usable for forming the support of the stimulable phosphor sheet in the present invention include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifuluoroethylene; polycarbonate; polyesters such as polyethylene naphthalate, polyethylene terephthalate and the like; nylons such as nylon-6, nylon-6,6, nylon-4,10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials. These may be a composite compound, and metal oxide particles, glass fiber or the like may be added thereto as occasion demands. Further, an organic compound material may be blended therewith.

Since the capability of attenuating light energy generally increases as scattering and/or absorption of light increases, the support of the stimulable phosphor sheet preferably has absorbance of 0.3 per cm (thickness) or more and more preferably has absorbance of 1 per cm (thickness) or more. The absorbance can be determined by placing an integrating sphere immediately behind a plate-like member having a thickness of T cm, measuring an amount A of transmitted light at a wavelength of probe light or emission light used for measurement by a spectrophotometer, and calculating A/T. In the present invention, a light scattering substance or a light absorbing substance may be added to the support of the stimulable phosphor sheet in order to improve the capability of attenuating light energy. Particles of a material different from a material forming the support of the stimulable phosphor sheet may be preferably used as a light scattering substance and a pigment or dye may be preferably used as a light absorbing substance.

Since the capability of attenuating radiation energy generally increases as specific gravity increases, the support of the stimulable phosphor sheet is preferably formed of a compound material or a composite material having specific gravity of 1.0 g/cm³ or more and more preferably formed of a compound material or a composite material having specific gravity of 1.5 g/cm³ to 23 g/cm³.

In a preferred aspect of the present invention, the plurality of stimulable phosphor layer regions of the stimulable phosphor sheet are formed in holes formed in the support.

In a preferred aspect of the present invention, the plurality of stimulable phosphor layer regions of the stimulable phosphor sheet are formed by charging stimulable phosphor in holes formed in the support.

In a further preferred aspect of the present invention, the plurality of stimulable phosphor layer regions of the stimulable phosphor sheet are formed by charging stimulable phosphor in through-holes formed in the support.

In a further preferred aspect of the present invention, the plurality of stimulable phosphor layer regions of the stimulable phosphor sheet are formed by embedding stimulable phosphor in through-holes formed in the support.

In a further preferred aspect of the present invention, the plurality of stimulable phosphor layer regions of the stimulable phosphor sheet are formed by pressing a stimulable phosphor membrane containing stimulable phosphor in through-holes formed in the support.

In another preferred aspect of the present invention, the plurality of stimulable phosphor layer regions of the stimulable phosphor sheet are formed by charging stimulable phosphor in recesses formed in the support.

In a further preferred aspect of the present invention, the plurality of stimulable phosphor layer regions of the stimulable phosphor sheet are formed by embedding stimulable phosphor in recesses formed in the support.

In another preferred aspect of the present invention, the plurality of stimulable phosphor layer regions of the stimulable phosphor sheet are formed on the surface of the support.

In a preferred aspect of the present invention, the support of the stimulable phosphor sheet is formed with 10 or more stimulable phosphor layer regions.

In a further preferred aspect of the present invention, the support of the stimulable phosphor sheet is formed with 50 or more stimulable phosphor layer regions.

In a further preferred aspect of the present invention, the support of the stimulable phosphor sheet is formed with 100 or more stimulable phosphor layer regions.

In a further preferred aspect of the present invention, the support of the stimulable phosphor sheet is formed with 500 or more stimulable phosphor layer regions.

In a further preferred aspect of the present invention, the support of the stimulable phosphor sheet is formed with 1,000 or more stimulable phosphor layer regions.

In a further preferred aspect of the present invention, the support of the stimulable phosphor sheet is formed with 5,000 or more stimulable phosphor layer regions.

In a further preferred aspect of the present invention, the support of the stimulable phosphor sheet is formed with 10,000 or more stimulable phosphor layer regions.

In a further preferred aspect of the present invention, the support of the stimulable phosphor sheet is formed with 50,000 or more stimulable phosphor layer regions.

In a further preferred aspect of the present invention, the support of the stimulable phosphor sheet is formed with 10,0000 or more stimulable phosphor layer regions.

In a preferred aspect of the present invention, each of the plurality of stimulable phosphor layer regions is formed in the stimulable phosphor sheet to have a size of less than 5 mm².

In a further preferred aspect of the present invention, each of the plurality of stimulable phosphor layer regions is formed in the stimulable phosphor sheet to have a size of less than 1 mm².

In a further preferred aspect of the present invention, each of the plurality of stimulable phosphor layer regions is formed in the stimulable phosphor sheet to have a size of less than 0.5 mm².

In a further preferred aspect of the present invention, each of the plurality of stimulable phosphor layer regions is formed in the stimulable phosphor sheet to have a size of less than 0.1 mm².

In a further preferred aspect of the present invention, each of the plurality of stimulable phosphor layer regions is formed in the stimulable phosphor sheet to have a size of less than 0.05 mm².

In a further preferred aspect of the present invention, each of the plurality of stimulable phosphor layer regions is formed in the stimulable phosphor sheet to have a size of less than 0.01 mm².

In the present invention, the density of the stimulable phosphor layer regions formed in the stimulable phosphor sheet can be determined based upon the material of the support, the kind of electron beam released from the radioactive labeling substance and the like.

In a preferred aspect of the present invention, the plurality of stimulable phosphor layer regions are formed in the stimulable phosphor sheet at a density of 10 or more per cm².

In a further preferred aspect of the present invention, the plurality of stimulable phosphor layer regions are formed in the stimulable phosphor sheet at a density of 50 or more per cm².

In a further preferred aspect of the present invention, the plurality of stimulable phosphor layer regions are formed in the stimulable phosphor sheet at a density of 100 or more per cm².

In a further preferred aspect of the present invention, the plurality of stimulable phosphor layer regions are formed in the stimulable phosphor sheet at a density of 500 or more per cm².

In a further preferred aspect of the present invention, the plurality of stimulable phosphor layer regions are formed in the stimulable phosphor sheet at a density of 1,000 or more per cm².

In a further preferred aspect of the present invention, the plurality of stimulable phosphor layer regions are formed in the stimulable phosphor sheet at a density of 5,000 or more per cm².

In a further preferred aspect of the present invention, the plurality of stimulable phosphor layer regions are formed in the stimulable phosphor sheet at a density of 10,000 or more per cm².

In a further preferred aspect of the present invention, the plurality of stimulable phosphor layer regions are formed in the stimulable phosphor sheet at a density of 50,000 or more per cm².

In a further preferred aspect of the present invention, the plurality of stimulable phosphor layer regions are formed in the stimulable phosphor sheet at a density of 100,000 or more per cm².

In the present invention, the stimulable phosphor usable for storing radiation energy may be of any type insofar as it can store radiation energy or electron beam energy and can be stimulated by an electromagnetic wave to release the radiation energy or the electron beam energy stored therein in the form of light. More specifically, preferably employed stimulable phosphors include alkaline earth metal fluorohalide phosphors (Ba₁₋ₓ, M²⁺ₓ)FX:yA (where M²⁺ is at least one alkaline earth metal selected from the group consisting of Mg, Ca, Sr, Zn and Cd; X is at least one element selected from the group consisting of Cl, Br and I, A is at least one element selected from the group consisting of Eu, Tb, Ce, Tm, Dy, Pr, Ho, Nd, Yb and Er; x is equal to or greater than 0 and equal to or less than 0.6 and y is equal to or greater than 0 and equal to or less than 0.2) disclosed in U.S. Pat. No. 4,239,968, alkaline earth metal fluorohalide phosphors SrFX:Z (where X is at least one halogen selected from the group consisting of Cl, Br and I; Z is at least one of Eu and Ce) disclosed in Japanese Patent Application Laid Open No. 2-276997, europium activated complex halide phosphors BaFXxNaX′:aEu²⁺ (where each of X or X′ is at least one halogen selected from the group consisting of Cl, Br and I; x is greater than 0 and equal to or less than 2; and y is greater than 0 and equal to or less than 0.2) disclosed in Japanese Patent Application Laid Open No. 59-56479, cerium activated trivalent metal oxyhalide phosphors MOX:xCe (where M is at least one trivalent metal selected from the group consisting of Pr, Nd, Pm, Sm, Eu, Tb, Dy, Ho, Er, Tm, Yb and Bi; X is at least one halogen selected from the group consisting of Br and I; and x is greater than 0 and less than 0.1) disclosed in Japanese Patent Application laid Open No. 58-69281, cerium activated rare earth oxyhalide phosphors LnOX:xCe (where Ln is at least one rare earth element selected from the group consisting of Y, La, Gd and Lu; X is at least one halogen selected from the group consisting of Cl, Br and I; and x is greater than 0 and equal to or less than 0.1) disclosed in U.S. Pat. No. 4,539,137, and europium activated complex halide phosphors M^{II}FXaM^{I}X′bM′^{II}X″₂CM^{III}X′″₃XA:yEu²⁺ (where M^{II} is at least one alkaline earth metal selected from the group consisting of Ba, Sr and Ca; M^{I} is at least one alkaline metal selected from the group consisting of Li, Na, K, Rb and Cs; M′^{II} is at least one divalent metal selected from the group consisting of Be and Mg; M^{III} is at least one trivalent metal selected from the group consisting of Al, Ga, In and Ti; A is at least one metal oxide; X is at least one halogen selected from the group consisting of Cl, Br and I; each of X′, X″ and X′″ is at least one halogen selected from the group consisting of F, Cl, Br and I; a is equal to or greater than 0 and equal to or less than 2; b is equal to or greater than 0 and equal to or less than 10⁻²⁻; c is equal to or greater than 0 and equal to or less than 10⁻²⁻; a+b+c is equal to or greater than 10⁻²⁻; x is greater than 0 and equal to or less than 0.5; and y is greater than 0 and equal to or less than 0.2) disclosed in U.S. Pat. No. 4,962,047.

In the present invention, the stimulable phosphor usable for storing the energy of chemiluminescence emission may be of any type insofar as it can store the energy of light in the wavelength band of visible light and can be stimulated by an electromagnetic wave to release in the form of light the energy of light in the wavelength band of visible light stored therein. More specifically, preferably employed stimulable phosphors include at least one selected from the group consisting of metal halophosphates, rare-earth-activated sulfide-host phosphors, aluminate host phosphors, silicate-host phosphors, fluoride-host phosphors and mixtures of two, three or more of these phosphors. Among them, rare-earth-activated sulfide-host phosphors are more preferable and, particularly, rare-earth-activated alkaline earth metal sulfide-host phosphors disclosed in U.S. Pat. Nos. 5,029,253 and 4,983,834, zinc germanate such as Zn₂GeO₄:Mn, V; Zn₂GeO₄:Mn disclosed in Japanese Patent Application Laid Open No. 2001-131545, alkaline-earth aluminate such as Sr₄Al₁₄O₂₅:Ln (wherein Ln is a rare-earth element) disclosed in Japanese Patent Application Laid Open No. 2001-123162, Y_{0.8}Lu_{1.2}SiO₅:Ce, Zr; GdOCl:Ce disclosed in Japanese Patent Publication No. 6-31904 and the like are most preferable.

In a preferred aspect of the present invention, the sample is constituted as a biochemical analysis unit including a substrate two-dimensionally formed with a plurality of absorptive regions formed of an absorptive material to be spaced apart from each other and selectively containing a fluorescent substance fixed therein and the method for producing biochemical analysis data comprises the steps of leading a stimulating ray through the light guide member, irradiating the individual absorptive regions with the stimulating ray, leading fluorescence emission released from the individual absorptive regions through the light guide member to the light detector and photoelectrically detecting the fluorescence emission by the light detector to produce biochemical analysis data.

According to this preferred aspect of the present invention, even in the case where a plurality of absorptive regions selectively labeled with a fluorescent substance are formed in a biochemical analysis unit such as a membrane filter at a high density, it is possible to reliably project a stimulating ray led through the light guide member onto only the absorptive region of the biochemical analysis unit to be irradiated therewith, excite a fluorescent substance contain in the absorptive region to cause it to release fluorescence emission, receive fluorescence emission by the light receiving end portion of the light guide member to lead it to the light detector and photoelectrically detect fluorescence emission by the light detector by positioning the light guide member so that the light receiving end portion thereof is sufficiently close to the absorptive region, when biochemical analysis data are to be produced by irradiating the plurality of absorptive regions two-dimensionally formed to be spaced apart from each other in the biochemical analysis unit with the stimulating ray to excite a fluorescent substance contained in the absorptive regions and photoelectrically detecting fluorescence emission released from the absorptive regions. Therefore, since it is possible to effectively prevent a stimulating ray from scattering and impinging onto neighboring absorptive regions next to the absorptive region which should be irradiated with the stimulating ray and causing the fluorescent substance contained in the neighboring absorptive regions to release fluorescence emission and to prevent fluorescence emission released from neighboring absorptive regions from being mixed with each other, biochemical analysis data having high quantitative characteristics can be produced with high resolution.

In a further preferred aspect of the present invention, the fluorescent substance is selectively fixed in the plurality of absorptive regions formed in the substrate of the stimulable phosphor sheet by spotting a solution containing specific binding substances which can specifically bind with a substance derived from a living organism and whose sequence, base length, composition and the like are known onto the plurality of absorptive regions formed in the substrate of the biochemical analysis unit to fix the specific binding substances therein and specifically binding a substance derived from a living organism and labeled with a fluorescent substance with specific binding substances fixed in the plurality of absorptive regions of the biochemical analysis unit.

In a preferred aspect of the present invention, the sample is constituted as a biochemical analysis unit including a substrate two-dimensionally formed with a plurality of absorptive regions formed of an absorptive material to be spaced apart from each other and selectively containing a labeling substance which generates chemiluminescence emission when it contacts a chemiluminescent substrate fixed therein and the method for producing biochemical analysis data comprises the steps of leading chemiluminescence emission released from the individual absorptive regions through the light guide member to the light detector and photoelectrically detecting the chemiluminescence emission by the light detector to produce biochemical analysis data.

According to this preferred aspect of the present invention, even in the case where a plurality of absorptive regions selectively labeled with a labeling substance which generates chemiluminescence emission when it contacts a chemiluminescent substrate are formed in a biochemical analysis unit such as a membrane filter at a high density, it is possible to reliably receive only chemiluminescence emission released from the absorptive region the light receiving end portion of the light guide member faces by the light receiving end portion of the light guide member to lead it to the light detector and photoelectrically detect chemiluminescence emission by the light detector by positioning the light guide member so that the light receiving end portion thereof is sufficiently close to the absorptive region, when biochemical analysis data are to be produced by photoelectrically detecting chemiluminescence emission released from the absorptive regions. Therefore, since it is possible to effectively prevent chemiluminescence emission released from neighboring absorptive regions from being mixed with each other, biochemical analysis data having high quantitative characteristics can be produced with high resolution.

In a further preferred aspect of the present invention, the labeling substance which generates chemiluminescence emission when it contacts a chemiluminescent substrate is selectively fixed in the plurality of absorptive regions formed in the substrate of the stimulable phosphor sheet by spotting a solution containing specific binding substances which can specifically bind with a substance derived from a living organism and whose sequence, base length, composition and the like are known onto the plurality of absorptive regions formed in the substrate of the biochemical analysis unit to fix the specific binding substances therein and specifically binding a substance derived from a living organism and labeled with a labeling substance which generates chemiluminescence emission when it contacts a chemiluminescent substrate with specific binding substances fixed in the plurality of absorptive regions of the biochemical analysis unit.

In the present invention, the case where a plurality of spot-like regions or absorptive regions are selectively labeled with a fluorescent substance as termed herein includes the case where a plurality of spot-like regions or absorptive regions are selectively labeled with a fluorescent substance by selectively binding a substance derived from a living organism and labeled with a fluorescent substance with specific binding substances contained in the plurality of spot-like regions or absorptive regions and the case where a plurality of spot-like regions or absorptive regions are selectively labeled with a fluorescent substance by selectively binding a substance derived from a living organism and labeled with a hapten with specific binding substances contained in the plurality of spot-like regions or absorptive regions, and binding an antibody for the hapten labeled with an enzyme which generates fluorescence emission when it contacts a fluorescent substrate with the hapten by an antigen-antibody reaction.

In the present invention, the case where a plurality of spot-like regions are selectively labeled with a labeling substance which generates chemiluminescence emission when it contacts a chemiluminescent substrate as termed herein includes the case where a plurality of spot-like regions are selectively labeled with a labeling substance which generates chemiluminescence emission when it contacts a chemiluminescent substrate by selectively binding a substance derived from a living organism and labeled with a labeling substance which generates chemiluminescence emission when it contacts a chemiluminescent substrate with specific binding substances contained in the plurality of spot-like regions or absorptive regions and the case where a plurality of spot-like regions are selectively labeled with a labeling substance which generates chemiluminescence emission when it contacts a chemiluminescent substrate by selectively binding a substance derived from a living organism and labeled with a hapten with specific binding substances contained in the plurality of spot-like regions or absorptive regions, and binding an antibody for the hapten labeled with an enzyme which generates chemiluminescence emission when it contacts a chemiluminescent substrate with the hapten by an antigen-antibody reaction.

In the present invention, illustrative examples of the combination of hapten and antibody include digoxigenin and anti-digoxigenin antibody, theophylline and anti-theophylline antibody, fluorosein and antifluorosein antibody, and the like. Further, the combination of biotin and avidin, antigen and antibody may be utilized instead of the combination of hapten and antibody.

In a preferred aspect of the present invention, the substrate of the biochemical analysis unit has a property of attenuating light energy.

According to this preferred aspect of the present invention, since the substrate of the biochemical analysis unit has a property of attenuating light energy, it is possible to effectively prevent a stimulating ray from scattering in the substrate of the biochemical analysis unit, entering an absorptive region to be next irradiated with a stimulating ray to excite a fluorescent substance contained therein and causing the fluorescent substance to release fluorescence emission. Therefore, biochemical analysis data having high quantitative characteristics can be produced with high resolution by scanning the plurality of absorptive regions of the biochemical analysis unit selectively containing a fluorescent substance with a stimulating ray and photoelectirically detecting fluorescence emission released from the plurality of absorptive regions.

Further, according to this preferred aspect of the present invention, since the substrate of the biochemical analysis unit has a property of attenuating light energy, it is possible to effectively prevent fluorescence emission or chemiluminescence emission released from any particular absorptive region of the biochemical analysis unit from scattering in the substrate of the biochemical analysis unit and being mixed with fluorescence emission or chemiluminescence emission released from neighboring absorptive regions of the biochemical analysis unit. Therefore, biochemical analysis data having high quantitative characteristics can be produced with high resolution by photoelectrically detecting fluorescence emission or chemiluminescence emission from the plurality of absorptive regions of the biochemical analysis unit.

In a preferred aspect of the present invention, the substrate of the biochemical analysis unit has a property of reducing the energy of light to ⅕ or less when the light travels in the substrate by a distance equal to that between neighboring absorptive regions.

In a further preferred aspect of the present invention, the substrate of the biochemical analysis unit has a property of reducing the energy of light to 1/10 or less when the light travels in the substrate by a distance equal to that between neighboring absorptive regions.

In a further preferred aspect of the present invention, the substrate of the biochemical analysis unit has a property of reducing the energy of light to 1/50 or less when the light travels in the substrate by a distance equal to that between neighboring absorptive regions.

In a further preferred aspect of the present invention, the substrate of the biochemical analysis unit has a property of reducing the energy of light to 1/100 or less when the light travels in the substrate by a distance equal to that between neighboring absorptive regions.

In a further preferred aspect of the present invention, the substrate of the biochemical analysis unit has a property of reducing the energy of light to 1/500 or less when the light travels in the substrate by a distance equal to that between neighboring absorptive regions.

In a further preferred aspect of the present invention, the substrate of the biochemical analysis unit has a property of reducing the energy of light to 1/1,000 or less when the light travels in the substrate by a distance equal to that between neighboring absorptive regions.

In the present invention, the material for forming the substrate of the biochemical analysis unit is preferably capable of attenuating light energy but is not particularly limited. The material for forming the substrate of the biochemical analysis unit may be any type of inorganic compound material or organic compound material and the substrate of the biochemical analysis unit can preferably be formed of a metal material, a ceramic material or a plastic material.

Illustrative examples of inorganic compound materials preferably usable for forming the substrate of the biochemical analysis unit in the present invention include metals such as gold, silver, copper, zinc, aluminum, titanium, tantalum, chromium, iron, nickel, cobalt, lead, tin, selenium and the like; alloys such as brass, stainless steel, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. These may have either a monocrystal structure or a polycrystal sintered structure such as amorphous, ceramic or the like.

In the present invention, a high molecular compound can preferably be used as an organic compound material preferably usable for forming the substrate of the biochemical analysis unit. Illustrative examples of high molecular compounds preferably usable for forming the substrate of the biochemical analysis unit in the present invention include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifuluoroethylene; polycarbonate; polyesters such as polyethylene naphthalate, polyethylene terephthalate and the like; nylons such as nylon-6, nylon-6,6, nylon-4,10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials. These may be a composite compound, and metal oxide particles, glass fiber or the like may be added thereto as occasion demands. Further, an organic compound material may be blended therewith.

Since the capability of attenuating light energy generally increases as scattering and/or absorption of light increases, the substrate of the biochemical analysis unit preferably has absorbance of 0.3 per cm (thickness) or more and more preferably has absorbance of 1 per cm (thickness) or more. The absorbance can be determined by placing an integrating sphere immediately behind a plate-like member having a thickness of T cm, measuring an amount A of transmitted light at a wavelength of probe light or emission light used for measurement by a spectrophotometer, and calculating A/T. In the present invention, a light scattering substance or a light absorbing substance may be added to the substrate of the biochemical analysis unit in order to improve the capability of attenuating light energy. Particles of a material different from a material forming the substrate of the biochemical analysis unit may be preferably used as a light scattering substance and a pigment or dye may be preferably used as a light absorbing substance.

In a preferred aspect of the present invention, the plurality of absorptive regions of the biochemical analysis unit are formed in holes formed in the substrate.

In a further preferred aspect of the present invention, the plurality of absorptive regions of the biochemical analysis unit are formed by charging an absorptive material in holes formed in the substrate.

In a further preferred aspect of the present invention, the plurality of absorptive regions of the biochemical analysis unit are formed by charging an absorptive material in through-holes formed in the substrate.

In a further preferred aspect of the present invention, the plurality of absorptive regions of the biochemical analysis unit are formed by embedding an absorptive material in holes formed in the substrate.

In another preferred aspect of the present invention, the plurality of absorptive regions of the biochemical analysis unit are formed by pressing a absorptive membrane containing an absorptive material in through-holes formed in the substrate.

In another preferred aspect of the present invention, the plurality of absorptive regions of the biochemical analysis unit are formed by charging an absorptive material in recesses formed in the substrate.

In a further preferred aspect of the present invention, the plurality of absorptive regions of the biochemical analysis unit are formed by embedding an absorptive material in recesses formed in the substrate.

In the present invention, a porous material or a fiber material may be preferably used as the absorptive material for forming the absorptive regions of the biochemical analysis unit. The absorptive regions may be formed by combining a porous material and a fiber material.

In the present invention, a porous material for forming the absorptive regions of the biochemical analysis unit may be any type of an organic material or an inorganic material and may be an organic/inorganic composite material.

In the present invention, an organic porous material used for forming the absorptive regions of the biochemical analysis unit is not particularly limited but a carbon porous material such as an activated carbon or a porous material capable of forming a membrane filter is preferably used. Illustrative examples of porous materials capable of forming a membrane filter include nylons such as nylon-6, nylon-6,6, nylon-4,10; cellulose derivatives such as nitrocellulose, acetyl cellulose, butyric-acetyl cellulose; collagen; alginic acids such as alginic acid, calcium alginate, alginic acid/poly-L-lysine polyionic complex; polyolefins such as polyethylene, polypropylene; polyvinyl chloride; polyvinylidene chloride; polyfluoride such as polyvinylidene fluoride, polytetrafluoride; and copolymers or composite materials thereof.

In the present invention, an inorganic porous material used for forming the absorptive regions of the biochemical analysis unit is not particularly limited. Illustrative examples of inorganic porous materials preferably usable in the present invention include metals such as platinum, gold, iron, silver, nickel, aluminum and the like; metal oxides such as alumina, silica, titania, zeolite and the like; metal salts such as hydroxy apatite, calcium sulfate and the like; and composite materials thereof.

In the present invention, a fiber material used for forming the absorptive regions of the biochemical analysis unit is not particularly limited. Illustrative examples of fiber materials preferably usable in the present invention include nylons such as nylon-6, nylon-6,6, nylon-4,10; and cellulose derivatives such as nitrocellulose, acetyl cellulose, butyric-acetyl cellulose.

In a preferred aspect of the present invention, the substrate of the biochemical analysis unit is formed with 10 or more absorptive regions.

In a further preferred aspect of the present invention, the substrate of the biochemical analysis unit is formed with 50 or more absorptive regions.

In a further preferred aspect of the present invention, the substrate of the biochemical analysis unit is formed with 100 or more absorptive regions.

In a further preferred aspect of the present invention, the substrate of the biochemical analysis unit is formed with 500 or more absorptive regions.

In a further preferred aspect of the present invention, the substrate of the biochemical analysis unit is formed with 1,000 or more absorptive regions.

In a further preferred aspect of the present invention, the substrate of the biochemical analysis unit is formed with 5,000 or more absorptive regions.

In a further preferred aspect of the present invention, the substrate of the biochemical analysis unit is formed with 10,000 or more absorptive regions.

In a further preferred aspect of the present invention, the substrate of the biochemical analysis unit is formed with 50,000 or more absorptive regions.

In a further preferred aspect of the present invention, the substrate of the biochemical analysis unit is formed with 100,000 or more absorptive regions.

In a preferred aspect of the present invention, each of the plurality of absorptive regions formed in the substrate of the biochemical analysis unit has a size of less than 5 mm².

In a further preferred aspect of the present invention, each of the plurality of absorptive regions formed in the substrate of the biochemical analysis unit has a size of less than 1 mm².

In a further preferred aspect of the present invention, each of the plurality of absorptive regions formed in the substrate of the biochemical analysis unit has a size of less than 0.5 mm².

In a further preferred aspect of the present invention, each of the plurality of absorptive regions formed in the substrate of the biochemical analysis unit has a size of less than 0.1 mm².

In a further preferred aspect of the present invention, each of the plurality of absorptive regions formed in the substrate of the biochemical analysis unit has a size of less than 0.05 mm².

In a further preferred aspect of the present invention, each of the plurality of absorptive regions formed in the substrate of the biochemical analysis unit has a size of less than 0.01 mm².

In the present invention, the density of the absorptive regions formed in the substrate of the biochemical analysis unit is determined depending upon the material for forming the substrate, the kind of electron beam released from a radioactive substance or the like.

In a preferred aspect of the present invention, the plurality of absorptive regions are formed in the substrate of the biochemical analysis unit at a density of 10 or more per cm².

In a further preferred aspect of the present invention, the plurality of absorptive regions are formed in the substrate of the biochemical analysis unit at a density of 50 or more per cm².

In a further preferred aspect of the present invention, the plurality of absorptive regions are formed in the substrate of the biochemical analysis unit at a density of 100 or more per cm².

In a further preferred aspect of the present invention, the plurality of absorptive regions are formed in the substrate of the biochemical analysis unit at a density of 500 or more per cm².

In a further preferred aspect of the present invention, the plurality of absorptive regions are formed in the substrate of the biochemical analysis unit at a density of 1,000 or more per cm².

In a further preferred aspect of the present invention, the plurality of absorptive regions are formed in the substrate of the biochemical analysis unit at a density of 5,000 or more per cm².

In a further preferred aspect of the present invention, the plurality of absorptive regions are formed in the substrate of the biochemical analysis unit at a density of 10,000 or more per cm².

In a further preferred aspect of the present invention, the plurality of absorptive regions are formed in the substrate of the biochemical analysis unit at a density of 50,000 or more per cm².

In a further preferred aspect of the present invention, the plurality of absorptive regions are formed in the substrate of the biochemical analysis unit at a density of 100,000 or more per cm².

In a preferred aspect of the present invention, a laser beam is selected as the stimulating lay.

The above and other objects of the present invention can be also accomplished by a scanner comprising a sample stage on which a sample two-dimensionally formed with a plurality of light releasable regions spaded apart from each other for releasing light, a light detector for photoelectrically detecting light released from the plurality of light releasable regions, a light guide member for leading light released from the plurality of light releasable regions to the light detector and a scanning mechanism for intermittently moving the light guide member and the sample stage relative to each other in a main scanning direction and a sub-scanning direction perpendicular to the main scanning direction.

According to one application of the present invention, even in the case where a plurality of spot-like regions selectively labeled with a radioactive labeling substance are formed in a biochemical analysis unit such as a membrane filter at a high density, biochemical analysis data having high quantitative characteristics can be produced with high resolution by superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to a radioactive labeling substance contained in the plurality of spot-like regions while preventing electron beams (β rays) released from the radioactive labeling substance contained in any particular spot-like region from entering stimulable phosphor layer regions other than that to be exposed to electron beams (β rays) released from the radioactive labeling substance contained in the spot-like region, thereby storing radiation energy therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other by the scanning mechanism in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this application of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release radiation energy stored therein, biochemical analysis data having high quantitative characteristics can be produced with high resolution.

According to another application of the present invention, even in the case where a plurality of spot-like regions selectively labeled with a labeling substance which generates chemiluminescence emission when it contacts a chemiluminescent substrate are formed in a biochemical analysis unit such as a membrane filter at a high density, biochemical analysis data having high quantitative characteristics can be produced with high resolution by bringing the plurality of spot-like regions of the biochemical analysis unit into contact with a chemiluminescent substrate, thereby causing the spot-like regions to selectively release chemiluminescence emission, superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to chemiluminescence emission selectively released from the spot-like regions of the biochemical analysis unit while preventing chemiluminescence emission released from any particular spot-like region of the biochemical analysis unit from entering stimulable phosphor layer regions other than that to be exposed to chemiluminescence emission released from the spot-like region, thereby storing the energy of chemiluminescence emission therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other by the scanning mechanism in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this application of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release the energy of chemiluminescence emission stored therein, biochemical analysis data having high quantitative characteristics can be produced with high resolution.

According to a further application of the present invention, even in the case where a plurality of spot-like regions selectively labeled with a fluorescent substance are formed in a biochemical analysis unit such as a membrane filter at a high density, biochemical analysis data having high quantitative characteristics can be produced with high resolution by placing the biochemical analysis unit on the sample stage, sequentially irradiating the plurality of spot-like regions of the biochemical analysis unit with a stimulating ray while intermittently moving the light guide member and the sample stage relative to each other by the scanning mechanism in a main scanning direction and a sub-scanning direction perpendicular to the main scanning direction, sequentially exciting a fluorescent substance contained the plurality of spot-like regions of the biochemical analysis unit, leading fluorescence emission released from the spot-like regions through the light guide member to the light detector, and photoelectrically detecting the fluorescence emission by the light detector.

More specifically, according to this application of the present invention, it is possible to reliably project a stimulating ray led through the light guide member onto only the spot-like region of the biochemical analysis unit to be irradiated therewith, excite a fluorescent substance contained in the spot-like regions to cause it to release fluorescence emission, receive fluorescence emission by the light receiving end portion of the light guide member to lead it to the light detector and photoelectrically detect fluorescence emission by the light detector by positioning the light guide member so that the light receiving end portion thereof is sufficiently close to the spot-like region when biochemical analysis data are to be produced by irradiating the plurality of spot-like regions two-dimensionally formed to be spaced apart from each other in the biochemical analysis unit with the stimulating ray to excite fluorescent substance contained in the spot-like regions and photoelectrically detecting fluorescence emission released from the spot-like regions. Therefore, since it is possible to effectively prevent a stimulating ray from impinging onto neighboring spot-like regions next to the spot-like region which should be irradiated with the stimulating ray and causing the spot-like regions to release fluorescence emission, biochemical analysis data having high quantitative characteristics can be produced with high resolution.

In a further application of the present invention, even in the case where a plurality of spot-like regions selectively labeled with a labeling substance which generates chemiluminescence emission when it contacts a chemiluminescent substrate are formed in a biochemical analysis unit such as a membrane filter at a high density, biochemical analysis data having high quantitative characteristics can be produced with high resolution by bringing the plurality of spot-like regions of the biochemical analysis unit into contact with a chemiluminescent substrate, thereby causing the spot-like regions to selectively releasechemiluminescence emission, placing the biochemical analysis unit on the sample stage, intermittently moving the light guide member and the sample stage relative to each other by the scanning mechanism in a main scanning direction and a sub-scanning direction perpendicular to the main scanning direction, sequentially leading chemiluminescence emission released from the plurality of spot-like regions of the biochemical analysis unit placed on the sample stage through the light guide member to the light detector, and photoelectrically detecting the chemiluminescence emission by the light detector.

More specifically, according to this application of the present invention, it is possible to reliably receive only chemiluminescence emission released from a spot-like region of the biochemical analysis unit and to be detected by the light detector, lead it to the light detector through the light guide member and photoelectrically detect it by the light detector by positioning the light guide member so that the light receiving end portion thereof is sufficiently close to the spot-like region when biochemical analysis data are to be produced by photoelectrically detecting chemiluminescence emission released from the spot-like regions of the biochemical analysis unit. Therefore, since it is possible to effectively prevent the light detector from photoelectrically detecting chemiluminescence emission released from neighboring spot-like regions next to the spot-like region which release chemiluminescence emission to be detected, biochemical analysis data having high quantitative characteristics can be produced with high resolution.

In a preferred aspect of the present invention, the light guide member has flexibility.

According to this preferred aspect of the present invention, since the light guide member has flexibility, it is possible to extremely easily move the light guide member in the main scanning direction and the sub-scanning direction and lead light released from the plurality of light releasable regions to the light detector through the light guide member, thereby photoelectrically detecting light to produce biochemical analysis data. In a preferred aspect of the present invention, the light guide member is formed of at least one optical fiber.

In a further preferred aspect of the present invention, the light guide member is formed of a bundle of optical fibers.

In a preferred aspect of the present invention, the sample is regularly formed with the plurality of light releasable regions by a predetermined pitch in the main scanning direction and the sub-scanning direction and the scanning mechanism is constituted so as to intermittently move the light guide member and the sample stage relative to each other by the predetermined pitch to photoelectrically detect light released from the plurality of light releasable regions two-dimensionally formed to be spaced form each other in the sample, thereby producing biochemical analysis data.

In a preferred aspect of the present invention, the scanner further comprises a stimulating ray source for emitting a stimulating ray and a stimulating ray cut filter having a property of cutting light having a wavelength of the stimulating ray and transmitting light having a wavelength of stimulated emission, the sample being constituted by a stimulable phosphor including a support two-dimensionally formed with a plurality of stimulable phosphor layer regions spaced apart from each other and selectively storing radiation energy, the light guide member being constituted so as to lead a stimulating ray emitted from the stimulating ray source to the individual stimulable phosphor layer regions of the stimulable phosphor sheet placed on the sample stage and to lead stimulated emission released from the individual stimulable phosphor layer regions in response to the excitation with the stimulating ray to the light detector.

According to this preferred aspect of the present invention, even in the case where a plurality of spot-like regions selectively labeled with a radioactive labeling substance are formed in a biochemical analysis unit such as a membrane filter at a high density, biochemical analysis data having high quantitative characteristics can be produced with high resolution by superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to a radioactive labeling substance contained in the plurality of spot-like regions while preventing electron beams (β rays) released from the radioactive labeling substance contained in any particular spot-like region from entering stimulable phosphor layer regions other than that to be exposed to electron beams (β rays) released from the radioactive labeling substance contained in the spot-like region, thereby storing radiation energy therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other by the scanning mechanism in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this preferred aspect of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release radiation energy stored therein, biochemical analysis data having high quantitative characteristics can be produced with high resolution.

In a further preferred aspect of the present invention, the scanner further comprises a stimulating ray source for emitting a stimulating ray and a stimulating ray cut filter having a property of cutting light having a wavelength of the stimulating ray and transmitting light having a wavelength of stimulated emission, the sample being constituted by a stimulable phosphor including a support two-dimensionally formed with a plurality of stimulable phosphor layer regions spaced apart from each other and selectively storing the energy of chemiluminescence emission, the light guide member being constituted so as to lead a stimulating ray emitted from the stimulating ray source to the individual stimulable phosphor layer regions of the stimulable phosphor sheet placed on the sample stage and to lead stimulated emission released from the individual stimulable phosphor layer regions in response to the excitation with the stimulating ray to the light detector.

According to this preferred aspect of the present invention, even in the case where a plurality of spot-like regions selectively labeled with a labeling substance which generates chemiluminescence emission when it contacts a chemiluminescent substrate are formed in a biochemical analysis unit such as a membrane filter at a high density, biochemical analysis data having high quantitative characteristics can be produced with high resolution by bringing the plurality of spot-like regions of the biochemical analysis unit into contact with a chemiluminescent substrate, thereby causing the spot-like regions to selectively release chemiluminescence emission, superposing a stimulable phosphor sheet formed with a plurality of stimulable phosphor layer regions in the same pattern as that of the plurality of spot-like regions formed in the biochemical analysis unit on the biochemical analysis unit in such a manner that each of the stimulable phosphor layer regions of the stimulable phosphor sheet faces the corresponding absorptive region of the biochemical analysis unit, exposing the plurality of stimulable phosphor layer regions of the stimulable phosphor sheet to chemiluminescence emission selectively released from the spot-like regions of the biochemical analysis unit while preventing chemiluminescence emission released from any particular spot-like region of the biochemical analysis unit from entering stimulable phosphor layer regions other than that to be exposed to chemiluminescence emission released from the spot-like region, thereby storing the energy of chemiluminescence emission therein, placing the stimulable phosphor sheet on the sample stage, sequentially irradiating the plurality of stimulable phosphor layer regions of the stimulable phosphor sheet placed on the sample stage with a stimulating ray while intermittently moving the light guide member and the sample stage relative to each other by the scanning mechanism in a main scanning direction and a sub-scanning direction perpendicular to the main scanning direction, sequentially exciting stimulable phosphor contained in the stimulable phosphor layer regions, leading stimulated emission released from the stimulable phosphor layer regions through the light guide member to the light detector, and photoelectrically detecting the stimulated emission by the light detector.

More specifically, according to this preferred aspect of the present invention, it is possible to reliably project a stimulating ray led through the light guide member onto only the stimulable phosphor layer region of the stimulable phosphor sheet to be irradiated therewith, excite stimulable phosphor contained in the stimulable phosphor layer region to cause it to release stimulated emission, receive stimulated emission by the light receiving end portion of the light guide member to lead it to the light detector and photoelectrically detect stimulated emission by the light detector by positioning the light guide member so that the light receiving end portion thereof is sufficiently close to the stimulable phosphor layer region when biochemical analysis data are to be produced by irradiating the plurality of stimulable phosphor layer regions two-dimensionally formed to be spaced apart from each other in the stimulable phosphor sheet with the stimulating ray to excite stimulable phosphor contained in the stimulable phosphor layer regions and photoelectrically detecting stimulated emission released from the stimulable phosphor layer regions. Therefore, since it is possible to effectively prevent a stimulating ray from impinging onto neighboring stimulable phosphor layer regions next to the stimulable phosphor region which should be irradiated with the stimulating ray and causing the stimulable phosphor layer regions to release the energy of chemiluminescence emission stored therein, biochemical analysis data having high quantitative characteristics can be produced with high resolution.

In a preferred aspect of the present invention, the scanner further comprises a stimulating ray source for emitting a stimulating ray and a stimulating ray cut filter having a property of cutting light having a wavelength of the stimulating ray and transmitting light having a wavelength longer than that of the stimulating ray, the sample being constituted as a biochemical analysis unit including a substrate two-dimensionally formed with a plurality of absorptive regions formed of an absorptive material to be spaced apart from each other and selectively containing a fluorescent substance fixed therein, the light guide member being constituted so as to lead a stimulating ray emitted from the stimulating ray source to the individual absorptive regions of the biochemical analysis unit placed on the sample stage and to lead fluorescence emission released from the individual absorptive regions in response to the excitation with the stimulating ray to the light detector.

According to this preferred aspect of the present invention, even in the case where a plurality of spot-like regions selectively labeled with a fluorescent substance are formed in a biochemical analysis unit such as a membrane filter at a high density, biochemical analysis data having high quantitative characteristics can be produced with high resolution by placing the biochemical analysis unit on the sample stage, sequentially irradiating the plurality of spot-like regions of the biochemical analysis unit with a stimulating ray while intermittently moving the light guide member and the sample stage relative to each other by the scanning mechanism in a main scanning direction and a sub-scanning direction perpendicular to the main scanning direction, sequentially exciting a fluorescent substance contained the plurality of spot-like regions of the biochemical analysis unit, leading fluorescence emission released from the spot-like regions through the light guide member to the light detector, and photoelectrically detecting the fluorescence emission by the light detector.

More specifically, according to this preferred aspect of the present invention, it is possible to reliably project a stimulating ray led through the light guide member onto only the spot-like region of the biochemical analysis unit to be irradiated therewith, excite a fluorescent substance contained in the spot-like regions to cause it to release fluorescence emission, receive fluorescence emission by the light receiving end portion of the light guide member to lead it to the light detector and photoelectrically detect fluorescence emission by the light detector by positioning the light guide member so that the light receiving end portion thereof is sufficiently close to the spot-like region when biochemical analysis data are to be produced by irradiating the plurality of spot-like regions two-dimensionally formed to be spaced apart from each other in the biochemical analysis unit with the stimulating ray to excite fluorescent substance contained in the spot-like regions and photoelectrically detecting fluorescence emission released from the spot-like regions. Therefore, since it is possible to effectively prevent a stimulating ray from impinging onto neighboring spot-like regions next to the spot-like region which should be irradiated with the stimulating ray and causing the spot-like regions to release fluorescence emission, biochemical analysis data having high quantitative characteristics can be produced with high resolution.

In a preferred aspect of the present invention, the scanner further comprises a position detecting means for detecting the relative positional relationship between the light guide member and the sample stage.

According to this preferred aspect of the present invention, since the scanner further comprises a position detecting means for detecting the relative positional relationship between the light guide member and the sample stage, it is possible to accurately locate the light guide member so that the light receiving end portion thereof accurately faces one of the plurality of stimulable phosphor layer regions two-dimensionally formed to be spaced apart from each other in the stimulable phosphor sheet or one of the plurality of absorptive regions two-dimensionally formed to be spaced apart from each other in the biochemical analysis unit. Therefore, since it is possible to lead a stimulating ray emitted from the stimulating ray source through the light guide member to the individual stimulable phosphor layer regions of the stimulable phosphor sheet or the individual absorptive regions of the biochemical analysis unit and to lead stimulated emission released from the individual stimulable phosphor layer regions of the stimulable phosphor sheet, or fluorescence emission or chemiluminescence emission released from the individual absorptive regions of the biochemical analysis unit through the light guide member to light detector, thereby causing the light detector to photoelectrically detect stimulated emission, fluorescence emission or chemiluminescence emission, biochemical analysis data having high quantitative characteristics can be produced with high resolution.

In a preferred aspect of the present invention, the scanning mechanism is constituted so as to move the light guide member in the main scanning direction.

In a preferred aspect of the present invention, the position detecting means is constituted as a linear encoder for detection the position of the light guide member in the main scanning direction.

In a preferred aspect of the present invention, the scanning mechanism includes a stepping motor for intermittently moving the light guide member in the main scanning direction.

In another preferred aspect of the present invention, the scanning mechanism is constituted so as to move the sample stage in the main scanning direction.

In another preferred aspect of the present invention, the position detecting means is constituted as a linear encoder for detection the position of the sample stage in the main scanning direction.

In another preferred aspect of the present invention, the scanning mechanism includes a stepping motor for intermittently moving the sample stage in the main scanning direction.

In a preferred aspect of the present invention, the stimulating ray source is constituted as a laser stimulating ray source for emitting a laser beam.

The above and other objects and features of the present invention will become apparent from the following description made with reference to the accompanying drawings.

### BRIEF DESCRIPTION OF THE DRAWINGS

FIG. 1 is a schematic perspective view showing a biochemical analysis unit used in a method for producing biochemical analysis data which is a preferred embodiment of the present invention.

FIG. 2 is a schematic front view showing a spotting device.

FIG. 3 is a schematic longitudinal cross sectional view showing a hybridization reaction vessel.

FIG. 4 is a schematic perspective view showing a stimulable phosphor sheet used in a method for producing biochemical analysis data which is a preferred embodiment of the present invention.

FIG. 5 is a schematic cross-sectional view showing a method for exposing a number of stimulable phosphor layer regions formed in a stimulable phosphor sheet to a radioactive labeling substance contained in a number of absorptive regions formed in a biochemical analysis unit.

FIG. 6 is a schematic view showing a scanner which is a preferred embodiment of the present invention.

FIG. 7 is a schematic front view showing a filter unit.

FIG. 8 is a schematic plan view showing a scanning mechanism for an optical fiber bundle.

FIG. 9 is a block diagram of a control system, an input system, a drive system and a detection system of a scanner which is a preferred embodiment of the present invention.

FIG. 10 is a schematic perspective view showing a stimulable phosphor sheet onto which chemiluminescence data are to be transferred and used in a method for producing biochemical analysis data which is a preferred embodiment of the present invention.

FIG. 11 is a schematic view showing a scanner for reading chemiluminescence data to produce biochemical analysis data, which is another preferred embodiment of the present invention.

FIG. 12 is a schematic front view showing a filter unit.

FIG. 13 is a schematic perspective view showing a biochemical analysis unit used in a method for producing biochemical analysis data which is a further preferred embodiment of the present invention.

FIG. 14 is a schematic perspective view showing a stimulable phosphor sheet used in a method for producing biochemical analysis data which is a further preferred embodiment of the present invention.

FIG. 15 is a schematic cross-sectional view showing a method for exposing a number of stimulable phosphor layer regions formed in a stimulable phosphor sheet to a radioactive labeling substance contained in a number of absorptive regions formed in a biochemical analysis unit.

FIG. 16 is a block diagram of the vicinity of a photomultiplier and a data processing apparatus of a scanner which is another preferred embodiment of the present invention.

FIG. 17 is a schematic perspective view showing a stimulable phosphor sheet onto which chemiluminescence data are to be transferred and used in a method for producing biochemical analysis data which is a further preferred embodiment of the present invention.

FIG. 18 is a block diagram of the vicinity of a photomultiplier and a data processing apparatus of a scanner for reading chemiluminescence data to produce biochemical analysis data, which is a further preferred embodiment of the present invention.

FIG. 19 is a schematic perspective view showing a stimulable phosphor sheet used in a method for producing biochemical analysis data which is a further preferred embodiment of the present invention.

FIG. 20 is a block diagram of the vicinity of a photomultiplier and a data processing apparatus of a scanner which is a further preferred embodiment of the present invention.

FIG. 21 is a schematic perspective view showing a stimulable phosphor sheet onto which chemiluminescence data are to be transferred and used in a method for producing biochemical analysis data which is a further preferred embodiment of the present invention.

FIG. 22 is a block diagram of the vicinity of a photomultiplier and a data processing apparatus of a scanner for reading chemiluminescence data to produce biochemical analysis data, which is a further preferred embodiment of the present invention.

FIG. 23 is a schematic view showing a scanner which is a further preferred embodiment of the present invention.

### DESCRIPTION OF THE PREFERRED EMBODIMENTS

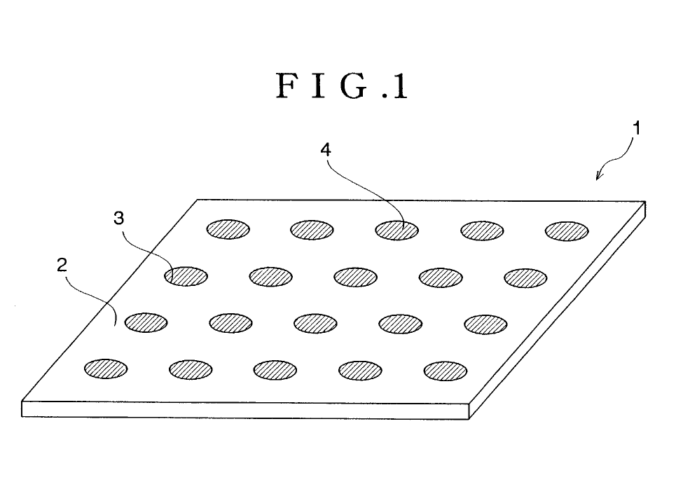

FIG. 1 is a schematic perspective view showing a biochemical analysis unit used in a method for producing biochemical analysis data which is a preferred embodiment of the present invention.

As shown in FIG. 1, a biochemical analysis unit 1 according to this embodiment includes a substrate 2 made of stainless steel and formed with a number of substantially circular through-holes 3 at high density and a number of absorptive regions 4 are formed by charging nylon-6 in the through-holes.

Although not accurately shown in FIG. 1, in this embodiment, about 10,000 through-holes 3 having a size of about 0.01 mm² are regularly formed at a density of about 5,000 per cm²in the substrate 2.

A number of absorptive regions 4 are formed by charging nylon-6 in the through-holes 3 formed in the substrate in such a manner that the surfaces of the absorptive regions 4 are located at the same height level as that of the substrate.

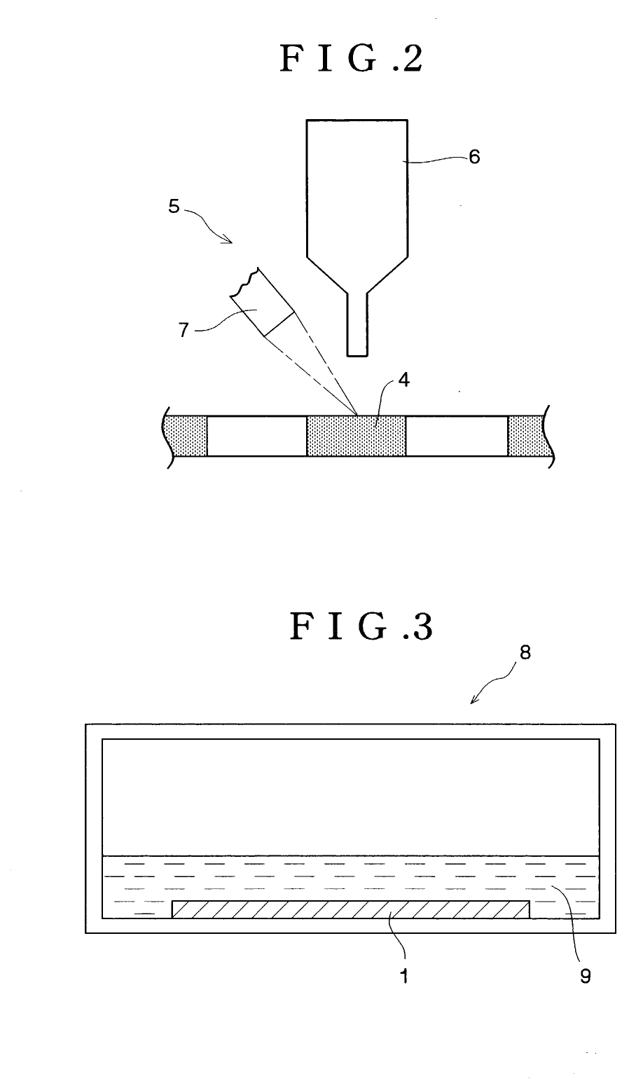

FIG. 2 is a schematic front view showing a spotting device.

As shown in FIG. 2, when biochemical analysis is performed, a solution containing specific binding substances such as a plurality of cDNAs whose sequences are known but differ from each other are spotted using a spotting device 5 onto a number of the absorptive regions 4 of the biochemical analysis unit 1 and the specific binding substances are fixed therein.

As shown in FIG. 2, the spotting device 5 includes an injector 6 for ejecting a solution of specific binding substances toward the biochemical analysis unit 1 and a CCD camera 7 and is constituted so that the solution of specific binding substances such as cDNAs are spotted from the injector 6 when the tip end portion of the injector 6 and the center of the absorptive region 4 into which the solution containing specific binding substances is to be spotted are determined to coincide with each other as a result of viewing them using the CCD camera, thereby ensuring that the solution of specific binding substances can be accurately spotted into a number of the absorptive regions 4 of the biochemical analysis unit 1.

FIG. 3 is a schematic longitudinal cross sectional view showing a hybridization reaction vessel.

As shown in FIG. 3, a hybridization reaction vessel 8 is formed to have a substantially rectangular cross section and accommodates a hybridization solution 9 containing a substance derived from a living organism labeled with a labeling substance as a probe therein.

In the case where a specific binding substance such as cDNA is to be labeled with a radioactive labeling substance, a hybridization solution 9 containing a substance derived from a living organism and labeled with a radioactive labeling substance as a probe is prepared and is accommodated in the hybridization reaction vessel 8.

On the other hand, in the case where a specific binding substance such as cDNA is to be labeled with a labeling substance which generates chemiluminescence emission when it contacts a chemiluminescent substrate, a hybridization solution 9 containing a substance derived from a living organism and labeled with a labeling substance which generates chemiluminescence emission when it contacts a chemiluminescent substrate as a probe is prepared and is accommodated in the hybridization reaction vessel 8.

Further, in the case where a specific binding substance such as cDNA is to be labeled with a fluorescent substance such as a fluorescent dye, a hybridization solution 9 containing a substance derived from a living organism and labeled with a fluorescent substance such as a fluorescent dye as a probe is prepared and is accommodated in the hybridization reaction vessel 8.

It is possible to prepare a hybridization reaction solution 9 containing two or more substances derived from a living organism among a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye and accommodate it in the hybridization vessel 8. In this embodiment, a hybridization reaction solution 9 containing a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye is prepared and accommodated in the hybridization reaction vessel 8.

When hybridization is to be performed, the biochemical analysis unit 1 containing specific binding substances such as a plurality of cDNAs spotted into a number of absorptive regions 4 is accommodated in the hybridization reaction vessel 8.

As a result, specific binding substances spotted in a number of the absorptive regions 4 of the biochemical analysis unit 1 can be selectively hybridized with a substance derived from a living organism, labeled with a radioactive labeling substance and contained in the hybridization reaction solution 9, a substance derived from a living organism, labeled with a labeling substance which generates chemiluminescence emission when it contacts a chemiluminescent substrate and contained in the hybridization reaction solution 9 and a substance derived from a living organism, labeled with a fluorescent substance such as a fluorescent dye and contained in the hybridization reaction solution 9.

In this manner, radiation data of a radioactive labeling substance, chemiluminescence data of a labeling substance which generates chemiluminescence emission when it contacts a chemiluminescent substrate and fluorescence data of a fluorescent substance such as a fluorescent dye are recorded in a number of absorptive regions 4 formed in the biochemical analysis unit 1.

Fluorescence data recorded in a number of absorptive regions 4 formed in the biochemical analysis unit 1 are read by a scanner described later, thereby producing biochemical analysis data.

On the other hand, radiation data of the radioactive labeling substance recorded in a number of absorptive regions 4 formed in the biochemical analysis unit 1 are transferred onto a stimulable phosphor sheet and read by the scanner described later, thereby producing biochemical analysis data.

Further, chemiluminescence data recorded in a number of absorptive regions 4 formed in the biochemical analysis unit 1 are read by the scanner described later or transferred onto a stimulable phosphor sheet described later and transferred chemiluminescence data are read by another scanner described later, thereby producing biochemical analysis data.

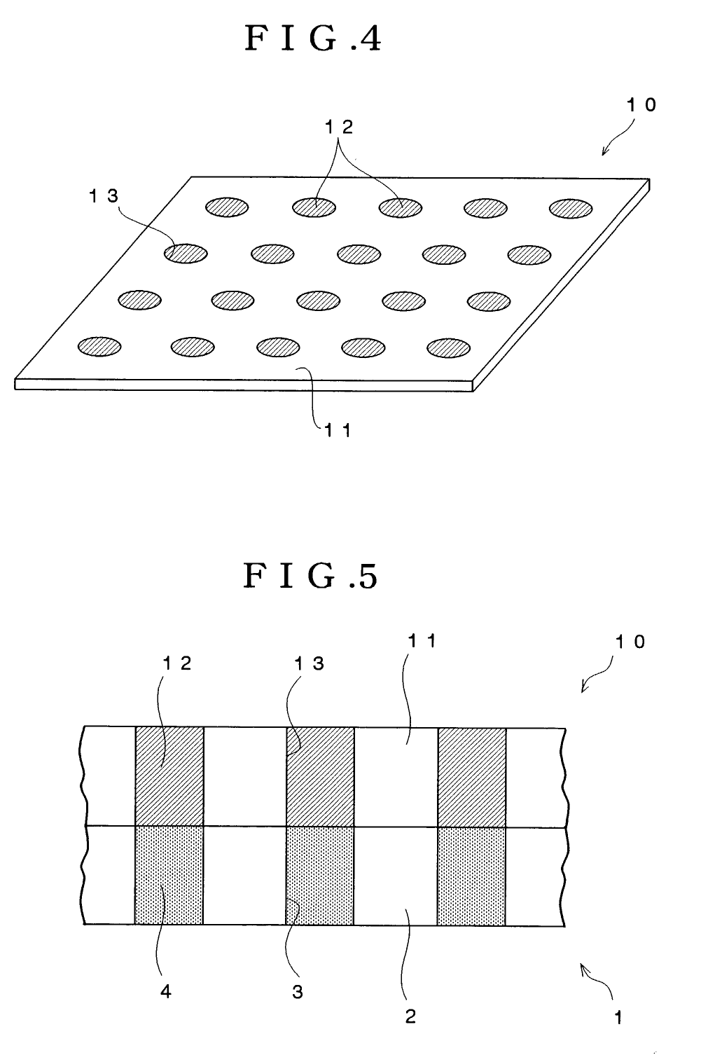

FIG. 4 is a schematic perspective view showing a stimulable phosphor sheet used in a method for producing biochemical analysis data which is a preferred embodiment of the present invention.

As shown in FIG. 4, a stimulable phosphor sheet 10 according to this embodiment includes a support 11 made of stainless steel and regularly formed with a number of substantially circular through-holes 13 and a number of stimulable phosphor layer regions 12 are dot-like formed by charging BaFX system stimulable phosphor (where X is at least one halogen atom selected from the group consisting of Cl, Br and I) capable of absorbing and storing radiation energy in the through-holes 13.

A number of the through-holes 13 are formed in the support 11 in the same pattern as that of a number of the absorptive regions 4 formed in the substrate 2 of the biochemical analysis unit 1 and each of them has the same size as that of the absorptive region 4 formed in the substrate 2 of the biochemical analysis unit 1.

Therefore, although not accurately shown in FIG. 4, in this embodiment, about 10,000 substantially circular stimulable phosphor layer regions 12 having a size of about 0.01 mm² are dot-like formed in a regular pattern at a density of about 5,000 per cm² in the support 11 of the stimulable phosphor sheet 10.

In this embodiment, stimulable phosphor is charged in a number of the through-holes 13 formed in the support 11 in such a manner that the surfaces of the stimulable phosphor layer regions 12 lie at the same height level of that of the surface of the support 11.

FIG. 5 is a schematic cross-sectional view showing a method for exposing a number of the stimulable phosphor layer regions 12 formed in the stimulable phosphor sheet 10 by a radioactive labeling substance contained in a number of the absorptive regions 4 formed in the biochemical analysis unit 1.

As shown in FIG. 5, when the stimulable phosphor layer regions 12 of a stimulable phosphor sheet 10 are to be exposed, the stimulable phosphor sheet 10 is superposed on the biochemical analysis unit 1 in such a manner that each of the stimulable phosphor layer regions 12 formed in the support 11 of the stimulable phosphor sheet 10 faces the corresponding absorptive regions 4 formed in the substrate 2 of the biochemical analysis unit 1.

In this embodiment, since the biochemical analysis unit 1 is formed by charging nylon-6 in a number of the through-holes 3 formed in the substrate 2 made of stainless steel, the biochemical analysis unit 1 does not substantially stretch or shrink when it is subjected to liquid processing such as hybridization and, therefore, it is possible to easily and accurately superpose the stimulable phosphor sheet 10 on the biochemical analysis unit 1 so that each of the stimulable phosphor layer regions 12 formed in the support 11 of the stimulable phosphor sheet 10 accurately faces the corresponding absorptive region 4 formed in the substrate 2 of the biochemical analysis unit 1, thereby exposing the stimulable phosphor layer regions 12.

In this manner, each of the stimulable phosphor layer regions 12 formed in the support 11 of the stimulable phosphor sheet 10 is kept to face the corresponding absorptive region 4 formed in the substrate 2 of the biochemical analysis unit 1 for a predetermined time period, whereby a number of the stimulable phosphor layer regions 12 formed in the support 11 of the stimulable phosphor sheet 10 are exposed to the radioactive labeling substance contained in a number of the absorptive regions 4 formed in the substrate 2 of the biochemical analysis unit 1.

During the exposure operation, electron beams (β rays) are released from the radioactive labeling substance contained in the absorptive regions 4 of the biochemical analysis unit 1. However, since a number of the absorptive regions 4 of the biochemical analysis unit 1 are formed spaced apart from each other in the substrate 2 made of stainless steel and the substrate 2 made of stainless steel capable of attenuating radiation energy is present around each of the absorptive regions 4, electron beams (β rays) released from the radioactive labeling substance contained in the absorptive regions 4 of the biochemical analysis unit 1 can be efficiently prevented from scattering in the substrate 2 of the biochemical analysis unit 1. Further, since a number of the stimulable phosphor layer regions 12 of the stimulable phosphor sheet 10 are formed by charging stimulable phosphor in a number of the through-holes 13 formed in the support 11 made of stainless steel capable of attenuating radiation energy and the support 11 made of stainless steel is present around each of the stimulable phosphor layer regions 12, electron beams (β rays) released from the radioactive labeling substance contained in the absorptive regions 4 of the biochemical analysis unit 1 can be efficiently prevented from scattering in the support 11 of the stimulable phosphor sheet 10. Therefore, it is possible to cause all electron beams (β rays) released from the radioactive labeling substance contained in the absorptive region 4 to enter the stimulable phosphor layer region 12 the absorptive region 4 faces and to effectively prevent electron beams (β rays) released from the absorptive region 4 from entering stimulable phosphor layer regions 12 to be exposed to electron beams (β rays) released from neighboring absorptive regions 4. In this manner, a number of the stimulable phosphor layer regions 12 formed in the support 11 of the stimulable phosphor sheet 10 are be selectively exposed to a radioactive labeling substance contained in the corresponding absorptive region 4 of the biochemical analysis unit 1.

Thus, radiation data of a radioactive labeling substance are recorded in a number of the stimulable phosphor layer regions 12 formed in the support 11 of the stimulable phosphor sheet 10.

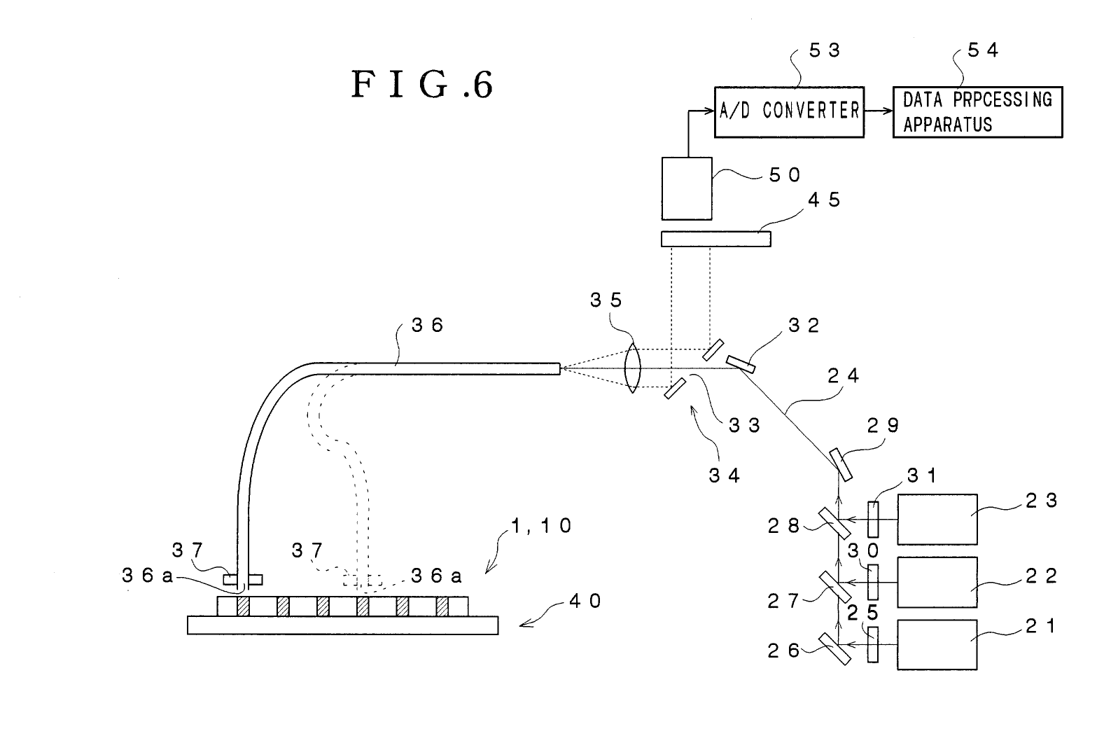

FIG. 6 is a schematic view showing a scanner for reading radiation data of a radioactive labeling substance recorded in a number of the stimulable phosphor layer regions 12 formed in the support 11 of the stimulable phosphor sheet 10 to produce biochemical analysis data.

The scanner according to this embodiment is constituted so as to read radiation data recorded in a number of the stimulable phosphor layer regions 12 formed in the support 11 of the stimulable phosphor sheet 10 to produce biochemical analysis data and to read fluorescent data and chemiluminescence data recorded in a number of the absorptive regions 4 formed in the substrate 2 of the biochemical analysis unit 1.

As shown in FIG. 6, the scanner according to this embodiment includes a first laser stimulating ray source 21 for emitting a laser beam having a wavelength of 640 nm, a second laser stimulating ray source 22 for emitting a laser beam having a wavelength of 532 nm and a third laser stimulating ray source 23 for emitting a laser beam having a wavelength of 473 nm.

In this embodiment, the first laser stimulating ray source 21 is constituted by a semiconductor laser beam source and the second laser stimulating ray source 22 and the third laser stimulating ray source 23 are constituted by a second harmonic generation element.

A laser beam 24 emitted from the first laser stimulating source 21 passes through a collimator lens 25, thereby being made a parallel beam, and is reflected by a mirror 26. A first dichroic mirror 27 for transmitting light having a wavelength of 640 nm but reflecting light having a wavelength of 532 nm and a second dichroic mirror 28 for transmitting light having a wavelength equal to and longer than 532 nm but reflecting light having a wavelength of 473 nm are provided in the optical path of the laser beam 24 emitted from the first laser stimulating ray source 21. The laser beam 24 emitted from the first laser stimulating ray source 21 and reflected by the mirror 26 passes through the first dichroic mirror 27 and the second dichroic mirror 28 and advances to a mirror 29.

On the other hand, the laser beam 24 emitted from the second laser stimulating ray source 22 passes through a collimator lens 30, thereby being made a parallel beam, and is reflected by the first dichroic mirror 27, thereby changing its direction by 90 degrees. The laser beam 24 then passes through the second dichroic mirror 28 and advances to the mirror 29.

Further, the laser beam 24 emitted from the third laser stimulating ray source 23 passes through a collimator lens 31, thereby being made a parallel beam, and is reflected by the second dichroic mirror 28, thereby changing its direction by 90 degrees. The laser beam 24 then advances to the mirror 29.

The laser beam 24 advancing to the mirror 29 is reflected by the mirror 29 and advances to a mirror 32 to be reflected thereby.

A perforated mirror 34 formed with a hole 33 at the center portion thereof is provided in the optical path of the laser beam 24 reflected by the mirror 32. The laser beam 24 reflected by the mirror 32 passes through the hole 33 of the perforated mirror 34 and advances to a convex lens 35.

The laser beam 24 advancing to the convex lens 35 is condensed onto one end portion of an optical fiber bundle 36 constituted by a plurality of optical fibers.

The opposite end portion of the optical fiber bundle constitutes a light receiving end portion 36a for receiving stimulated emission released from the stimulable phosphor layer regions 12 of the stimulable phosphor sheet 10, or receiving fluorescence emission or chemiluminescence emission released from the absorptive regions 4 of the biochemical analysis unit 1 and the optical fiber bundle 36 is mounted on a head 37 of a scanning mechanism described later in the vicinity of the light receiving end portion 36a in such a manner that the light receiving end portion 36a is located at position sufficiently close to the stimulable phosphor sheet 10 or the biochemical analysis unit 1 placed on a sample stage 40.

The head 37 on which the vicinity of the light receiving end portion 36a of the optical fiber bundle 36 is constituted so as to be intermittently moved by a scanning mechanism described later in a main scanning direction by a pitch equal to a distance between neighboring stimulable phosphor layer regions 12 formed in the support of the stimulable phosphor sheet 10 and a distance between neighboring absorptive regions 4 formed in the substrate 2 of the biochemical analysis unit 1 so that a laser beam 24 can be led by the optical fiber bundle 36 onto the stimulable phosphor layer regions 12 formed in the support of the stimulable phosphor sheet 10 or the absorptive regions 4 formed in the substrate 2 of the biochemical analysis unit 1.

When a laser beam 24 impinges onto the stimulable phosphor layer regions 12 formed in the support of the stimulable phosphor sheet 10, stimulable phosphor contained therein is excited, thereby releasing stimulated emission.

On the other hand, when a laser beam 24 impinges onto the absorptive regions 4 formed in the substrate 2 of the biochemical analysis unit 1, a fluorescent substance contained therein is excited, thereby releasing fluorescence emission.

Stimulated emission released from the stimulable phosphor layer regions 12 formed in the support of the stimulable phosphor sheet 10 or fluorescence emission released from the absorptive regions 4 formed in the substrate 2 of the biochemical analysis unit 1 enter the opposite end portion of the optical fiber bundle 36 and is led by the optical fiber bundle 36, thereby advancing to the convex lens 35. The stimulated emission or fluorescence emission advancing to the convex lens 35 is made a parallel beam by the convex lens 35 and advances to the perforated mirror 34.

Stimulated emission or fluorescence emission made a parallel beam and advancing to the perforated mirror 34 is reflected by the perforated mirror 34 and advances to a filter unit 45.

Stimulated emission or fluorescence emission transmitted through the filter unit 45 is photoelectrically detected by a photomultiplier 50.

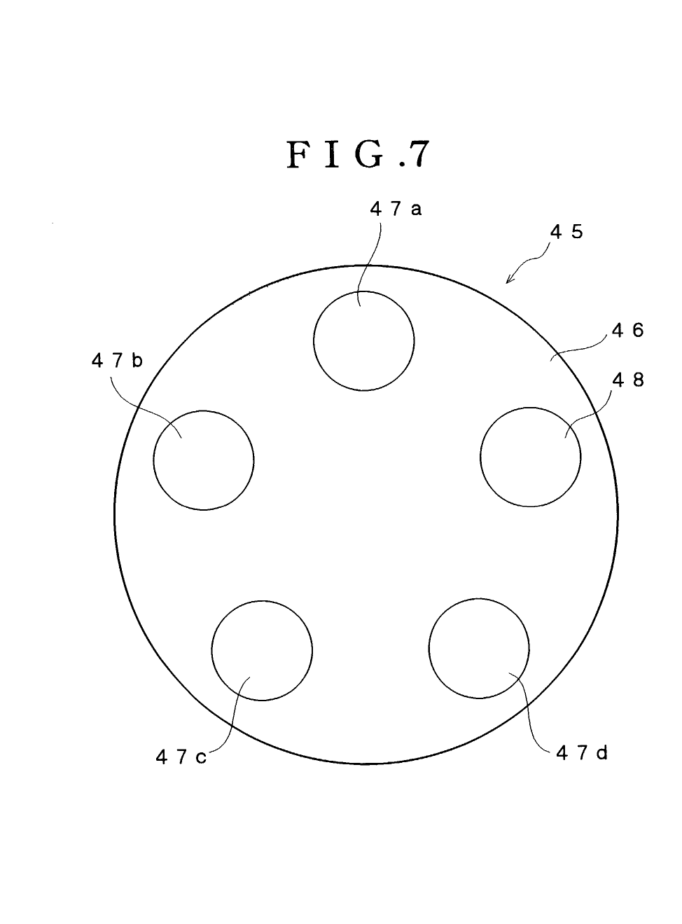

FIG. 7 is a schematic front view showing the filter unit 45.

As shown in FIG. 7, the filter unit 45 includes a disc 46 rotatable by a motor (not shown) and the disc 46 is equiangularly formed with four filters 47a, 47b, 47c and 47d having different transmittance property from each other and an opening 48.

The filter 47a is used for reading fluorescence emission by stimulating a fluorescent substance contained in a number of the absorptive regions 4 formed in the substrate 2 of the biochemical analysis unit 1 using the first laser stimulating ray source 21 and has a property of cutting off light having a wavelength of 640 nm but transmitting light having a wavelength longer than 640 nm.

The filter 47b is used for reading fluorescence emission by stimulating a fluorescent substance contained in a number of the absorptive regions 4 formed in the substrate 2 of the biochemical analysis unit 1 using the second laser stimulating ray source 22 and has a property of cutting off light having a wavelength of 532 nm but transmitting light having a wavelength longer than 532 nm.

The filter 47c is used for reading fluorescence emission by stimulating a fluorescent substance contained in a number of the absorptive regions 4 formed in the substrate 2 of the biochemical analysis unit 1 using the third laser stimulating ray source 23 and has a property of cutting off light having a wavelength of 473 nm but transmitting light having a wavelength longer than 473 nm.

The filter 47d is used for reading stimulated emission released from stimulable phosphor contained in the stimulable phosphor layer 12 formed in the stimulable phosphor sheet 10 upon being stimulated using the first laser stimulating ray source 1 and has a property of transmitting only light having a wavelength corresponding to that of stimulated emission emitted from stimulable phosphor and cutting off light having a wavelength of 640 nm.

Therefore, in accordance with the kind of a stimulating ray source to be used, one of these filters 47a, 47b, 47c, 47d is selectively positioned in front of the photomultiplier 50 by rotating the filter unit 45, thereby enabling the photomultiplier 50 to photoelectrically detect only light to be detected.

When chemiluminescence data recorded in a number of the absorptive regions 4 formed in the substrate 2 of the biochemical analysis unit 1 are to be read to produce biochemical analysis data, the laser stimulating ray sources are kept off and the disc 46 is rotated so that the opening is located in front of the photomultiplier 50.

Analog data produced by photoelectrically detecting stimulated emission, fluorescence emission or chemiluminescence emission by the photomultiplier 50 are digitized by an A/D converter 53 to produce digital data and the digital data forwarded to a data processing apparatus 54.

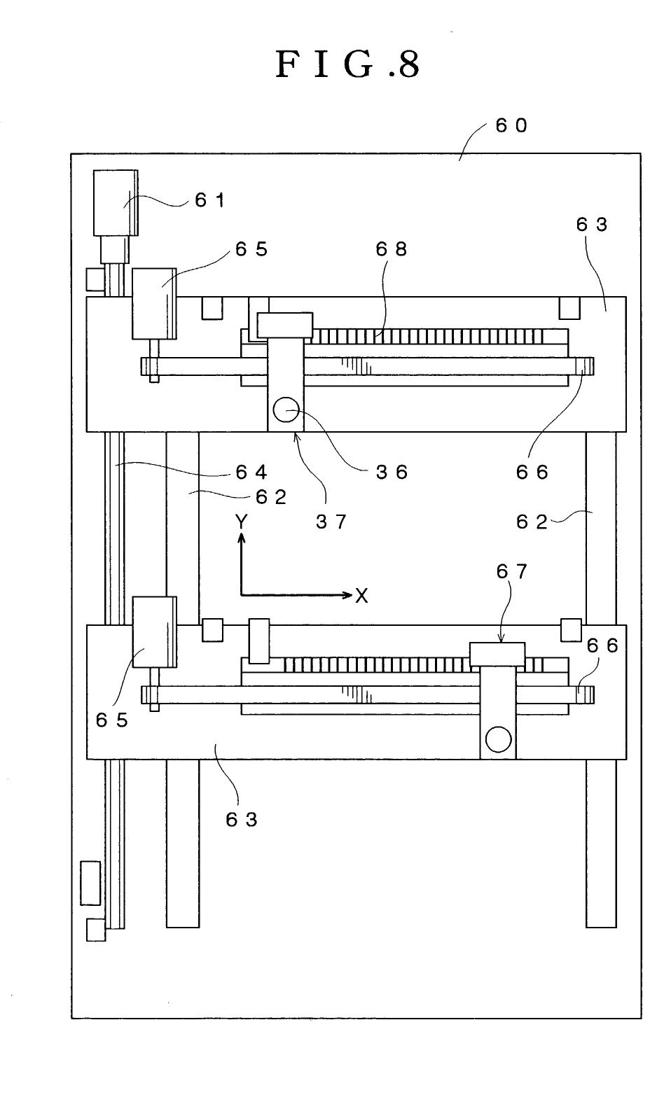

FIG. 8 is a schematic plan view showing a scanning mechanism of the optical fiber bundle 36.

As shown in FIG. 8, the scanning mechanism of the optical fiber bundle 36 includes a base plate 60, and a sub-scanning pulse motor 61 and a pair of rails 62, 62 are fixed on the base plate 60. A movable base plate 63 is further provided so as to be movable in the sub-scanning direction indicated by an arrow Y in FIG. 8.

The movable base plate 63 is formed with a threaded hole (not shown) and a threaded rod 64 rotated by the sub-scanning pulse motor 61 is engaged with the inside of the hole.

A main scanning stepping motor 65 is provided on the movable base plate 63. The main scanning stepping motor 65 is adapted for intermittently driving an endless belt 66 by a pitch equal to the distance between neighboring stimulable phosphor layer regions 12 formed in the support 11 of the stimulable phosphor sheet 10 and neighboring absorptive regions 4 formed in the substrate 2 of the biochemical analysis unit 1.

The optical fiber bundle 36 is mounted on the head 37 fixed to the endless belt 66 in the vicinity thereof facing the stimulable phosphor sheet 10 or the biochemical analysis unit 1 placed on the sample stage 40 and when the endless belt 66 is driven by the main scanning stepping motor 65, the optical fiber bundle 36 is moved in the main scanning direction indicated by an arrow X in FIG. 8. In FIG. 8, the reference numeral 67 designates a linear encoder for detecting the position of the light receiving end portion 36a of the optical fiber bundle 36 in the main scanning direction and the reference numeral 68 designates slits of the linear encoder 67.

Therefore, the light receiving end portion 36a of the optical fiber bundle 36 is moved in the main scanning direction indicated by the arrow X and the sub-scanning direction indicated by the arrow Y in FIG. 8 by driving the endless belt 66 in the main scanning direction by the main scanning stepping motor 65 and intermittently moving the movable base plate 63 in the sub-scanning direction by the sub-scanning pulse motor 61, thereby scanning all of the stimulable phosphor layer regions 12 formed in the support 11 of the stimulable phosphor sheet 10 or all of the absorptive regions 4 formed in the substrate 2 of the biochemical analysis unit 1 with the laser beam 24.

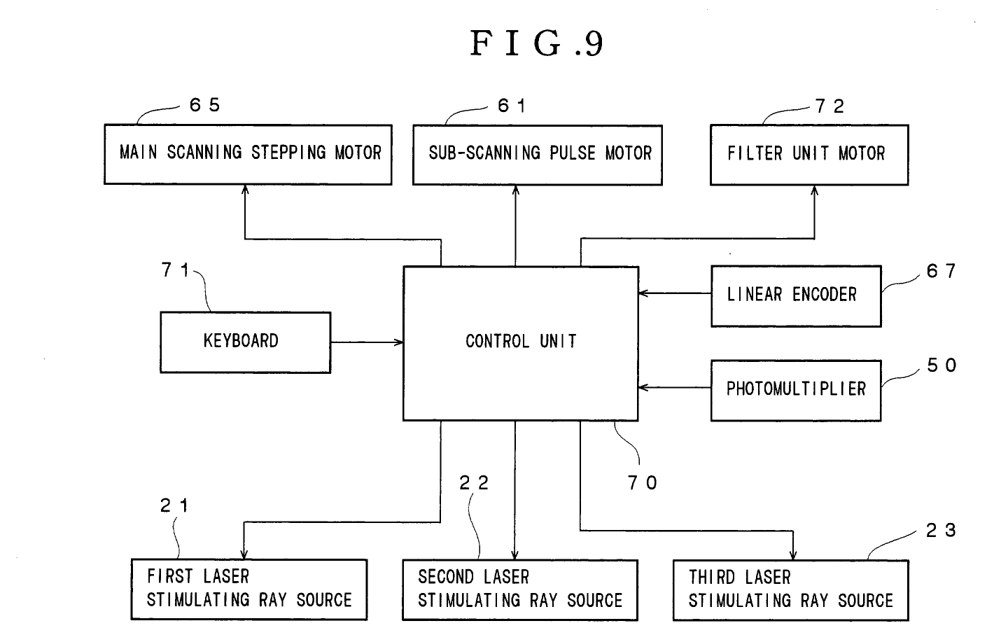

FIG. 9 is a block diagram of a control system, an input system, a drive system and a detection system of the scanner which is a preferred embodiment of the present invention.

As shown in FIG. 9, the control system of the scanner includes a control unit 70 for controlling the overall operation of the scanner, and the input system of the first scanner includes a keyboard 71 which can be operated by a user and through which various instruction signals can be input.

As shown in FIG. 9, the drive system of the scanner includes the main scanning stepping motor 65 for intermittently moving the light receiving end portion 36a of the optical fiber bundle 36 in the main scanning direction, the sub-scanning pulse motor 61 for moving the light receiving end portion 36a of the optical fiber bundle 36 in the sub-scanning direction and a filter unit motor 72 for rotating the disc 46 of the filter unit 45 provided with the four filter members 47a, 47b, 47c and 47d.

The control unit 70 is adapted for selectively outputting a drive signal to the first laser stimulating ray source 21, the second laser stimulating ray source 22 or the third laser stimulating ray source 23 and outputting a drive signal to the filter unit motor 72.

Further, as shown in FIG. 9, the detection system of the scanner includes the photomultiplier 50 and the linear encoder 67 for detecting the position of the light receiving end portion 36a of the optical fiber bundle 36 in the main scanning direction.

In this embodiment, the control unit 70 is adapted to control the on and off operation of the first laser stimulating ray source 21, the second laser stimulating ray source 22 or the third laser stimulating ray source 23 in accordance with a detection signal indicating the position of the light receiving end portion 36a of the optical fiber bundle 36.

The thus constituted scanner reads radiation data recorded in a number of the stimulable phosphor layer regions 12 formed in the support 11 of the stimulable phosphor sheet 10 and produces biochemical analysis data in the following manner.

A stimulable phosphor sheet 10 in which radiation data are recorded is first set on the stage 40 by a user.

An instruction signal indicating that radiation data recorded in a number of the stimulable phosphor layer regions 12 formed in the support 11 of the stimulable phosphor sheet 10 are to be read is then input through the keyboard 71.

The instruction signal input through the keyboard 71 is input to the control unit 70 and the control unit 70 outputs a drive signal to the filter unit motor 72 in accordance with the instruction signal, thereby rotating the disc 46 of the filter unit 48 so as to locate the filter 47d having a property of transmitting only light having a wavelength corresponding to that of stimulated emission emitted from stimulable phosphor but cutting off light having a wavelength of 640 nm in the optical path of stimulated emission.

The control unit 70 further outputs a drive signal to the main scanning stepping motor 65 to move the light receiving end portion 36a of the optical fiber bundle 36 in the main scanning direction and when it determines based on a detection signal indicating the position of the light receiving end portion 36a of the optical fiber bundle 36 input from the linear encoder 67 that the light receiving end portion 36a of the optical fiber bundle 36 has reached a position where a laser beam 24 can be projected onto a first stimulable phosphor layer region 12 among a number of the stimulable phosphor layer regions 12 formed in the support 11 of the stimulable phosphor sheet 10, it outputs a drive stop signal to the main scanning stepping motor 65 and a drive signal to the first laser stimulating ray source 21, thereby actuating it to emit a laser beam 24 having a wavelength of 640 nm.

A laser beam 24 emitted from the first laser stimulating source 21 passes through the collimator lens 25, thereby being made a parallel beam, and is reflected by the mirror 26.

The laser beam 24 reflected by the mirror 26 passes through the first dichroic mirror 27 and the second dichroic mirror 28 and advances to the mirror 29.

The laser beam 24 advancing to the mirror 29 is reflected by the mirror 29 and advances to the mirror 32 to be reflected thereby.

The laser beam 24 reflected by the mirror 32 passes through the hole 33 of the perforated mirror 34 and advances to the convex lens 35.

The laser beam 24 advancing to the convex lens 35 is condensed onto one end portion of an optical fiber bundle 36.

The laser beam 24 is guided by the optical fiber bundle 36 and impinges the first stimulable phosphor layer region 12 formed in the support 11 of the stimulable phosphor sheet 10.

When the laser beam 24 impinges onto the first stimulable phosphor layer region 12 formed in the support 11 of the stimulable phosphor sheet 10, stimulable phosphor contained in the first stimulable phosphor layer region 12 is excited by the laser beam 24, thereby releasing stimulated emission from the first stimulable phosphor layer region 12.

In this embodiment, since the optical fiber bundle 36 is mounted on the head 37 in such a manner that the light receiving end portion 36a is located sufficiently close to the stimulable phosphor sheet 10 placed on the sample stage 40, the laser beam 24 is reliably led to the first stimulable phosphor layer region 12 of the stimulable phosphor sheet 10. Therefore, it is possible to effectively prevent the laser beam 24 from entering neighboring stimulable phosphor layer regions 12 next to the first stimulable phosphor layer region 12 and excite stimulable phosphor contained therein to cause it to release stored radiation energy in the form of stimulated emission and also possible for the light receiving end portion 36a of the optical fiber bundle 36 to receive only stimulated emission released from the first stimulable phosphor layer region 12 of the stimulable phosphor sheet 10.

Stimulated emission released from stimulable phosphor contained in the first stimulable phosphor layer region 12 of the stimulable phosphor sheet 10 enters the light receiving end portion 36a of the optical fiber bundle 36 and led by the optical fiber bundle 36 to the convex lens 35.

The stimulated emission led to the convex lens 35 is made a parallel beam and impinges on the perforated mirror 34.

The stimulated emission impinging on the perforated mirror 34 is reflected by the perforated mirror 34 and enters the filter 47d of the filter unit 45.

Since the filter 47d has a property of transmitting only light having a wavelength corresponding to that of stimulated emission emitted from stimulable phosphor and cutting off light having a wavelength of 640 nm, light having a wavelength of 640 nm corresponding to that of the stimulating ray is cut off by the filter 47d and only light having a wavelength corresponding to that of stimulated emission and released from the first stimulable phosphor layer region 12 of the stimulable phosphor sheet 10 passes through the filter 47d to be photoelectrically detected by the photomultiplier 50.

Analog data produced by photoelectrically detecting stimulated emission with the photomultiplier 50 are converted by the A/D converter 53 into digital data and the digital data are fed to the data processing apparatus 54.

When a predetermined time, for example, several microseconds, has passed after the first laser stimulating ray source 21 was turned on, the control unit 70 outputs a drive stop signal to the first laser stimulating ray source 21, thereby turning it off and outputs a drive signal to the main scanning stepping motor 65, thereby moving the light receiving end portion 36a of the optical fiber bundle 36 by one pitch equal to the distance between neighboring stimulable phosphor layer regions 12 formed in the support 11 of the stimulable phosphor sheet 10.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring stimulable phosphor layer regions 12 and has reached a position where a laser beam 24 can be projected onto a second stimulable phosphor layer region 12 next to the first stimulable phosphor layer region 12 formed in the stimulable phosphor sheet 10, it outputs a drive signal to the first laser stimulating ray source 21 to turn it on, thereby causing the laser beam 24 to excite stimulable phosphor contained in the second stimulable phosphor layer region 12 formed in the stimulable phosphor sheet 10 next to the first stimulable phosphor layer region 12.

Similarly to the above, the second stimulable phosphor layer region 12 formed in the stimulable phosphor sheet 10 is irradiated with the laser beam 24 for a predetermined time and when stimulated emission released from the second stimulable phosphor layer region 12 is photoelectrically detected by the photomultiplier 50, the control unit 70 outputs a drive stop signal to the first laser stimulating ray source 21, thereby turning it off and outputs a drive signal to the main scanning stepping motor 65, thereby moving the light receiving end portion 36a of the optical fiber bundle 36 by one pitch equal to the distance between neighboring stimulable phosphor layer regions 12.

In this manner, the on and off operation of the first laser stimulating ray source 21 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that the stimulable phosphor layer regions 12 included in a first line of the stimulable phosphor layer regions 12 formed in the support 11 of the stimulable phosphor sheet 10 have been scanned with the laser beam 24, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the stimulable phosphor layer regions 12 included in the first line of the stimulable phosphor layer regions 12 formed in the support 11 of the stimulable phosphor sheet 10 were sequentially irradiated with the laser beam 24 emitted from the first laser stimulating ray source 21, the stimulable phosphor layer regions 12 included in a second line of the stimulable phosphor layer regions 12 formed in the support 11 of the stimulable phosphor sheet 10 are sequentially irradiated with the laser beam 24 emitted from the first laser stimulating ray source 21, thereby exciting stimulable phosphor contained in the stimulable phosphor layer regions 12 included in the second line and stimulated emission released from the stimulable phosphor layer regions 12 is sequentially and photoelectrically detected by the photomultiplier 50.

Analog data produced by photoelectrically detecting stimulated emission with the photomultiplier 50 are converted by the A/D converter 53 into digital data and the digital data are fed to the data processing apparatus 54.

When all of the stimulable phosphor layer regions 12 formed in the support 11 of the stimulable phosphor sheet 10 have been scanned with the laser beam 24 to excite stimulable phosphor contained in the stimulable phosphor layer regions 12 and digital data produced by photoelectrically detecting stimulated emission released from the stimulable phosphor layer regions 12 by the photomultiplier 50 to produce analog data and digitizing the analog data by the A/D converter 53 have been forwarded to the data processing apparatus 54, the control unit 70 outputs a drive stop signal to the first laser stimulating ray source 21, thereby turning it off.

As described above, radiation data of the radioactive labeling substance recorded in a number of the stimulable phosphor layer regions 12 formed in the support 11 of the stimulable phosphor sheet 10 are read by the scanner to produce biochemical analysis data.

On the other hand, when fluorescence data of a fluorescent substance recorded in a number of the absorptive regions 4 formed in the substrate 2 of the biochemical analysis unit 1 are to be read to produce biochemical analysis data, the biochemical analysis unit 1 is first set by the user on the stage 40.

An instruction signal identifying the kind of a fluorescent substance such as a fluorescent dye labeling a substance derived from a living organism and indicating that fluorescence data are to be read is then input by the user through the keyboard 71.

When the instruction signal is input by the user through the keyboard 71, the control unit 70 selects a laser stimulating ray source from among the first laser stimulating ray source 21, the second laser stimulating ray source 22 and the third laser stimulating ray source 23 and selects the filter to be located in the optical path of fluorescence emission from among the three filter 47a, 47b and 47c.

For example, when Rhodamine (registered trademark), which can be most efficiently stimulated by a laser beam having a wavelength of 532 nm, is used as a fluorescent substance for labeling a substance derived from a living organism and an instruction signal indicating such a fact is input, the control unit 70 selects the second laser stimulating ray source 22 and the filter 47b and outputs a drive signal to the filter unit motor 72, thereby rotating the disc 46 of the filter unit 45 so that the filter 47b having a property of cutting off light having a wavelength of 532 nm but transmitting light having a wavelength longer than 532 nm in the optical path of the fluorescence emission to be released from the biochemical analysis unit 1. The control unit 70 further outputs a drive signal to the main scanning stepping motor 65 to move the light receiving end portion 36a of the optical fiber bundle 36 in the main scanning direction and when it determines based on a detection signal indicating the position of the light receiving end portion 36a of the optical fiber bundle 36 input from the linear encoder 67 that the light receiving end portion 36a of the optical fiber bundle 36 has reached a position where a laser beam 24 can be projected onto a first absorptive region 4 among a number of the absorptive regions 4 formed in the substrate 2 of the biochemical analysis unit 1, it outputs a drive stop signal to the main scanning stepping motor 65 and a drive signal to the second laser stimulating ray source 22, thereby actuating it to emit a laser beam 24 having a wavelength of 532 nm.

The laser beam 24 emitted from the second laser stimulating ray source 22 is made a parallel beam by the collimator lens 30, advances to the first dichroic mirror 27 and is reflected thereby.

The laser beam 24 reflected by the first dichroic mirror 27 transmits through the second dichroic mirror 28 and advances to the mirror 29.

The laser beam 24 advancing to the mirror 29 is reflected by the mirror 29 and further advances to the mirror 32 to be reflected thereby.

The laser beam 24 reflected by the mirror 32 advances to the perforated mirror 34 and passes through the hole 33 of the perforated mirror 34. Then, the laser beam 24 advances to the convex lens 35.

The laser beam 24 advancing to the convex lens 35 is condensed onto one end portion of the optical fiber bundle 36.

The laser beam 24 is guided by the optical fiber bundle 36 and impinges on the first absorptive region 4 formed in the substrate 2 of the biochemical analysis unit 1.

When the laser beam 24 impinges onto the first absorptive region 4 formed in the substrate 2 of the biochemical analysis unit 1, a fluorescent substance such as a fluorescent dye, for instance, Rhodamine, contained in the absorptive region 4 is stimulated by the laser beam 24 and fluorescence emission is released from Rhodamine.

In this embodiment, since the optical fiber bundle 36 is mounted on the head 37 in such a manner that the light receiving end portion 36a is located sufficiently close to the stimulable phosphor sheet 10 placed on the sample stage 40, the laser beam 24 is reliably led to the first absorptive region 4 of the biochemical analysis unit 1. Therefore, it is possible to effectively prevent the laser beam 24 from entering neighboring absorptive regions 4 next to the first absorptive region 4 and excite a fluorescent substance contained therein to cause it to release fluorescence emission and also possible for the light receiving end portion 36a of the optical fiber bundle 36 to receive only fluorescence emission released from the first absorptive region 4 of the biochemical analysis unit 1.

Further, in this embodiment, since a number of the absorptive regions 4 of the biochemical analysis unit 1 are formed by charging nylon-6 in the through-holes 3 formed in the substrate 2 made of stainless steel and the substrate 2 has a property of attenuating light energy, it is possible to effectively prevent fluorescence emission released from the individual absorptive regions 4 in response to the excitation of a fluorescent substance with the laser beam 24 from being mixed with fluorescence emission released from neighboring absorptive regions 4.

Fluorescence emission released from a fluorescent substance contained in the first absorptive region 4 of the biochemical analysis unit 1 enters the light receiving end portion 36a of the optical fiber bundle 36 and led by the optical fiber bundle 36 to the convex lens 35.

The fluorescence emission led to the convex lens 35 is made a parallel beam and advances to the perforated mirror 34.

The fluorescence emission advancing to the perforated mirror 34 is reflected by the perforated mirror 34 and enters the filter 47b of the filter unit 45.

Since the filter 47b has a property of cutting off light having a wavelength of 532 nm but transmitting light having a wavelength longer than 532 nm, light having the same wavelength of 532 nm as that of the stimulating ray is cut off by the filter 47b and only light in the wavelength of the fluorescence emission released from Rhodamine passes through the filter 47b to be photoelectrically detected by the photomultiplier 50.

Analog data produced by photoelectrically detecting fluorescence emission with the photomultiplier 50 are converted by the A/D converter 53 into digital data and the digital data are fed to the data processing apparatus 54.

When a predetermined time, for example, several microseconds, has passed after the second laser stimulating ray source 22 was turned on, the control unit 70 outputs a drive stop signal to the second laser stimulating ray source 22, thereby turning it off and outputs a drive signal to the main scanning stepping motor 65, thereby moving the optical head 35 by one pitch equal to the distance between neighboring absorptive regions 4 formed in the substrate 2 of the biochemical analysis unit 1.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring absorptive regions 4 and has reached a position where a laser beam 24 can be projected onto a second absorptive region 4 next to the first absorptive region 4 formed in the substrate 2 of the biochemical analysis unit 1, it outputs a drive signal to the second laser stimulating ray source 22 to turn it on, thereby causing the laser beam 24 to excite a fluorescent substance, for example, Rhodamine, contained in the second absorptive region 4 formed in the substrate 2 of the biochemical analysis unit 1 next to the first absorptive region 4.

Similarly to the above, the second absorptive region 4 formed in the substrate 2 of the biochemical analysis unit 1 is irradiated with the laser beam 24 for a predetermined time and when fluorescence emission released from the second absorptive region 4 is photoelectrically detected by the photomultiplier 50, the control unit 70 outputs a drive stop signal to the second laser stimulating ray source 22, thereby turning it off and outputs a drive signal to the main scanning stepping motor 65, thereby moving the light receiving end portion 36a of the optical fiber bundle 36 by one pitch equal to the distance between neighboring absorptive regions 4.

In this manner, the on and off operation of the second laser stimulating ray source 22 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that the absorptive regions 4 included in a first line of the absorptive regions 4 formed in the substrate 2 of the biochemical analysis unit 1 have been scanned with the laser beam 24, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the absorptive regions 4 included in the first line of the absorptive regions 4 formed in the substrate 2 of the biochemical analysis unit 1 were sequentially irradiated with the laser beam 24 emitted from the second laser stimulating ray source 22, the absorptive regions 4 included in a second line of the absorptive regions 4 formed in the substrate 2 of the biochemical analysis unit 1 are sequentially irradiated with the laser beam 24 emitted from the second laser stimulating ray source 22, thereby exciting Rhodamine contained in the absorptive regions 4 included in the second line and fluorescence emission released from the absorptive regions 4 included in the second line is sequentially and photoelectrically detected by the photomultiplier 50.

Analog data produced by photoelectrically detecting fluorescence emission with the photomultiplier 50 are converted by the A/D converter 53 into digital data and the digital data are fed to the data processing apparatus 54.

When all of the absorptive regions 4 formed in the substrate 2 of the biochemical analysis unit 1 have been scanned with the laser beam 24 to excite Rhodamine contained in the absorptive regions 4 and digital data produced by photoelectrically detecting fluorescence emission released from the absorptive regions 4 by the photomultiplier 50 to produce analog data and digitizing the analog data by the A/D converter 53 have been forwarded to the data processing apparatus 54, the control unit 70 outputs a drive stop signal to the second laser stimulating ray source 22, thereby turning it off.

As described above, fluorescence data recorded in a number of the absorptive regions 4 formed in the substrate 2 of the biochemical analysis unit 1 are read by the scanner to produce biochemical analysis data.

On the other hand, when chemiluminescence data recorded in a number of the absorptive regions 4 formed in the substrate 2 of the biochemical analysis unit 1 are to be read to produce biochemical analysis data, the biochemical analysis unit 1 is placed on the sample stage 40 while in a state of releasing chemiluminescence emission from a number of the absorptive regions 4 as a result of contact of a labeling substance contained in a number of the absorptive regions 4 formed in the biochemical analysis unit 1 and a chemiluminescent substrate.

An instruction signal indicating that chemilumnescence data are to be read is then input through the keyboard 71 by the user.

The instruction signal input by the user through the keyboard 71 is input to the control unit 70 and when the control unit 70 receives the instruction signal, it outputs a drive signal to the filter unit motor 72, thereby causing it to rotate the disc 46 of the filter unit 45 so that the opening 48 is located in the optical path of chemiluminescence emission to be released from the biochemical analysis unit.

The control unit 70 further outputs a drive signal to the main stepping motor 65, thereby moving the light receiving end portion 36a of the optical fiber bundle 36 in the main scanning direction and when it determines based on a detection signal indicating the position of the light receiving end portion 36a of the optical fiber bundle 36 input from the linear encoder 67 that the light receiving end portion 36a of the optical fiber bundle 36 has reached a position where the light receiving end portion 36a of the optical fiber bundle 36 can receive chemiluminescence emission released from the first absorptive region 4 among a number of the absorptive regions 4 formed in the substrate 2 of the biochemical analysis unit 1, it outputs a drive stop signal to the main scanning stepping motor 65 and a drive signal to the photomultiplier 50, thereby causing it to start detecting chemiluminescence emission.

In this embodiment, since a number of the absorptive regions 4 of the biochemical analysis unit 1 are formed by charging nylon-6 in the through-holes 3 formed in the substrate 2 made of stainless steel and the substrate 2 has a property of attenuating light energy, it is possible to effectively prevent chemiluminescence emission released from the individual absorptive regions 4 from being mixed with chemiluminescence emission released from neighboring absorptive regions 4.

Further, in this embodiment, since the optical fiber bundle 36 is mounted on the head 37 in such a manner that the light receiving end portion 36a is located sufficiently close to the stimulable phosphor sheet 10 placed on the sample stage 40, only chemiluminescence emission released from the first absorptive region 4 of the biochemical analysis unit 1 can be received by the light receiving end portion 36a of the optical fiber bundle 36 and it is possible to reliably prevent the light receiving end portion 36a of the optical fiber bundle 36 from simultaneously receiving chemiluminescence emission released from neighboring absorptive regions 4.

Chemiluminescence emission released from the first absorptive region 4 of the biochemical analysis unit 1 enters the light receiving end portion 36a of the optical fiber bundle 36 and led by the optical fiber bundle 36 to the convex lens 35.

The chemiluminescence emission led to the convex lens 35 is made a parallel beam and advances to the perforated mirror 34.

The chemiluminescence emission advancing to the perforated mirror 34 is reflected by the perforated mirror 34 and enters the filter unit 45. When chemiluminescence data are to be read, since the disc 46 of the filter unit 45 has been rotated so that the opening 48 is located in the optical path of chemiluminescence emission, the chemiluminescence emission reflected by the perforated mirror 34 passes through the opening 48 of the filter unit 45 and is photoelectrically detected by the photomultiplier 50.

Analog data produced by photoelectrically detecting chemiluminescence emission with the photomultiplier 50 are converted by the A/D converter 53 into digital data and the digital data are fed to the data processing apparatus 54.

When a predetermined time has passed after the photomultiplier 50 was turned on, the control unit 70 outputs a drive stop signal to the photomultiplier 50, thereby turning it off and outputs a drive signal to the main scanning stepping motor 65, thereby moving the light receiving end portion 36a of the optical fiber bundle 36 by one pitch equal to the distance between neighboring absorptive regions 4 formed in the substrate 2 of the biochemical analysis unit 1.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring absorptive regions 4 and has reached a position where the light receiving end portion 36a of the optical fiber bundle 36 can receive chemiluminescence emission released from the second absorptive region 4 next to the first absorptive region 4 formed in the substrate 2 of the biochemical analysis unit 1, it outputs a drive stop signal to the main scanning stepping motor 65 and a drive signal to the photomultiplier 50, thereby turning it on to cause it to photoelectrically detect chemiluminescence emission released from the second absorptive region 4 formed in the substrate 2 of the biochemical analysis unit 1 and led by the optical fiber bundle 36.

Similarly to the above, when chemiluminescence emission released from the second absorptive region 4 formed in the substrate 2 of the biochemical analysis unit 1 has been photoelectrically detected by the photomultiplier 50 for a predetermined time to produce analog data, the control unit 70 outputs a drive stop signal to the photomultiplier 50, thereby turning it off and outputs a drive signal to the main scanning stepping motor 65, thereby moving the light receiving end portion 36a of the optical fiber bundle 36 by one pitch equal to the distance between neighboring absorptive regions 4 formed in the substrate 2 of the biochemical analysis unit 1.

In this manner, the on and off operation of the photomultiplier 50 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that chemiluminescence emission released from the absorptive regions 4 included in a first line of the absorptive regions 4 formed in the substrate 2 of the biochemical analysis unit 1 have been received by the light receiving end portion 36a of the optical fiber bundle 36 and photoelectrically detected by the photomultiplier 50, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which chemiluminescence emission released from the absorptive regions 4 included in the first line of the absorptive regions 4 formed in the substrate 2 of the biochemical analysis unit 1 was sequentially received by the light receiving end portion 36a of the optical fiber bundle 36 and photoelectrically detected by the photomultiplier 50, chemiluminescence emission released from the absorptive regions 4 included in a second line of the absorptive regions 4 formed in the substrate 2 of the biochemical analysis unit 1 is sequentially received by the light receiving end portion 36a of the optical fiber bundle 36 and photoelectrically detected by the photomultiplier 50.

Analog data produced by photoelectrically detecting chemiluminescence emission with the photomultiplier 50 are converted by the A/D converter 53 into digital data and the digital data are fed to the data processing apparatus 54.

When chemiluminescence emission released from all of the absorptive regions 4 formed in the substrate 2 of the biochemical analysis unit 1 have been received by the light receiving end portion 36a of the optical fiber bundle 36 and photoelectrically detected by the photomultiplier 50 and digital data produced by photoelectrically detecting chemiluminescence emission released from the absorptive regions 4 by the photomultiplier 50 to produce analog data and digitizing the analog data by the A/D converter 53 have been forwarded to the data processing apparatus 54, the control unit 70 outputs a drive stop signal to the photomultiplier 50, thereby turning it off.

As described above, chemiluminescence data recorded in a number of the absorptive regions 4 formed in the substrate 2 of the biochemical analysis unit 1 are read by the scanner shown in FIGS. 6 to 9 to produce biochemical analysis data.

In this embodiment, chemiluminescence data recorded in a number of the absorptive regions 4 formed in the substrate 2 of the biochemical analysis unit 1 can be transferred onto a stimulable phosphor sheet and biochemical analysis data can be produced by reading chemiluminescence data transferred onto the stimulable phosphor sheet by a scanner described later.

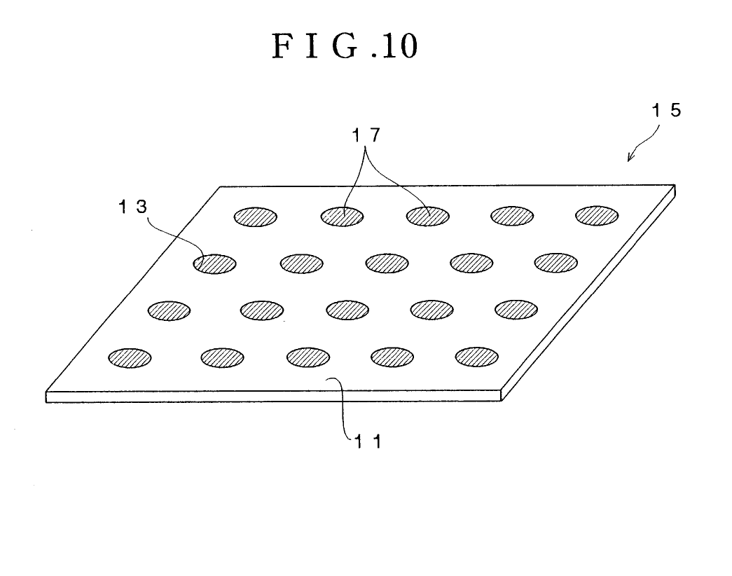

FIG. 10 is a schematic perspective view showing a stimulable phosphor sheet onto which chemiluminescence data are to be transferred and used in a method for producing biochemical analysis data which is a preferred embodiment of the present invention.

A stimulable phosphor sheet 15 shown in FIG. 10 has the same configuration as that of the stimulable phosphor sheet 10 shown in FIG. 4 except that a number of stimulable phosphor layer regions 17 are formed by charging SrS system stimulable phosphor capable of absorbing and storing light energy in the through-holes 13 formed in the support 11 made of stainless steel.

Chemiluminescence data recorded in a number of the absorptive regions 4 formed in the substrate 2 of the biochemical analysis unit 1 are transferred onto a number of the stimulable phosphor layer regions 17 of the stimulable phosphor sheet 15 shown in FIG. 10.

When chemiluminescence data recorded in a number of the absorptive regions 4 formed in the substrate 2 of the biochemical analysis unit 1 are to be transferred onto a number of the stimulable phosphor layer regions 17 of the stimulable phosphor sheet 15, a number of the absorptive regions 4 of the biochemical analysis unit 1 are first brought into contact with a chemiluminescent substrate.

As a result, chemiluminescence emission in a wavelength of visible light is selectively released from a number of the absorptive regions 4 of the biochemical analysis unit 1.

Similarly to the manner shown in FIG. 5, the stimulable phosphor sheet 15 is then superposed on the biochemical analysis unit 1 formed of a number of the absorptive regions 4 selectively releasing chemiluminescence emission in such a manner that each of the stimulable phosphor layer regions 17 formed in the support 11 of the stimulable phosphor sheet 15 faces the corresponding absorptive region 4 formed in the substrate 2 of the biochemical analysis unit 1.

In this manner, each of the stimulable phosphor layer regions 17 formed in the stimulable phosphor sheet 15 is kept to face the corresponding absorptive region 4 formed in the substrate 2 of the biochemical analysis unit 1 for a predetermined time period, whereby a number of the stimulable phosphor layer regions 17 formed in the stimulable phosphor sheet 15 are exposed to chemiluminescence emission released from a number of the absorptive regions 4 formed in the substrate 2 of the biochemical analysis unit 1.

In this embodiment, since the substrate 2 made of stainless steel capable of attenuating light energy are present around each of the absorptive regions 4 of the biochemical analysis unit 1, chemiluminescence emission released from the absorptive regions 4 of the biochemical analysis unit 1 during the exposure operation can be efficiently prevented from scattering in the biochemical analysis unit 1. Further, since the support 11 of the stimulable phosphor sheet 15 is made of stainless steel capable of attenuating light energy, chemiluminescence emission released from the absorptive regions 5 of the biochemical analysis unit 1 can be efficiently prevented from scattering in the support 11 of the stimulable phosphor sheet 15 and impinging on the stimulable phosphor layer regions 17 neighboring absorptive regions 5 face.

In this manner, chemiluminescence data are recorded in a number of the stimulable phosphor layer regions 17 formed in the support 11 of the stimulable phosphor sheet 15.

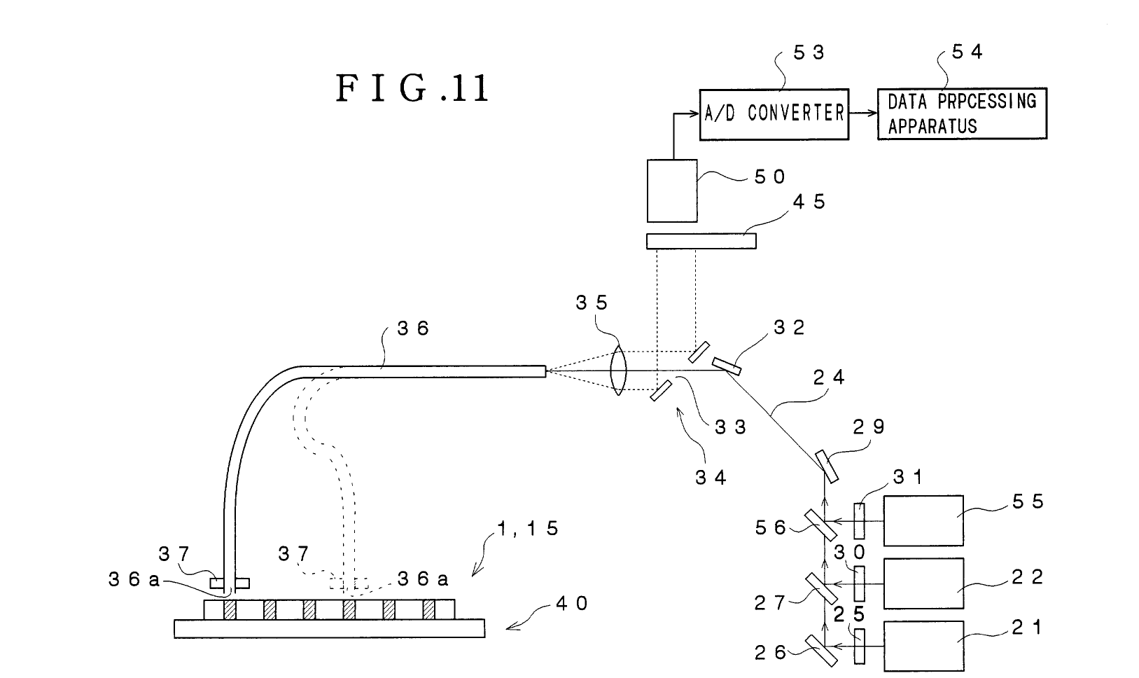

FIG. 11 is a schematic view showing a scanner for reading chemiluminescence data recorded in a number of the stimulable phosphor layer regions 17 formed in the support 11 of the stimulable phosphor sheet 15 and producing biochemical analysis data, which is another preferred embodiment of the present invention.

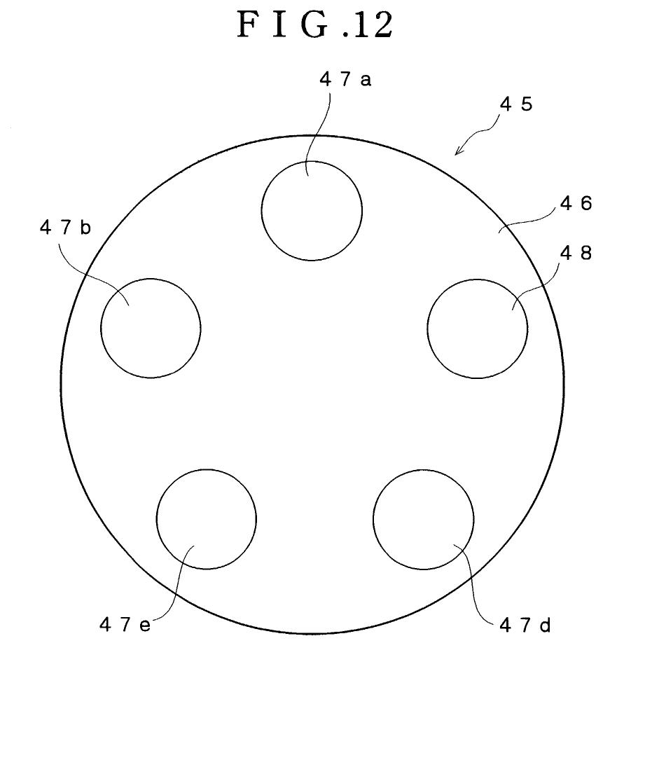

A scanner shown in FIG. 11 has the same configuration as that of the scanner shown in FIGS. 6 to 9 except that it includes a fourth laser stimulating ray source 55 for emitting a laser beam 24 having a wavelength of 980 nm which can effectively stimulate SrS system stimulable phosphor instead of the third laser stimulating ray source 23 for emitting a laser beam 24 having a wavelength of 473 nm and includes a third dichroic mirror 56 for transmitting light having a wavelength equal to and shorter than 640 nm but reflecting light having a wavelength of 980 nm instead of the second dichroic mirror 28 for transmitting light having a wavelength equal to and longer than 532 nm but reflecting light having a wavelength of 473 nm and that the filter unit 45 shown in FIG. 12 is provided with a filter 47e having a property of transmitting only light having a wavelength corresponding to that of stimulated emission emitted from stimulable phosphor and cutting off light having a wavelength of 980 nm instead of the filter 47c having a property of cutting off light having a wavelength of 473 nm but transmitting light having a wavelength longer than 473 nm.

The thus constituted scanner reads chemiluminescence data recorded in a number of the stimulable phosphor layer regions 17 of the stimulable phosphor sheet 15 and produces biochemical analysis data in the following manner.

A stimulable phosphor sheet 15 is first set on the stage 40 by a user.

An instruction signal indicating that radiation data recorded in the stimulable phosphor layer 17 formed in the stimulable phosphor sheet 15 are to be read is then input through the keyboard 71.

The instruction signal input through the keyboard 71 is input to the control unit 70 and the control unit 70 outputs a drive signal to the filter unit motor 72 in accordance with the instruction signal, thereby rotating the disc 46 of the filter unit 45 so that the filter 47e having a property of transmitting only light having a wavelength corresponding to that of stimulated emission emitted from the stimulable phosphor layer regions 17 and cutting off light having a wavelength of 980 nm in the optical path of stimulated emission.

The control unit 70 further outputs a drive signal to the main scanning stepping motor 65 to move the light receiving end portion 36a of the optical fiber bundle 36 in the main scanning direction and when it determines based on a detection signal indicating the position of the light receiving end portion 36a of the optical fiber bundle 36 input from the linear encoder 67 that the light receiving end portion 36a of the optical fiber bundle 36 has reached a position where a laser beam 24 can be projected onto a first stimulable phosphor layer region 17 among a number of the stimulable phosphor layer regions 17 formed in the stimulable phosphor sheet 15, it outputs a drive stop signal to the main scanning stepping motor 65 and a drive signal to the fourth laser stimulating ray source 55, thereby actuating it to emit a laser beam 24 having a wavelength of 980 nm.

A laser beam 24 emitted from the fourth laser stimulating ray source 55 passes through a collimator lens 31, thereby being made a parallel beam, and is reflected by the third dichroic mirror 56, thereby changing its direction by 90 degrees. The laser beam 24 then advances to the mirror 29.

The laser beam 24 advancing to the mirror 29 is reflected by the mirror 29 and advances to the mirror 32 to be reflected thereby.

The laser beam 24 reflected by the mirror 32 passes through the hole 33 of the perforated mirror 34 and advances to the convex lens 35.

The laser beam 24 advancing to the convex lens 35 is condensed onto one end portion of an optical fiber bundle 36.

The laser beam 24 is guided by the optical fiber bundle 36 and impinges the first stimulable phosphor layer region 17 formed in the support 11 of the stimulable phosphor sheet 15.

When the laser beam 24 impinges onto the first stimulable phosphor layer region 17 formed in the support 11 of the stimulable phosphor sheet 15, stimulable phosphor contained in the first stimulable phosphor layer region 17 is excited by the laser beam 24, thereby releasing stimulated emission from the first stimulable phosphor layer region 17.

In this embodiment, since the optical fiber bundle 36 is mounted on the head 37 in such a manner that the light receiving end portion 36a is located sufficiently close to the stimulable phosphor sheet 15 placed on the sample stage 40, the laser beam 24 is reliably led to the first stimulable phosphor layer region 17 of the stimulable phosphor sheet 15. Therefore, it is possible to effectively prevent the laser beam 24 from entering neighboring stimulable phosphor layer regions 17 next to the first stimulable phosphor layer region 17 and excite stimulable phosphor contained therein to cause it to release stored radiation energy in the form of stimulated emission and also possible for the light receiving end portion 36a of the optical fiber bundle 36 to receive only stimulated emission released from the first stimulable phosphor layer region 17 of the stimulable phosphor sheet 15.

Stimulated emission released from stimulable phosphor contained in the first stimulable phosphor layer region 17 of the stimulable phosphor sheet 15 enters the light receiving end portion 36a of the optical fiber bundle 36 and led by the optical fiber bundle 36 to the convex lens 35.

The stimulated emission led to the convex lens 35 is made a parallel beam and impinges on the perforated mirror 34.

The stimulated emission impinging on the perforated mirror 34 is reflected by the perforated mirror 34 and enters the filter 47d of the filter unit 45.

Since the filter 47e has a property of transmitting only light having a wavelength corresponding to that of stimulated emission emitted from stimulable phosphor and cutting off light having a wavelength of 980 nm, light having a wavelength of 980 nm corresponding to that of the stimulating ray is cut off by the filter 47e and only light having a wavelength corresponding to that of stimulated emission and released from the first stimulable phosphor layer region 17 of the stimulable phosphor sheet 15 passes through the filter 47e to be photoelectrically detected by the photomultiplier 50.

Analog data produced by photoelectrically detecting stimulated emission with the photomultiplier 50 are converted by the A/D converter 53 into digital data and the digital data are fed to the data processing apparatus 54.

When a predetermined time, for example, several microseconds, has passed after the fourth laser stimulating ray source 55 was turned on, the control unit 70 outputs a drive stop signal to the fourth laser stimulating ray source 55, thereby turning it off and outputs a drive signal to the main scanning stepping motor 65, thereby moving the light receiving end portion 36a of the optical fiber bundle 36 by one pitch equal to the distance between neighboring stimulable phosphor layer regions 17 formed in the support 11 of the stimulable phosphor sheet 15.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring stimulable phosphor layer regions 17 and has reached a position where a laser beam 24 can be projected onto a second stimulable phosphor layer region 17 next to the first stimulable phosphor layer region 17 formed in the stimulable phosphor sheet 15, it outputs a drive signal to the fourth laser stimulating ray source 55 to turn it on, thereby causing the laser beam 24 to excite stimulable phosphor contained in the second stimulable phosphor layer region 17 formed in the stimulable phosphor sheet 15 next to the first stimulable phosphor layer region 17.

Similarly to the above, the second stimulable phosphor layer region 17 formed in the stimulable phosphor sheet 15 is irradiated with the laser beam 24 for a predetermined time and when stimulated emission released from the second stimulable phosphor layer region 17 is photoelectrically detected by the photomultiplier 50, the control unit 70 outputs a drive stop signal to the fourth laser stimulating ray source 55, thereby turning it off and outputs a drive signal to the main scanning stepping motor 65, thereby moving the light receiving end portion 36a of the optical fiber bundle 36 by one pitch equal to the distance between neighboring stimulable phosphor layer regions 17.

In this manner, the on and off operation of the fourth laser stimulating ray source 55 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that the stimulable phosphor layer regions 17 included in a first line of the stimulable phosphor layer regions 17 formed in the support 11 of the stimulable phosphor sheet 15 have been scanned with the laser beam 24, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the stimulable phosphor layer regions 17 included in the first line of the stimulable phosphor layer regions 17 formed in the support 11 of the stimulable phosphor sheet 15 were sequentially irradiated with the laser beam 24 emitted from the fourth laser stimulating ray source 55, the stimulable phosphor layer regions 17 included in a second line of the stimulable phosphor layer regions 17 formed in the support 11 of the stimulable phosphor sheet 15 are sequentially irradiated with the laser beam 24 emitted from the fourth laser stimulating ray source 55, thereby exciting stimulable phosphor contained in the stimulable phosphor layer regions 17 included in the second line and stimulated emission 45 released from the stimulable phosphor layer regions 17 is sequentially and photoelectrically detected by the photomultiplier 50.

Analog data produced by photoelectrically detecting stimulated emission with the photomultiplier 50 are converted by the A/D converter 53 into digital data and the digital data are fed to the data processing apparatus 54.

When all of the stimulable phosphor layer regions 17 formed in the support 11 of the stimulable phosphor sheet 15 have been scanned with the laser beam 24 to excite stimulable phosphor contained in the stimulable phosphor layer regions 17 and digital data produced by photoelectrically detecting stimulated emission released from the stimulable phosphor layer regions 17 by the photomultiplier 50 to produce analog data and digitizing the analog data by the A/D converter 53 have been forwarded to the data processing apparatus 54, the control unit 70 outputs a drive stop signal to the fourth laser stimulating ray source 55, thereby turning it off.

As described above, chemiluminescence data recorded in a number of the stimulable phosphor layer regions 17 formed in the support 11 of the stimulable phosphor sheet 15 are read by the scanner to produce biochemical analysis data.

According to this embodiment, when a number of the stimulable phosphor layer regions 12 formed in the support 11 of the stimulable phosphor sheet 10 are exposed to a radioactive labeling substance selectively contained in a number of the absorptive regions 4 formed in the substrate 2 of the biochemical analysis unit 1, although electron beams (β rays) having high energy are released from the radioactive labeling substance contained in the absorptive regions 4 of the biochemical analysis unit 1, since a number of the absorptive regions 4 of the biochemical analysis unit 1 are formed spaced apart from each other in the substrate 2 made of stainless steel and the substrate 2 made of stainless steel capable of attenuating radiation energy is present around each of the absorptive regions 4, electron beams (β rays) released from the radioactive labeling substance contained in the absorptive regions 4 of the biochemical analysis unit 1 can be efficiently prevented from scattering in the substrate 2 of the biochemical analysis unit 1. Further, since a number of the stimulable phosphor layer regions 12 of the stimulable phosphor sheet 10 are formed by charging stimulable phosphor in a number of the through-holes 13 formed in the support 11 in the same pattern as that of the absorptive regions 4 formed in the substrate 2 of the biochemical analysis unit 1 and the stimulable phosphor sheet 10 is superposed on the biochemical analysis unit 1 in such a manner that each of the stimulable phosphor layer regions 12 faces the corresponding absorptive region 4 formed in the substrate 2 of the biochemical analysis unit 1, electron beams (β rays) released from a radioactive labeling substance contained in the individual absorptive regions 4 formed in the substrate 2 of the biochemical analysis unit 1 can be caused to advance to only the corresponding stimulable phosphor layer regions 12. Moreover, since the support 11 of the stimulable phosphor sheet 10 is made of stainless steel capable of attenuating radiation energy, electron beams (β rays) released from a radioactive labeling substance contained in the absorptive regions 4 formed in the substrate 2 of the biochemical analysis unit 1 can be effectively prevented from scattering in the support 11 of the stimulable phosphor sheet 10. Therefore, since the individual stimulable phosphor layer regions 12 of the stimulable phosphor sheet 10 can be effectively exposed to a radioactive labeling substance contained only in the corresponding absorptive regions 4 formed in the substrate 2 of the biochemical analysis unit 1, it is possible to effectively prevent noise caused by exposing a stimulable phosphor layer region 12 to be exposed to a radioactive labeling substance contained in the absorptive region 4 to electron beams (β rays) released from a radioactive labeling substance contained in neighboring absorptive regions 4 from being generated in biochemical analysis data and to improve the quantitative accuracy of biochemical analysis.

Further, according to in this embodiment, when a number of the stimulable phosphor layer regions 17 formed in the support 11 of the stimulable phosphor sheet 15 are exposed to chemiluminescence emission released from a number of the absorptive regions 4 formed in the substrate 2 of the biochemical analysis unit 1, since a number of the absorptive regions 4 of the biochemical analysis unit 1 are formed spaced apart from each other in the substrate 2 made of stainless steel and the substrate 2 made of stainless steel capable of attenuating light energy is present around each of the absorptive regions 4, chemiluminescence emission released from the absorptive regions 4 of the biochemical analysis unit 1 can be efficiently prevented from scattering in the substrate 2 of the biochemical analysis unit 1. Further, since a number of the stimulable phosphor layer regions 17 of the stimulable phosphor sheet 15 are formed by charging stimulable phosphor in a number of the through-holes 13 formed in the support 11 in the same pattern as that of the absorptive regions 4 formed in the substrate 2 of the biochemical analysis unit 1 and the stimulable phosphor sheet 15 is superposed on the biochemical analysis unit 1 in such a manner that each of the stimulable phosphor layer regions 17 faces the corresponding absorptive region 4 formed in the substrate 2 of the biochemical analysis unit 1, chemiluminescence emission released from the individual absorptive regions 4 formed in the substrate 2 of the biochemical analysis unit 1 can be caused to advance to only the corresponding stimulable phosphor layer regions 17. Moreover, since the support 11 of the stimulable phosphor sheet 10 is made of stainless steel capable of attenuating light energy, chemiluminescence emission released from the absorptive regions 4 formed in the substrate 2 of the biochemical analysis unit 1 can be effectively prevented from scattering in the support 11 of the stimulable phosphor sheet 15. Therefore, since the individual stimulable phosphor layer regions 17 of the stimulable phosphor sheet 15 can be effectively exposed to chemiluminescence emission released from the corresponding absorptive regions 4 formed in the substrate 2 of the biochemical analysis unit 1, it is possible to effectively prevent noise caused by exposing a stimulable phosphor layer region 17 to be exposed to chemiluminescence emission released from the absorptive region 4 to chemiluminescence emission released from neighboring absorptive regions 4 from being generated in biochemical analysis data and to improve the quantitative accuracy of biochemical analysis.

Furthermore, according to this embodiment, when radiation data recorded in a number of the stimulable phosphor layer regions 12 two-dimensionally formed so as to be spaced apart from each other in the support 11 of the stimulable phosphor sheet 10 are read by scanning a number of the stimulable phosphor layer regions 12 of the stimulable phosphor sheet 10 with the laser beam 24, thereby exciting stimulable phosphor contained therein and biochemical analysis data are produced, since the optical fiber bundle 36 whose light receiving end portion 36 is located at a position sufficiently close to the stimulable phosphor sheet 10 placed on the sample stage 40 is intermittently moved in the main scanning direction and the sub-scanning direction and a laser beam 24 is led to each of the stimulable phosphor layer regions 12 formed in the support 11 of the stimulable phosphor sheet 10 through the light receiving end portion 36a of the optical fiber bundle 36 facing the stimulable phosphor layer region 12 of the stimulable phosphor sheet 10, only a stimulable phosphor layer region 12 to be irradiated with the laser beam 24 can be irradiated with the laser beam 24. Therefore, it is possible to reliably prevent the laser beam 24 from entering stimulable phosphor layer regions 12 next to the stimulable phosphor layer region 12 to be irradiated with the laser beam 24 and causing them to release radiation energy stored therein and the quantitative accuracy of biochemical analysis can be markedly improved.

Moreover, according to this embodiment, when chemiluminescence data recorded in a number of the stimulable phosphor layer regions 17 two-dimensionally formed so as to be spaced apart from each other in the support 11 of the stimulable phosphor sheet 15 are read by scanning a number of the stimulable phosphor layer regions 17 of the stimulable phosphor sheet 15 with the laser beam 24, thereby exciting stimulable phosphor contained therein and biochemical analysis data are produced, since the optical fiber bundle 36 whose light receiving end portion 36 is located at a position sufficiently close to the stimulable phosphor sheet 15 placed on the sample stage 40 is intermittently moved in the main scanning direction and the sub-scanning direction and a laser beam 24 is led to each of the stimulable phosphor layer regions 17 formed in the support 11 of the stimulable phosphor sheet 15 through the light receiving end portion 36a of the optical fiber bundle 36 facing the stimulable phosphor layer region 17 of the stimulable phosphor sheet, only a stimulable phosphor layer region 17 to be irradiated with the laser beam 24 can be irradiated with the laser beam 24. Therefore, it is possible to reliably prevent the laser beam 24 from entering stimulable phosphor layer regions 17 next to the stimulable phosphor layer region 17 to be irradiated with the laser beam 24 and causing them to release the energy of chemiluminescence emission stored therein and the quantitative accuracy of biochemical analysis can be markedly improved.

Further, according to this embodiment, since the support 11 of the stimulable phosphor sheet 10 is made of stainless steel capable of attenuating light energy, it is possible to effectively prevent the laser beam 24 from scattering in the stimulable phosphor layer region 12 formed in the support 11 of the stimulable phosphor sheet 10 and entering stimulable phosphor layer regions 12 next to the stimulable phosphor layer region 12, thereby causing them to release radiation energy stored therein. Therefore, the quantitative accuracy of biochemical analysis can be markedly improved.

Furthermore, according to this embodiment, since the support 11 of the stimulable phosphor sheet 15 is made of stainless steel capable of attenuating light energy, it is possible to effectively prevent the laser beam 24 from scattering in the stimulable phosphor layer region 17 formed in the support 11 of the stimulable phosphor sheet 15 and entering stimulable phosphor layer regions 17 next to the stimulable phosphor layer region 17, thereby causing them to release the energy of chemiluminescence emission stored therein. Therefore, the quantitative accuracy of biochemical analysis can be markedly improved.

Moreover, according to this embodiment, when fluorescence data recorded in a number of the absorptive regions 4 two-dimensionally formed so as to be spaced apart from each other in the substrate 2 of the biochemical analysis unit 1 are read by scanning a number of the absorptive regions 4 of the biochemical analysis unit 1 with the laser beam 24, thereby stimulating a fluorescent substance contained therein and biochemical analysis data are produced, since the optical fiber bundle 36 whose light receiving end portion 36 is located at a position sufficiently close to the biochemical analysis unit 1 placed on the sample stage 40 is intermittently moved in the main scanning direction and the sub-scanning direction and a laser beam 24 is led to each of the absorptive regions 4 formed in the substrate 2 of the biochemical analysis unit 1 through the light receiving end portion 36a of the optical fiber bundle 36 facing the absorptive region 4 of the biochemical analysis unit, only an absorptive region 4 to be irradiated with the laser beam 24 can be irradiated with the laser beam 24. Therefore, it is possible to reliably prevent the laser beam 24 from entering absorptive regions 4 next to the absorptive region 4 to be irradiated with the laser beam 24 and stimulate a fluorescent substance contained therein, thereby causing it to release fluorescence emission and the quantitative accuracy of biochemical analysis can be markedly improved.

Further, according to this embodiment, when chemiluminescence data recorded in a number of the absorptive regions 4 formed in the substrate 2 of the biochemical analysis unit 1 are read to produce biochemical analysis data, since the optical fiber bundle 36 whose light receiving end portion 36 is located at a position sufficiently close to the biochemical analysis unit 1 placed on the sample stage 40 is intermittently moved in the main scanning direction and the sub-scanning direction and chemiluminescence emission released from each of the absorptive regions 4 formed in the substrate 2 of the biochemical analysis unit 1 is received by the light receiving end portion 36 of the optical fiber bundle 36 facing the absorptive region 4 of the biochemical analysis unit 1 and led to the photomultiplier 50 by the optical fiber bundle 36, it is possible to effectively prevent chemiluminescence emission released from absorptive regions 4 next the absorptive region 4 from which chemiluminescence emission to be detected is released from entering the light receiving end portion 36a of the optical fiber bundle 36 and being photoelectrically detected by the photomultiplier 50 and, therefore, the quantitative accuracy of biochemical analysis can be markedly improved.

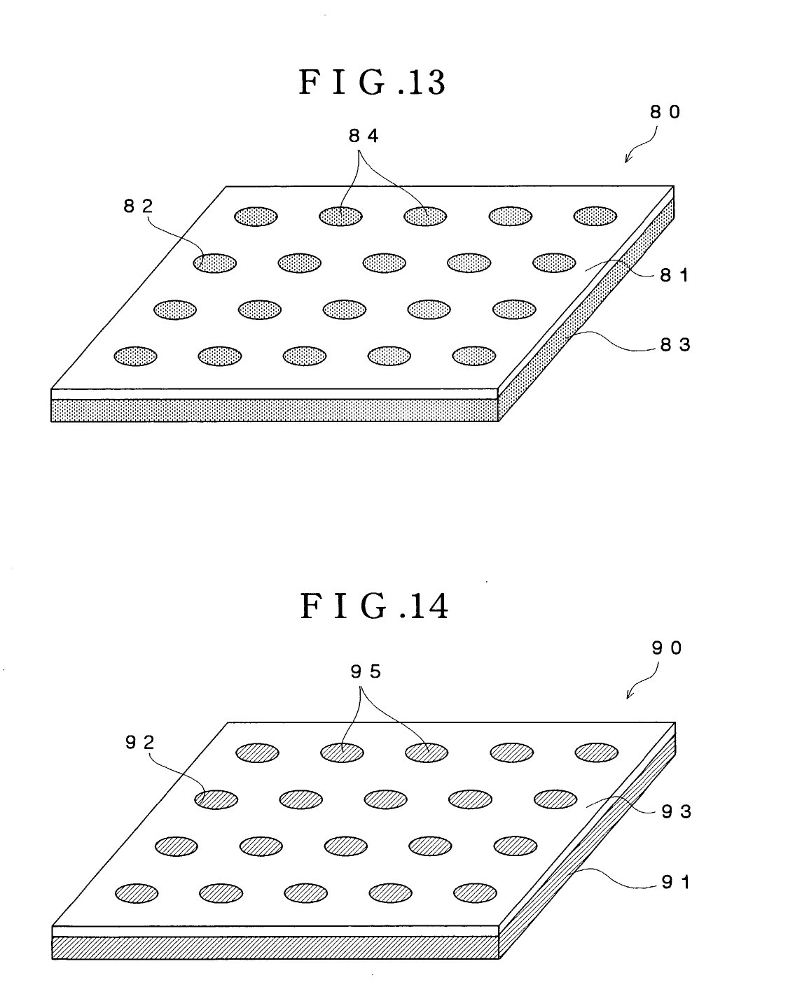

FIG. 13 is a biochemical analysis unit used in the method for producing biochemical analysis data which is a further preferred aspect of the present invention.

As shown in FIG. 13, a biochemical analysis unit 80 includes a substrate 81 made of stainless steel and formed with a number of substantially circular through-holes 82 in a regular pattern and a number of absorptive regions 84 are dot-like formed in a regular pattern by pressing a absorptive membrane 83 formed of nylon-6 into a number of the through-holes 82 formed in the substrate 81 using the calender processing apparatus (not shown).

Although not accurately shown in FIG. 13, about 10,000 substantially circular absorptive regions 84 having a size of about 0.01 mm² are regularly formed at a density of about 5,000 per cm² in the biochemical analysis unit 80.

In this embodiment, the biochemical analysis unit 80 is produced by pressing absorptive membrane 83 into a number of the through-holes 82 formed in the substrate 81 so that the surface of the absorptive regions 84 and the surface of the substrate 81 lie at the same height level.

In this embodiment, similarly to the biochemical analysis unit 1 according to the previous embodiment shown in FIG. 1, a solution containing specific binding substances such as cDNAs is spotted using the spotting device 5 onto a number of the absorptive regions 84 formed in the biochemical analysis unit 80 and the specific binding substances are absorbed in a number of the absorptive regions 84.

Further, as shown in FIG. 3, the biochemical analysis unit 80 is set in the hybridization reaction vessel 8 accommodating a hybridization reaction solution 9 containing a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye and specific binding substances such as cDNAs absorbed in a number of the absorptive regions 84 of the biochemical analysis unit 80 are selectively hybridized with a substance derived from a living organism, labeled with a radioactive labeling substance and contained in the hybridization reaction solution 9, a substance derived from a living organism, labeled with a labeling substance which generates chemiluminescence emission when it contacts a chemiluminescent substrate and contained in the hybridization reaction solution 9 and a substance derived from a living organism, labeled with a fluorescent substance such as a fluorescent dye and contained in the hybridization reaction solution 9.

Thus, radiation data, chemiluminescence data and fluorescence data are recorded in a number of the absorptive regions 84 formed in the biochemical analysis unit 80.

Fluorescence data recorded in a number of the absorptive regions 84 of the biochemical analysis unit 80 are read by a scanner described later to produce biochemical analysis data.

On the other hand, chemiluminescence data recorded in a number of the absorptive regions 84 of the biochemical analysis unit 80 are read by a scanner described later or transferred onto a stimulable phosphor sheet and transferred chemiluminescence data are read by a scanner described later, thereby producing biochemical analysis data.

To the contrary, radiation data recorded in a number of the absorptive regions 84 of the biochemical analysis unit 80 are transferred onto a stimulable phosphor sheet and transferred radiation data are read by a scanner described later, thereby producing biochemical analysis data.

FIG. 14 is a schematic perspective view showing a stimulable phosphor sheet used in the method for producing biochemical analysis data which is a further preferred aspect of the present invention.

As shown in FIG. 14, a stimulable phosphor sheet 90 according to this embodiment includes a stimulable phosphor membrane 91 containing BaFX system stimulable phosphor (where X is at least one halogen atom selected from the group consisting of Cl, Br and I) capable of absorbing and storing radiation energy and a binder and a substrate 93 made of stainless steel and regularly formed with a number of through-holes 92 and the stimulable phosphor membrane 91 is pressed into a number of the through-holes 92 formed in the substrate 93 made of stainless steel using the calender processing apparatus (not shown), whereby a number of stimulable phosphor layer regions 95 are formed at positions of the stimulable phosphor membrane 91 corresponding to a number of the through-holes 92 formed in the substrate 93.

A number of the through-holes 92 are formed in the substrate 93 in the same pattern as that of a number of the absorptive regions 84 formed in the biochemical analysis unit 80 and each of a number of the through-holes 92 has the same size as that of each of a number of the absorptive regions 84 formed in the biochemical analysis unit 80.

Therefore, although not accurately shown in FIG. 14, in this embodiment, about 10,000 substantially circular stimulable phosphor layer regions 95 having a size of about 0.01 mm² are dot-like formed in a regular pattern at a density of about 5,000 per cm² in the stimulable phosphor sheet 90.

In this embodiment, the stimulable phosphor sheet 90 is prepared by pressing the stimulable phosphor membrane 91 into a number of the through-holes 92 formed in the substrate 93 in such a manner that the surface of the substrate 93 and the surfaces of the stimulable phosphor layer regions 95 lies at the same height level.

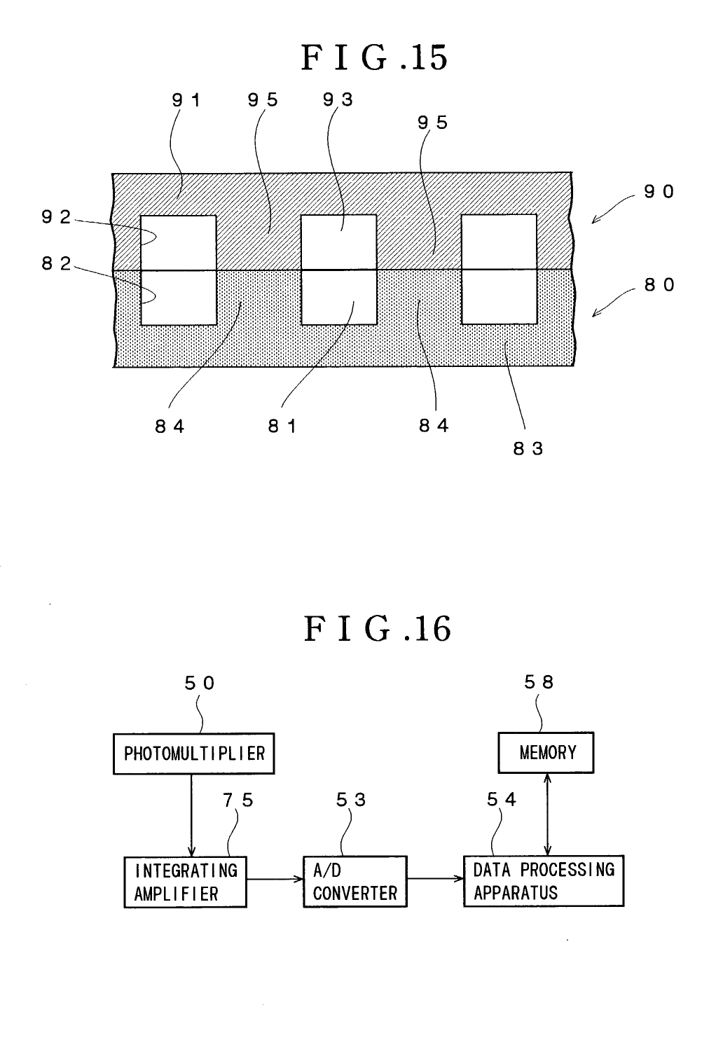

FIG. 15 is a schematic cross-sectional view showing a method for exposing a number of the stimulable phosphor layer regions 95 formed in the stimulable phosphor sheet 90 to a radioactive labeling substance selectively contained in a number of the absorptive layers 84 formed in the biochemical analysis unit 80.

As shown in FIG. 15, when the stimulable phosphor layer regions 95 of a stimulable phosphor sheet 90 are to be exposed, the stimulable phosphor sheet 90 is superposed on the biochemical analysis unit 80 in such a manner that a number of the absorptive regions 84 formed in the biochemical analysis unit 80 face the corresponding stimulable phosphor layer regions 95 formed in the stimulable phosphor sheet 90.

In this embodiment, since the biochemical analysis unit 80 is formed by pressing the absorptive membrane 83 into a number of the through-holes 82 formed in the substrate 81 made of stainless steel, the biochemical analysis unit 80 does not stretch or shrink when it is subjected to liquid processing such as hybridization and, therefore, it is possible to easily and accurately superpose the stimulable phosphor sheet 90 on the biochemical analysis unit 80 so that each of the stimulable phosphor layer regions 95 formed in the stimulable phosphor sheet 90 accurately faces the corresponding absorptive region 84 formed in the biochemical analysis unit 80, thereby exposing a number of the stimulable phosphor layer regions 95.

In this manner, each of the stimulable phosphor layer regions 95 formed in the stimulable phosphor sheet 90 is kept to face the corresponding absorptive region 84 formed in the biochemical analysis unit 80 for a predetermined time period, whereby a number of the stimulable phosphor layer regions 95 formed in the stimulable phosphor sheet 90 are exposed to the radioactive labeling substance selectively contained in a number of the absorptive regions 84 formed in the biochemical analysis unit 80.

During the exposure operation, electron beams (β rays) are released from the radioactive labeling substance contained in the absorptive regions 84 of the biochemical analysis unit 80. However, since a number of the absorptive regions 84 of the biochemical analysis unit 80 are formed by pressing the absorptive membrane 83 into a number of the through-holes 82 formed in the substrate 81 made of stainless steel and the substrate 81 made of stainless steel capable of attenuating radiation energy is present around each of the absorptive regions 84, electron beams (β rays) released from the radioactive labeling substance contained in the absorptive regions 84 of the biochemical analysis unit 80 can be efficiently prevented from scattering in the substrate 81 of the biochemical analysis unit 80. Further, since a number of the stimulable phosphor layer regions 95 of the stimulable phosphor sheet 90 are formed by pressing the stimulable phosphor membrane 91 into a number of the through-holes 92 formed in the substrate 93 made of stainless steel and the substrate 93 capable of attenuating radiation energy is present around each of the stimulable phosphor layer regions 95, electron beams (β rays) released from the radioactive labeling substance contained in the absorptive regions 84 of the biochemical analysis unit 80 can be efficiently prevented from scattering in the substrate 93 of the stimulable phosphor sheet 90. Therefore, it is possible to selectively expose only the stimulable phosphor layer region 95 each of the absorptive regions 84 faces to the electron beams (β rays) released from the radioactive labeling substance contained in each of the absorptive regions 84.

In this manner, radiation data are recorded in a number of the stimulable phosphor layer regions 95 formed in the stimulable phosphor sheet 90 and similarly to the previous embodiment, the radiation data recorded in a number of the stimulable phosphor layer regions 95 formed in the stimulable phosphor sheet 90 are read by a scanner described later to produce biochemical analysis data.

FIG. 16 is a block diagram of the vicinity of a photomultiplier and a data processing apparatus of a scanner which is a further preferred embodiment of the present invention.

As shown in FIG. 16, a scanner according to this embodiment has the same configuration as that of the scanner shown in FIGS. 6 to 9 except that an integrating amplifier 75 is provided for integrating analog data produced by the photomultiplier 50 and an integrated value of analog data produced by the integrating amplifier 75 is digitized by the A/D converter 53 to be stored in a memory 58 by the data processing apparatus 54.

When radiation data recorded in a number of the stimulable phosphor layer regions 95 of the stimulable phosphor sheet 90 are to be read to produce biochemical analysis data, similarly to the previous embodiment, the stimulable phosphor sheet 90 is placed on the sample stage 40 of the scanner and a laser beam 24 emitted from the first laser stimulating ray source 21 is led to a first stimulable phosphor layer region 95 among a number of the stimulable phosphor layer regions 95 formed in the stimulable phosphor sheet 90 by the optical fiber bundle 36, thereby exciting stimulable phosphor contained in the first stimulable phosphor layer regions 95 of the stimulable phosphor sheet 90. Stimulated emission released from the first stimulable phosphor layer regions 95 is led by the optical fiber bundle 36 to the photomultiplier 50 and photoelectrically detected by the photomultiplier 50.

Analog data produced by photoelectrically detecting stimulated emission released from the first stimulable phosphor layer region 95 by the photomultiplier 50 are integrated by the integrating amplifier 75.

When a predetermined time period has passed after the first laser stimulating ray source 21 was activated, the control unit 70 outputs a drive stop signal to the first laser stimulating ray source 21, thereby turning it off and causes the integrating amplifier 75 to output integrated analog data to the A/D converter 53. The control unit 70 further causes the A/D converter 53 to digitize the integrated value of the analog data and to output digitized data to the data processing apparatus 54 and causes the data processing apparatus 54 to store the digitized data in the memory 58.

Thus, radiation data recorded in the first stimulable phosphor layer region 95 of the stimulable phosphor sheet 90 are read to produce biochemical analysis data and the biochemical analysis data of the first stimulable phosphor layer region 95 are stored in the memory 58.

At the same time, the control unit 70 outputs a drive signal to the main scanning stepping motor 65, thereby causing it to move the light receiving end portion 36a of the optical fiber bundle 36 by one pitch equal to the distance between neighboring stimulable phosphor layer regions 95 formed in stimulable phosphor sheet 90.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring stimulable phosphor layer regions 95 and has reached a position where a laser beam 24 can be projected onto a second stimulable phosphor layer region 95 next to the first stimulable phosphor layer region 95 formed in the stimulable phosphor sheet 90, it outputs a drive signal to the first laser stimulating ray source 21 to turn it on, thereby causing the laser beam 24 to excite stimulable phosphor contained in the second stimulable phosphor layer region 95 formed in the stimulable phosphor sheet 90 next to the first stimulable phosphor layer region 95.

Similarly to the above, the second stimulable phosphor layer region 95 formed in the stimulable phosphor sheet 90 is irradiated with the laser beam 24 for a predetermined time and when stimulated emission released from the second stimulable phosphor layer region 95 is photoelectrically detected by the photomultiplier 50, the control unit 70 outputs a drive stop signal to the first laser stimulating ray source 21, thereby turning it off and causes the integrating amplifier 75 to output integrated analog data to the A/D converter 53. The control unit 70 further causes the A/D converter 53 to digitize the integrated value of the analog data and to output digitized data to the data processing apparatus 54 and causes the data processing apparatus 54 to store the digitized data in the memory 58.

Thus, radiation data recorded in the second stimulable phosphor layer region 95 of the stimulable phosphor sheet 90 are read to produce biochemical analysis data and the biochemical analysis data of the second stimulable phosphor layer region 95 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring stimulable phosphor layer regions 95.

In this manner, the on and off operation of the first laser stimulating ray source 21 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that radiation data recorded in the stimulable phosphor layer regions 95 included in a first line of the stimulable phosphor layer regions 95 formed in the stimulable phosphor sheet 90 have been read, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the stimulable phosphor layer regions 95 included in the first line of the stimulable phosphor layer regions 95 formed in the stimulable phosphor sheet 90 were sequentially irradiated with the laser beam 24 emitted from the first laser stimulating ray source 21, the stimulable phosphor layer regions 95 included in a second line of the stimulable phosphor layer regions 95 formed in the stimulable phosphor sheet 90 are sequentially irradiated with the laser beam 24 emitted from the first laser stimulating ray source 21, thereby exciting stimulable phosphor contained in the stimulable phosphor layer regions 95 included in the second line and stimulated emission released from the stimulable phosphor layer regions 95 is sequentially and photoelectrically detected by the photomultiplier 50.

Analog data produced by photoelectrically detecting stimulated emission released from each of the stimulable phosphor layer regions 95 included in the second line of the stimulable phosphor layer regions 95 formed in the stimulable phosphor sheet 90 by the photomultiplier 50 are integrated by the integrating amplifier 75 and the integrated analog data are digitized by the A/D converter 53 to be stored in the memory 58 as biochemical analysis data recorded in the stimulable phosphor layer region 95.

When all of the stimulable phosphor layer regions 95 formed in the stimulable phosphor sheet 90 have been scanned with the laser beam 24 emitted from the first laser stimulating ray source 21 to excite stimulable phosphor contained in the stimulable phosphor layer regions 95 and digital data produced by photoelectrically detecting stimulated emission released from the stimulable phosphor layer regions 95 by the photomultiplier 50 to produce analog data, integrating the analog data by the integrating amplifier 75 and digitizing the integrated analog data by the A/D converter 53 have been forwarded to the data processing apparatus 54 and stored in the memory 58, the control unit 70 outputs a drive stop signal to the first laser stimulating ray source 21, thereby turning it off.

As described above, radiation data recorded in a number of the stimulable phosphor layer regions 95 formed in the stimulable phosphor sheet 90 are read to produce biochemical analysis data.

On the other hand, when fluorescence data of a fluorescent substance, for example, Rhodamine (registered trademark) recorded in a number of absorptive regions 84 formed in the biochemical analysis unit 80 are to be read to produce biochemical analysis unit, similarly to the previous embodiment, the biochemical analysis unit 80 is placed on the sample stage of the scanner and a laser beam 24 emitted from the second laser stimulating ray source 22 is sequentially led to a first absorptive region 84 among a number of the absorptive regions 84 formed in the biochemical analysis unit 80 by the optical fiber bundle 36, thereby exciting Rhodamine contained in the first absorptive regions 84 of the biochemical analysis unit 80. Fluorescence emission released from the first absorptive regions 84 is led by the optical fiber bundle 36 to the photomultiplier 50 and photoelectrically detected by the photomultiplier 50.

Analog data produced by photoelectrically detecting fluorescence emission released from the first absorptive region 84 by the photomultiplier 50 are integrated by the integrating amplifier 75.

When a predetermined time period has passed after the second laser stimulating ray source 22 was turned on, the control unit 70 outputs a drive stop signal to the second laser stimulating ray source 22, thereby turning it off and causes the integrating amplifier 75 to output integrated analog data to the A/D converter 53. The control unit 70 further causes the A/D converter 53 to digitize the integrated value of the analog data and to output digitized data to the data processing apparatus 54 and causes the data processing apparatus 54 to store the digitized data in the memory 58.

Thus, fluorescence data recorded in the first absorptive region 84 of the biochemical analysis unit 80 are read to produce biochemical analysis data and the biochemical analysis data of the first absorptive region 84 are stored in the memory 58.

At the same time, the control unit 70 outputs a drive signal to the main scanning stepping motor 65, thereby moving the optical head 35 by one pitch equal to the distance between neighboring absorptive regions 84 formed in the biochemical analysis unit 80.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring absorptive regions 84 and has reached a position where a laser beam 24 can be projected onto a second absorptive region 84 next to the first absorptive region 84 formed in the biochemical analysis unit 80, it outputs a drive signal to the second laser stimulating ray source 22 to turn it on, thereby causing the laser beam 24 to excite a fluorescent substance, for example, Rhodamine, contained in the second absorptive region 84 formed in the biochemical analysis unit 1 next to the first absorptive region 84.

Similarly to the above, the second absorptive region 84 formed in the biochemical analysis unit 80 is irradiated with the laser beam 24 for a predetermined time and when fluorescence emission released from the second absorptive region 84 is photoelectrically detected by the photomultiplier 50, the control unit 70 outputs a drive stop signal to the second laser stimulating ray source 22, thereby turning it off and causes the integrating amplifier 75 to output integrated analog data to the A/D converter 53. The control unit further causes the A/D converter 53 to digitize the integrated analog data to produce digital data and to output digitized data to the data processing apparatus 54 and causes the data processing apparatus 54 to store the digitized data in the memory 58.

Thus, fluorescence data recorded in the second absorptive region 84 of the biochemical analysis unit 80 are read to produce biochemical analysis data and the biochemical analysis data of the second absorptive region 84 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring absorptive regions 84.

In this manner, the on and off operation of the second laser stimulating ray source 22 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that fluorescence data recorded in the absorptive regions 84 included in a first line of the absorptive regions 84 formed in the biochemical analysis unit 80 have been produced, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the absorptive regions 84 included in the first line of the absorptive regions 84 formed in the biochemical analysis unit 80 were sequentially irradiated with the laser beam 24 emitted from the second laser stimulating ray source 22, the absorptive regions 84 included in a second line of the absorptive regions 84 formed in the biochemical analysis unit 80 are sequentially irradiated with the laser beam 24 emitted from the second laser stimulating ray source 22, thereby exciting a fluorescent substance contained in the absorptive regions 84 included in the second line and fluorescence emission released from the absorptive regions 84 included in the second line is sequentially and photoelectrically detected by the photomultiplier 50.

Analog data produced by photoelectrically detecting fluorescence emission released from each of the absorptive regions 84 included in the second line of the absorptive regions 84 formed in the biochemical analysis unit 80 by the photomultiplier 50 are integrated by the integrating amplifier 75 and the integrated analog data are digitized by the A/D converter 53 to be stored in the memory 58 as biochemical analysis data recorded in the absorptive region 84.

When all of the absorptive regions 84 formed in the biochemical analysis unit 80 have been scanned with the laser beam 24 to excite a fluorescent substance contained in the absorptive regions 84 and digital data produced by photoelectrically detecting fluorescence emission released from the absorptive regions 84 by the photomultiplier 50 to produce analog data, integrating the analog data by the integrating amplifier 75 and digitizing the integrated analog data by the A/D converter 53 have been forwarded to the data processing apparatus 54 and stored in the memory 58, the control unit 70 outputs a drive stop signal to the second laser stimulating ray source 22, thereby turning it off.

As described above, fluorescence data recorded in a number of the absorptive regions 84 formed in the biochemical analysis unit 84 are read to produce biochemical analysis data.

On the other hand, when chemiluminescence data recorded in a number of the absorptive regions 84 formed in the biochemical analysis unit 80 are to be read to produce biochemical analysis data, the biochemical analysis unit 1 is placed on the sample stage 40 of the scanner while in a state of releasing chemiluminescence emission from a number of the absorptive regions 84 as a result of contact of a labeling substance contained in a number of the absorptive regions 84 formed in the biochemical analysis unit 80 and a chemiluminescent substrate and the optical fiber bundle 36 is moved to a position where the light receiving end portion 36a of the optical fiber bundle 36 can receive chemiluminescence emission released from the first absorptive region 4 among a number of the absorptive regions 84 formed in the biochemical analysis unit 80.

When the control unit 70 determined based on a detection signal indicating the position of the light receiving end portion 36a of the optical fiber bundle 36 input from the linear encoder 67 that the light receiving end portion 36a of the optical fiber bundle 36 has reached a position where the light receiving end portion 36a of the optical fiber bundle 36 can receive chemiluminescence emission released from the first absorptive region 84, it outputs a drive signal to the photomultiplier 50, thereby turning it on.

As a result, chemiluminescence emission released from the first absorptive region 84 formed in the biochemical analysis unit 80 is led by the optical fiber bundle 36 to the photomultiplier 50 and photoelectrically detected by the photomultiplier 50 to produce analog data.

The analog data produced by photoelectrically detecting chemiluminescence emission released from the first absorptive region 84 by the photomultiplier 50 are integrated by the integrating amplifier 75.

When a predetermined time has passed after the photomultiplier 50 was turned on, the control unit 70 outputs a drive stop signal to the photomultiplier 50, thereby turning it off and causes the integrating amplifier 75 to output integrated analog data to the A/D converter 53. The control unit 70 further causes the A/D converter 53 to digitize the integrated value of the analog data and to output digitized data to the data processing apparatus 54 and causes the data processing apparatus 54 to store the digitized data in the memory 58.

Thus, chemiluminescence data recorded in the first absorptive region 84 of the biochemical analysis unit 80 are read to produce biochemical analysis data and the biochemical analysis data of the first absorptive region 84 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring absorptive regions 84 formed in the biochemical analysis unit 80.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring absorptive regions 84 and has reached a position where the light receiving end portion 36a of the optical fiber bundle 36 can receive chemiluminescence emission released from the second absorptive region 84 next to the first absorptive region 84 formed in the biochemical analysis unit 80, it outputs a drive stop signal to the main scanning stepping motor 65 and a drive signal to the photomultiplier 50, thereby turning it on to cause it to photoelectrically detect chemiluminescence emission released from the second absorptive region 84 formed in the biochemical analysis unit 80 and led by the optical fiber bundle 36.

Similarly to the above, when chemiluminescence emission released from the second absorptive region 4 formed in the substrate 2 of the biochemical analysis unit 1 has been photoelectrically detected by the photomultiplier 50 for a predetermined time to produce analog data, the control unit 70 outputs a drive stop signal to the photomultiplier 50, thereby turning it off and causes the integrating amplifier 75 to output integrated analog data to the A/D converter 53. The control unit further causes the A/D converter 53 to digitize the integrated analog data and to output digitized data to the data processing apparatus 54 and causes the data processing apparatus 54 to store the digitized data in the memory 58.

Thus, chemiluminescence data recorded in the second absorptive region 84 of the biochemical analysis unit 80 are read to produce biochemical analysis data and the biochemical analysis data of the second absorptive region 84 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring absorptive regions 84 formed in the biochemical analysis unit 80.

In this manner, the on and off operation of the photomultiplier 50 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that chemiluminescence data recorded in the absorptive regions 84 included in a first line of the absorptive regions 84 formed in the biochemical analysis unit 80 have been produced, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which chemiluminescence emission released from the absorptive regions 84 included in the first line of the absorptive regions 84 formed in the biochemical analysis unit 80 was sequentially photoelectrically detected by the photomultiplier 50, chemiluminescence emission released from the absorptive regions 84 included in a second line of the absorptive regions 84 formed in the biochemical analysis unit 80 is sequentially led by the optical fiber bundle 36 to the photomultiplier 50 and photoelectrically detected by the photomultiplier 50.

Analog data produced by photoelectrically detecting chemiluminescence emission released from each of the absorptive regions 84 included in the second line of the absorptive regions 84 formed in the biochemical analysis unit 80 by the photomultiplier 50 are integrated by the integrating amplifier 75 and the integrated analog data are digitized by the A/D converter 53 to be stored in the memory 58 as biochemical analysis data recorded in the absorptive region 84.

When chemiluminescence emission released from all of the absorptive regions 84 formed in the biochemical analysis unit 80 have been received by the light receiving end portion 36a of the optical fiber bundle 36 and photoelectrically detected by the photomultiplier 50 and digital data produced by photoelectrically detecting chemiluminescence emission released from the absorptive regions 84 by the photomultiplier 50 to produce analog data, integrating the analog data by the integrating amplifier 75 and digitizing the integrated analog data by the A/D converter 53 have been forwarded to the data processing apparatus 54 and stored in the memory 58, the control unit 70 outputs a drive stop signal to the photomultiplier 50, thereby turning it off.

As described above, chemiluminescence data recorded in a number of the absorptive regions 84 formed in the biochemical analysis unit 80 are read to produce biochemical analysis data.

In this embodiment, chemiluminescence data recorded in a number of the absorptive regions 84 formed in the biochemical analysis unit 80 can be transferred onto a stimulable phosphor sheet and biochemical analysis data can be produced by reading chemiluminescence data transferred onto the stimulable phosphor sheet by a scanner described later.

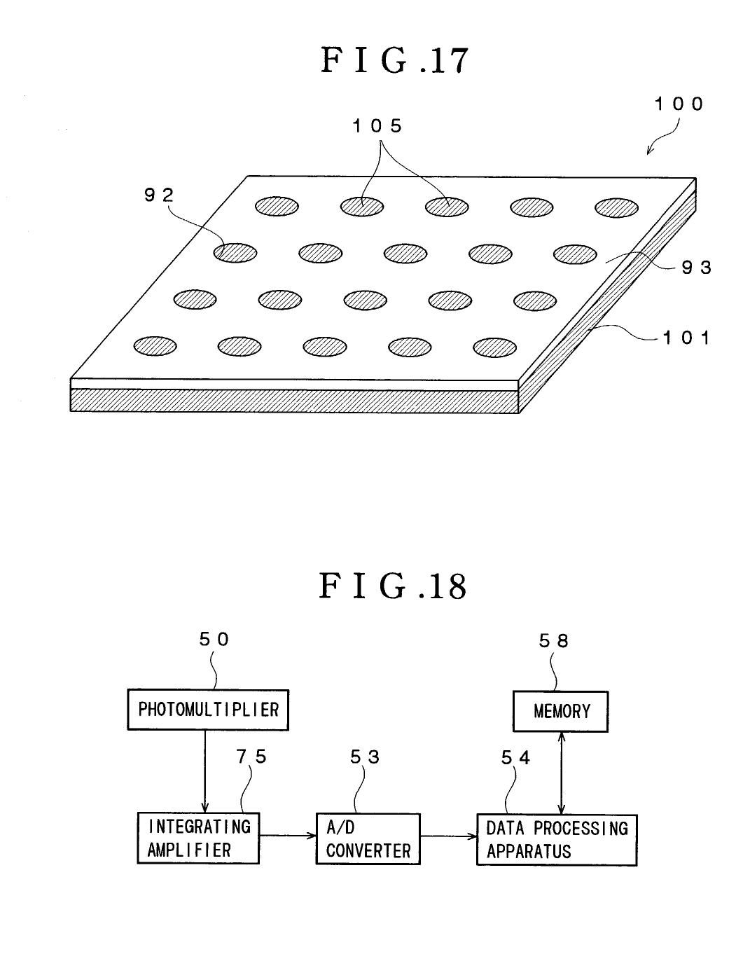

FIG. 17 is a schematic perspective view showing a stimulable phosphor sheet onto which chemiluminescence data are to be transferred and used in a method for producing biochemical analysis data which is a further preferred embodiment of the present invention.

A stimulable phosphor sheet 100 shown in FIG. 17 has the same configuration as that of the stimulable phosphor sheet 90 shown in FIG. 14 except that a stimulable phosphor membrane 101 contains SrS system stimulable phosphor capable of absorbing and storing light energy and a binder and a number of stimulable phosphor layer regions 105 containing SrS system stimulable phosphor capable of absorbing and storing light energy are formed.

Chemiluminescence data recorded in a number of the absorptive regions 84 formed in the biochemical analysis unit 80 are transferred onto a number of the stimulable phosphor layer regions 105 of the stimulable phosphor 100 shown in FIG. 17.

When chemiluminescence data recorded in a number of the absorptive regions 84 formed in the biochemical analysis unit 80 are to be transferred onto a number of the stimulable phosphor layer regions 105 of the stimulable phosphor 100, a number of the absorptive regions 84 of the biochemical analysis unit 80 are first brought into contact with a chemiluminescent substrate.

As a result, chemiluminescence emission in a wavelength of visible light is selectively released from a number of the absorptive regions 84 of the biochemical analysis unit 80.

Similarly to the manner shown in FIG. 15, the stimulable phosphor sheet 100 is then superposed on the biochemical analysis unit 80 formed of a number of the absorptive regions 84 selectively releasing chemiluminescence emission in such a manner that each of the stimulable phosphor layer regions 105 formed in the stimulable phosphor sheet 100 faces the corresponding absorptive region 84 formed in the biochemical analysis unit 80.

In this manner, each of the stimulable phosphor layer regions 105 formed in the stimulable phosphor sheet 100 is kept to face the corresponding absorptive region 84 formed in the biochemical analysis unit 80 for a predetermined time period, whereby a number of the stimulable phosphor layer regions 105 formed in the stimulable phosphor sheet 100 are exposed to chemiluminescence emission released from a number of the absorptive regions 84 formed in the biochemical analysis unit 80.

In this embodiment, since a number of the absorptive regions 84 of the biochemical analysis unit 80 are formed by pressing the absorptive membrane 83 into a number of the through-holes 82 formed in the substrate 81 made of stainless steel and the substrate 81 made of stainless steel capable of attenuating light energy are present around each of the absorptive regions 84 of the biochemical analysis unit 80, chemiluminescence emission released from the absorptive regions 84 of the biochemical analysis unit 80 during the exposure operation can be efficiently prevented from scattering in the biochemical analysis unit 80. Further, since a number of the stimulable phosphor layer regions 105 of the stimulable phosphor sheet 100 are formed by pressing the stimulable phosphor membrane into a number of the through-holes 92 formed in the substrate 93 made of stainless steel and the substrate 93 made of stainless steel capable of attenuating light energy are present around each of the stimulable phosphor layer regions 105 of the stimulable phosphor sheet 100, chemiluminescence emission released from the absorptive regions 84 of the biochemical analysis unit 80 can be efficiently prevented from scattering in the stimulable phosphor sheet 100 and impinging on the stimulable phosphor layer regions 105 neighboring absorptive regions 84 face.

In this manner, chemiluminescence data are recorded in a number of the stimulable phosphor layer regions 105 formed in the stimulable phosphor sheet 100.

FIG. 18 is a block diagram of the vicinity of a photomultiplier and a data processing apparatus of a scanner for reading chemiluminescence data recorded in a number of the stimulable phosphor layer regions 105 formed in the stimulable phosphor sheet 100 and producing biochemical analysis data, which is a further preferred embodiment of the present invention.

As shown in FIG. 18, the scanner according to this embodiment has the same configuration as that of the scanner shown in FIGS. 11 and 12 except that an integrating amplifier 75 is provided for integrating analog data produced by the photomultiplier 50 and an integrated value of analog data produced by the integrating amplifier 75 is digitized by a A/D converter 53 to be stored in a memory 58 by the data processing apparatus 54.

When chemiluminescence data recorded in a number of the stimulable phosphor layer regions 105 of the stimulable phosphor sheet 100 are to be read to produce biochemical analysis data, similarly to the previous embodiment, the stimulable phosphor sheet 100 is placed on the sample stage 40 of the scanner and a laser beam 24 emitted from the fourth laser stimulating ray source 55 is led to a first stimulable phosphor layer region 105 among a number of the stimulable phosphor layer regions 105 formed in the stimulable phosphor sheet 100 by the optical fiber bundle 36, thereby exciting stimulable phosphor contained in the first stimulable phosphor layer regions 105 of the stimulable phosphor sheet 100. Stimulated emission released from the first stimulable phosphor layer regions 105 is led by the optical fiber bundle 36 to the photomultiplier 50 and photoelectrically detected by the photomultiplier 50.

Analog data produced by photoelectrically detecting stimulated emission released from the first stimulable phosphor layer region 105 by the photomultiplier 50 are integrated by the integrating amplifier 75.

When a predetermined time period has passed after the fourth laser stimulating ray source 55 was activated, the control unit 70 outputs a drive stop signal to the fourth laser stimulating ray source 55, thereby turning it off and causes the integrating amplifier 75 to output integrated analog data to the A/D converter 53. The control unit further causes the A/D converter 53 to digitize the integrated value of the analog data and to output digitized data to the data processing apparatus 54 and causes the data processing apparatus 54 to store the digitized data in the memory 58.

Thus, chemiluminescence data recorded in the first stimulable phosphor layer region 105 of the stimulable phosphor sheet 100 are read to produce biochemical analysis data and the biochemical analysis data of the first stimulable phosphor layer region 105 are stored in the memory 58.

At the same time, the control unit 70 outputs a drive signal to the main scanning stepping motor 65, thereby causing it to move the light receiving end portion 36a of the optical fiber bundle 36 by one pitch equal to the distance between neighboring stimulable phosphor layer regions 105 formed in stimulable phosphor sheet 100.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring stimulable phosphor layer regions 105 and has reached a position where a laser beam 24 can be projected onto a second stimulable phosphor layer region 105 next to the first stimulable phosphor layer region 105 formed in the stimulable phosphor sheet 100, it outputs a drive signal to the fourth laser stimulating ray source 55 to turn it on, thereby causing the laser beam 24 to excite stimulable phosphor contained in the second stimulable phosphor layer region 105 formed in the stimulable phosphor sheet 100 next to the first stimulable phosphor layer region 105.

Similarly to the above, the second stimulable phosphor layer region 105 formed in the stimulable phosphor sheet 100 is irradiated with the laser beam 24 for a predetermined time and when stimulated emission released from the second stimulable phosphor layer region 105 is photoelectrically detected by the photomultiplier 50, the control unit 70 outputs a drive stop signal to the fourth laser stimulating ray source 55, thereby turning it off and causes the integrating amplifier 75 to output integrated analog data to the A/D converter 53. The control unit 75 further causes the A/D converter 53 to digitize the integrated value of the analog data and to output digitized data to the data processing apparatus 54 and causes the data processing apparatus 54 to store the digitized data in the memory 58.

Thus, chemiluminescence data recorded in the second stimulable phosphor layer region 105 of the stimulable phosphor sheet 100 are read to produce biochemical analysis data and the biochemical analysis data of the first stimulable phosphor layer region 105 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring stimulable phosphor layer regions 105.

In this manner, the on and off operation of the fourth laser stimulating ray source 55 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that chemiluminescence data recorded in the stimulable phosphor layer regions 105 included in a first line of the stimulable phosphor layer regions 105 formed in the stimulable phosphor sheet 100 have been read, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the stimulable phosphor layer regions 105 included in the first line of the stimulable phosphor layer regions 105 formed in the stimulable phosphor sheet 100 were sequentially irradiated with the laser beam 24 emitted from the fourth laser stimulating ray source 55, the stimulable phosphor layer regions 105 included in a second line of the stimulable phosphor layer regions 105 formed in the stimulable phosphor sheet 100 are sequentially irradiated with the laser beam 24 emitted from the fourth laser stimulating ray source 55, thereby exciting stimulable phosphor contained in the stimulable phosphor layer regions 105 included in the second line and stimulated emission released from the stimulable phosphor layer regions 105 is sequentially and photoelectrically detected by the photomultiplier 50.

Analog data produced by photoelectrically detecting stimulated emission released from each of the stimulable phosphor layer regions 105 included in the second line of the stimulable phosphor layer regions 105 formed in the stimulable phosphor sheet 100 by the photomultiplier 50 are integrated by the integrating amplifier 75 and the integrated analog data are digitized by the A/D converter 53 to be stored in the memory 58 as biochemical analysis data recorded in the stimulable phosphor layer region 105.

When all of the stimulable phosphor layer regions 105 formed in the stimulable phosphor sheet 100 have been scanned with the laser beam 24 emitted from the fourth laser stimulating ray source 55 to excite stimulable phosphor contained in the stimulable phosphor layer regions 105 and digital data produced by photoelectrically detecting stimulated emission released from the stimulable phosphor layer regions 105 by the photomultiplier 50 to produce analog data, integrating the analog data by the integrating amplifier 75 and digitizing the integrated analog data by the A/D converter 53 have been forwarded to the data processing apparatus 54 and stored in the memory 58, the control unit 70 outputs a drive stop signal to the fourth laser stimulating ray source 55, thereby turning it off.

As described above, radiation data recorded in a number of the stimulable phosphor layer regions 105 formed in the stimulable phosphor sheet 100 are read to produce biochemical analysis data.

According to this embodiment, since biochemical analysis data of each of the stimulable phosphor layer regions 95 of the stimulable phosphor sheet 90 are produced by photoelectrically detecting stimulated emission released from each of the stimulable phosphor layer regions 95 of the stimulable phosphor sheet 90 to produce analog data by the photomultiplier 50, integrating the analog data by the integrating amplifier 75 and digitizing the integrated analog data by the A/D converter 53, even in the case where radiation energy stored in a particular stimulable phosphor layer region 95 of the stimulable phosphor sheet 90 is low and the intensity of stimulated emission released from the stimulable phosphor layer region 95 is low, biochemical analysis data having sufficiently high signal intensity can be produced with high sensitivity.

Further, according to this embodiment, since biochemical analysis data of each of the stimulable phosphor layer regions 105 of the stimulable phosphor sheet 100 are produced by photoelectrically detecting stimulated emission released from each of the stimulable phosphor layer regions 105 of the stimulable phosphor sheet 100 to produce analog data by the photomultiplier 50, integrating the analog data by the integrating amplifier 75 and digitizing the integrated analog data by the A/D converter 53, even in the case where the energy of chemiluminescence emission stored in a particular stimulable phosphor layer region 105 of the stimulable phosphor sheet 100 is low and the intensity of stimulated emission released from the stimulable phosphor layer region 105 is low, biochemical analysis data having sufficiently high signal intensity can be produced with high sensitivity.

Furthermore, according to this embodiment, since biochemical analysis data of each of the absorptive regions 84 of the biochemical analysis unit 80 are produced by photoelectrically detecting fluorescence emission or chemiluminescence emission released from each of the absorptive regions 84 of the biochemical analysis unit 80 to produce analog data by the photomultiplier 50, integrating the analog data by the integrating amplifier 75 and digitizing the integrated analog data by the A/D converter 53, even in the case where the intensity of fluorescence emission or chemiluminescence emission released from a particular absorptive region 84 of the biochemical analysis unit 80 is low, biochemical analysis data having sufficiently high signal intensity can be produced with high sensitivity.

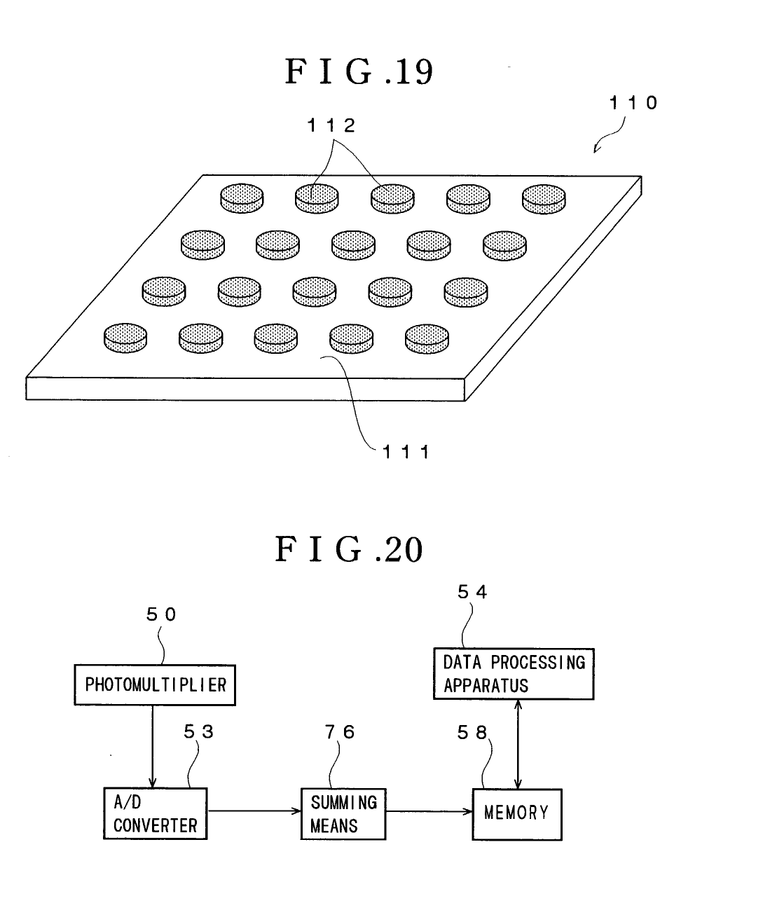

FIG. 19 is a schematic perspective view showing a stimulable phosphor sheet used in the method for producing biochemical analysis data which is a further preferred embodiment of the present invention.

As shown in FIG. 19, a stimulable phosphor sheet 110 according to this embodiment includes a support 111 made of stainless steel and a number of stimulable phosphor layer regions 112 containing BaFX system stimulable phosphor (where X is at least one halogen atom selected from the group consisting of Cl, Br and I) capable of absorbing and storing radiation energy are dot-like formed on the surface of the support 111.

Although not accurately shown in FIG. 19, in this embodiment, correspondingly to a number of the absorptive regions 84 formed in the biochemical analysis unit 80 shown in FIG. 13, about 10,000 substantially circular stimulable phosphor layer regions 112 having a size of about 0.01 mm² are dot-like formed in a regular pattern at a density of about 5,000 per cm²in the stimulable phosphor sheet 110.

In this embodiment, similarly to the previous embodiment, a number of the stimulable phosphor layer regions 112 formed in the stimulable phosphor sheet 110 are exposed to a radioactive labeling substance selectively contained in a number of the absorptive regions 84 formed in the biochemical analysis unit 80, whereby radiation data recorded in a number of the absorptive regions 84 of the biochemical analysis unit 80 are transferred onto and recorded in a number of the stimulable phosphor layer regions 112 formed in the stimulable phosphor sheet 110.

Radiation data recorded in this manner in a number of the stimulable phosphor layer regions 112 formed in the stimulable phosphor sheet 110 are read by a scanner described later to produce biochemical analysis data.

FIG. 20 is a block diagram of the vicinity of a photomultiplier and a data processing apparatus of a scanner which is a further preferred embodiment of the present invention.

As shown in FIG. 20, a scanner according to this embodiment has the same configuration as that of the scanner shown in FIGS. 6 to 9 except that it includes a summing means 76 for summing digital data produced by the A/D converter 53 and a memory 58 for storing digital data summed by the summing means 76.

When radiation data recorded in a number of the stimulable phosphor layer regions 112 of the stimulable phosphor sheet 110 are to be read to produce biochemical analysis data, similarly to the previous embodiment, the stimulable phosphor sheet 110 is placed on the sample stage 40 of the scanner and a drive signal is output from the control unit 70 to the first laser stimulating ray source 21, thereby activating the first laser stimulating ray source 21.

As a result, a laser beam 24 emitted from the first laser stimulating ray source 21 is led to a first stimulable phosphor layer region 112 among a number of the stimulable phosphor layer regions 112 formed in the stimulable phosphor sheet 110 by the optical fiber bundle 36 and stimulable phosphor contained in the first stimulable phosphor layer regions 112 of the stimulable phosphor sheet 110, thereby releasing stimulated emission from the first stimulable phosphor layer regions 112.

Stimulated emission released from the first stimulable phosphor layer regions 112 is received by the light receiving end portion 36a of the optical fiber bundle 36 and led by the optical fiber bundle 36 to the photomultiplier 50 to be photoelectrically detected by the photomultiplier 50.

In this embodiment, the control unit 70 is constituted so as to output a summing operation effecting signal to the summing means 76 simultaneously with outputting a drive signal to the first laser stimulating ray source 21. Therefore, analog data produced by photoelectrically detecting stimulated emission released from the first stimulable phosphor layer regions 112 by the photomultiplier 50 are converted to digital data by the A/D converter 53 and digital data are sequentially summed by the summing means 76 to be stored in the memory 58.

When a predetermined time period has passed after the first laser stimulating ray source 21 was activated, the control unit 70 outputs a drive stop signal to the first laser stimulating ray source 21, thereby turning it off.

Thus, radiation data recorded in the first stimulable phosphor layer region 112 of the stimulable phosphor sheet 110 are read to produce biochemical analysis data and the biochemical analysis data of the first stimulable phosphor layer region 112 are stored in the memory 58.

At the, same time, the control unit 70 outputs a drive signal to the main scanning stepping motor 65, thereby causing it to move the light receiving end portion 36a of the optical fiber bundle 36 by one pitch equal to the distance between neighboring stimulable phosphor layer regions 112 formed in stimulable phosphor sheet 110.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring stimulable phosphor layer regions 112 and has reached a position where a laser beam 24 can be projected onto a second stimulable phosphor layer region 112 next to the first stimulable phosphor layer region 112 formed in the stimulable phosphor sheet 110, it outputs a drive signal to the first laser stimulating ray source 21 to turn it on, thereby causing the laser beam 24 to excite stimulable phosphor contained in the second stimulable phosphor layer region 112 formed in the stimulable phosphor sheet 110 next to the first stimulable phosphor layer region 112.

Stimulated emission released from the second stimulable phosphor layer regions 112 is received by the light receiving end portion 36a of the optical fiber bundle 36 and led by the optical fiber bundle 36 to the photomultiplier 50 to be photoelectrically detected by the photomultiplier 50.

Analog data produced by photoelectrically detecting stimulated emission released from the second stimulable phosphor layer regions 112 by the photomultiplier 50 are converted to digital data by the A/D converter 53 and digital data are sequentially summed by the summing means 76 to be stored in the memory 58.

When the second stimulable phosphor layer region 112 formed in the stimulable phosphor sheet 110 is irradiated with the laser beam 24 emitted from the first laser stimulating ray source 21 for a predetermined time, the control unit 70 outputs a drive stop signal to the first laser stimulating ray source 21, thereby turning it off.

Thus, radiation data recorded in the second stimulable phosphor layer region 112 of the stimulable phosphor sheet 110 are read to produce biochemical analysis data and the biochemical analysis data of the second stimulable phosphor layer region 112 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring stimulable phosphor layer regions 112.

In this manner, the on and off operation of the first laser stimulating ray source 21 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that radiation data recorded in the stimulable phosphor layer regions 112 included in a first line of the stimulable phosphor layer regions 112 formed in the stimulable phosphor sheet 110 have been read, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the stimulable phosphor layer regions 112 included in the first line of the stimulable phosphor layer regions 112 formed in the stimulable phosphor sheet 110 were sequentially irradiated with the laser beam 24 emitted from the first laser stimulating ray source 21, the stimulable phosphor layer regions 112 included in a second line of the stimulable phosphor layer regions 112 formed in the stimulable phosphor sheet 110 are sequentially irradiated with the laser beam 24 emitted from the first laser stimulating ray source 21, thereby exciting stimulable phosphor contained in the stimulable phosphor layer regions 112 included in the second line and stimulated emission released from the stimulable phosphor layer regions 112 is sequentially and photoelectrically detected by the photomultiplier 50.

Analog data produced by photoelectrically detecting stimulated emission released from each of the stimulable phosphor layer regions 112 included in the second line of the stimulable phosphor layer regions 112 formed in the stimulable phosphor sheet 110 by the photomultiplier 50 are converted by the A/D converter 53 to digital data and the thus produced digital data are sequentially summed by the summing means 76 to be stored in the memory 58 as biochemical analysis data recorded in the stimulable phosphor layer region 112.

When all of the stimulable phosphor layer regions 112 formed in the stimulable phosphor sheet 110 have been scanned with the laser beam 24 emitted from the first laser stimulating ray source 21 to excite stimulable phosphor contained in the stimulable phosphor layer regions 112 and digital data produced by photoelectrically detecting stimulated emission released from the stimulable phosphor layer regions 112 by the photomultiplier 50 to produce analog data and digitizing the analog data by the A/D converter 53 have been sequentially summed by the summing means 76 to be stored in the memory 58, the control unit 70 outputs a drive stop signal to the first laser stimulating ray source 21, thereby turning it off.

As described above, radiation data recorded in a number of the stimulable phosphor layer regions 112 formed in the stimulable phosphor sheet 110 are read to produce biochemical analysis data.

On the other hand, when fluorescence data of a fluorescent substance, for example, Rhodamine (registered trademark) recorded in a number of absorptive regions 84 formed in the biochemical analysis unit 80 are to be read to produce biochemical analysis unit, similarly to the previous embodiment, the biochemical analysis unit 80 is placed on the sample stage of the scanner and a laser beam 24 emitted from the second laser stimulating ray source 22 is sequentially led to a first absorptive region 84 among a number of the absorptive regions 84 formed in the biochemical analysis unit 80 by the optical fiber bundle 36, thereby exciting Rhodamine contained in the first absorptive regions 84 of the biochemical analysis unit 80. Fluorescence emission released from the first absorptive regions 84 is led by the optical fiber bundle 36 to the photomultiplier 50 and photoelectrically detected by the photomultiplier 50.

In this embodiment, the control unit 70 is constituted so as to output a summing operation effecting signal to the summing means 76 simultaneously with outputting a drive signal to the second laser stimulating ray source 22. Therefore, analog data produced by photoelectrically detecting stimulated emission released from the first absorptive regions 84 by the photomultiplier 50 are converted to digital data by the A/D converter 53 and digital data are sequentially summed by the summing means 76 to be stored in the memory 58.

When a predetermined time period has passed after the second laser stimulating ray source 22 was activated, the control unit 70 outputs a drive stop signal to the second laser stimulating ray source 22, thereby turning it off.

Thus, fluorescence data recorded in the first absorptive region 84 of the biochemical analysis unit 80 are read to produce biochemical analysis data and the biochemical analysis data of the first absorptive region 84 are stored in the memory 58.

At the same time, the control unit 70 outputs a drive signal to the main scanning stepping motor 65, thereby moving the optical head 35 by one pitch equal to the distance between neighboring absorptive regions 84 formed in the biochemical analysis unit 80.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring absorptive regions 84 and has reached a position where a laser beam 24 can be projected onto a second absorptive region 84 next to the first absorptive region 84 formed in the biochemical analysis unit 80, it outputs a drive signal to the second laser stimulating ray source 22 to turn it on, thereby causing the laser beam 24 to excite a fluorescent substance, for example, Rhodamine, contained in the second absorptive region 84 formed in the biochemical analysis unit 1 next to the first absorptive region 84.

Fluorescence emission released from the second absorptive regions 84 is received by the light receiving end portion 36a of the optical fiber bundle 36 and led by the optical fiber bundle 36 to the photomultiplier 50 to be photoelectrically detected by the photomultiplier 50.

Analog data produced by photoelectrically detecting fluorescence emission released from the second absorptive regions 84 by the photomultiplier 50 are converted to digital data by the A/D converter 53 and digital data are sequentially summed by the summing means 76 to be stored in the memory 58.

When the second stimulable absorptive region 84 formed in the biochemical analysis unit 80 is irradiated with the laser beam 24 emitted from the second laser stimulating ray source 22 for a predetermined time, the control unit 70 outputs a drive stop signal to the second laser stimulating ray source 22, thereby turning it off.

Thus, fluorescence data recorded in the second absorptive region 84 of the biochemical analysis unit 80 are read to produce biochemical analysis data and the biochemical analysis data of the second absorptive region 84 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring absorptive regions 84.

In this manner, the on and off operation of the second laser stimulating ray source 22 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that fluorescence data recorded in the absorptive regions 84 included in a first line of the absorptive regions 84 formed in the biochemical analysis unit 80 have been read, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the absorptive regions 84 included in the first line of the absorptive regions 84 formed in the biochemical analysis unit 80 were sequentially irradiated with the laser beam 24 emitted from the second laser stimulating ray source 22, the absorptive regions 84 included in a second line of the absorptive regions 84 formed in the biochemical analysis unit 80 are sequentially irradiated with the laser beam 24 emitted from the second laser stimulating ray source 22, thereby exciting a fluorescent substance contained in the absorptive regions 84 included in the second line and fluorescence emission released from the absorptive regions 84 is sequentially and photoelectrically detected by the photomultiplier 50.

Analog data produced by photoelectrically detecting fluorescence emission released from each of the absorptive regions 84 included in the second line of the absorptive regions 84 formed in the biochemical analysis unit 80 by the photomultiplier 50 are converted by the A/D converter 53 to digital data and the thus produced digital data are sequentially summed by the summing means 76 to be stored in the memory 58 as biochemical analysis data recorded in the absorptive region 84.

When all of the absorptive regions 84 formed in the biochemical analysis unit 80 have been scanned with the laser beam 24 emitted from the second laser stimulating ray source 22 to excite a fluorescent substance contained in the absorptive regions 84 and digital data produced by photoelectrically detecting fluorescence emission released from the absorptive regions 84 by the photomultiplier 50 to produce analog data and digitizing the analog data by the A/D converter 53 have been sequentially summed by the summing means 76 to be stored in the memory 58, the control unit 70 outputs a drive stop signal to the second laser stimulating ray source 22, thereby turning it off.

As described above, fluorescence data recorded in a number of the absorptive regions 84 formed in the biochemical analysis unit 80 are read to produce biochemical analysis data.

On the other hand, when chemiluminescence data recorded in a number of the absorptive regions 84 formed in the biochemical analysis unit 80 are to be read to produce biochemical analysis data using the scanner shown in FIG. 20, the biochemical analysis unit 1 is placed on the sample stage 40 of the scanner while in a state of releasing chemiluminescence emission from a number of the absorptive regions 84 as a result of contact of a labeling substance contained in a number of the absorptive regions 84 formed in the biochemical analysis unit 80 and a chemiluminescent substrate and the optical fiber bundle 36 is moved to a position where the light receiving end portion 36a of the optical fiber bundle 36 can receive chemiluminescence emission released from the first absorptive region 4 among a number of the absorptive regions 84 formed in the biochemical analysis unit 80.

When the control unit 70 determined based on a detection signal indicating the position of the light receiving end portion 36a of the optical fiber bundle 36 input from the linear encoder 67 that the light receiving end portion 36a of the optical fiber bundle 36 has reached a position where the light receiving end portion 36a of the optical fiber bundle 36 can receive chemiluminescence emission released from the first absorptive region 84, it outputs a drive signal to the photomultiplier 50, thereby turning it on.

As a result, chemiluminescence emission released from the first absorptive region 84 formed in the biochemical analysis unit 80 is led by the optical fiber bundle 36 to the photomultiplier 50 and photpelectrically detected by the photomultiplier 50 to produce analog data.

In this embodiment, the control unit 70 is constituted so as to output a summing operation effecting signal to the summing means 76 simultaneously with outputting a drive signal to the photomultiplier 50. Therefore, the analog data produced by photoelectrically detecting chemiluminescence emission released from the first absorptive regions 84 by the photomultiplier 50 are converted to digital data by the A/D converter 53 and digital data are sequentially summed by the summing means 76 to be stored in the memory 58.

When a predetermined time has passed after the photomultiplier 50 was turned on, the control unit 70 outputs a drive stop signal to the photomultiplier 50, thereby turning it off.

Thus, chemiluminescence data recorded in the first absorptive region 84 of the biochemical analysis unit 80 are read to produce biochemical analysis data and the biochemical analysis data of the first absorptive region 84 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring absorptive regions 84 formed in the biochemical analysis unit 80.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring absorptive regions 84 and has reached a position where the light receiving end portion 36a of the optical fiber bundle 36 can receive chemiluminescence emission released from the second absorptive region 84 next to the first absorptive region 84 formed in the biochemical analysis unit 80, it outputs a drive stop signal to the main scanning stepping motor 65 and a drive signal to the photomultiplier 50, thereby turning it on to cause it to photoelectrically detect chemiluminescence emission released from the second absorptive region 84 formed in the biochemical analysis unit 80 and led by the optical fiber bundle 36.

Analog data produced by photoelectrically detecting chemiluminescence emission released from the second absorptive regions 84 by the photomultiplier 50 are converted to digital data by the A/D converter 53 and digital data are sequentially summed by the summing means 76 to be stored in the memory 58.

When chemiluminescence emission released from the second stimulable absorptive region 84 formed in the biochemical analysis unit 80 is photoelectrically detected by the photomultiplier 50 for a predetermined time, the control unit 70 outputs a drive stop signal to the photomultiplier 50, thereby turning it off.

Thus, chemiluminescence data recorded in the second absorptive region 84 of the biochemical analysis unit 80 are read to produce biochemical analysis data and the biochemical analysis data of the second absorptive region 84 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring absorptive regions 84 formed in the biochemical analysis unit 80.

In this manner, the on and off operation of the photomultiplier 50 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that chemiluminescence data recorded in the absorptive regions 84 included in a first line of the absorptive regions 84 formed in the biochemical analysis unit 80 have been produced, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which chemiluminescence emission released from the absorptive regions 84 included in the first line of the absorptive regions 84 formed in the biochemical analysis unit 80 was sequentially photoelectrically detected by the photomultiplier 50, chemiluminescence emission released from the absorptive regions 84 included in a second line of the absorptive regions 84 formed in the biochemical analysis unit 80 is sequentially led by the optical fiber bundle 36 to the photomultiplier 50 and photoelectrically detected by the photomultiplier 50.

Analog data produced by photoelectrically detecting chemiluminescence emission released from each of the absorptive regions 84 included in the second line of the absorptive regions 84 formed in the biochemical analysis unit 80 by the photomultiplier 50 are converted by the A/D converter 53 to digital data and the thus produced digital data are sequentially summed by the summing means 76 to be stored in the memory 58 as biochemical analysis data recorded in the absorptive region 84.

When chemiluminescence emission released from all of the absorptive regions 84 formed in the biochemical analysis unit 80 have been received by the light receiving end portion 36a of the optical fiber bundle 36 and photoelectrically detected by the photomultiplier 50 and digital data produced by photoelectrically detecting chemiluminescence emission released from the absorptive regions 84 by the photomultiplier 50 to produce analog data and digitizing the analog data by the A/D converter 53 have been sequentially summed by the summing means 76 to be stored in the memory 58, the control unit 70 outputs a drive stop signal to the photomultiplier 50, thereby turning it off.

As described above, chemiluminescence data recorded in a number of the absorptive regions 84 formed in the biochemical analysis unit 80 are read to produce biochemical analysis data.

In this embodiment, chemiluminescence data recorded in a number of the absorptive regions 84 formed in the biochemical analysis unit 80 can be transferred onto a stimulable phosphor sheet and biochemical analysis data can be produced by reading chemiluminescence data transferred onto the stimulable phosphor sheet by a scanner described later.

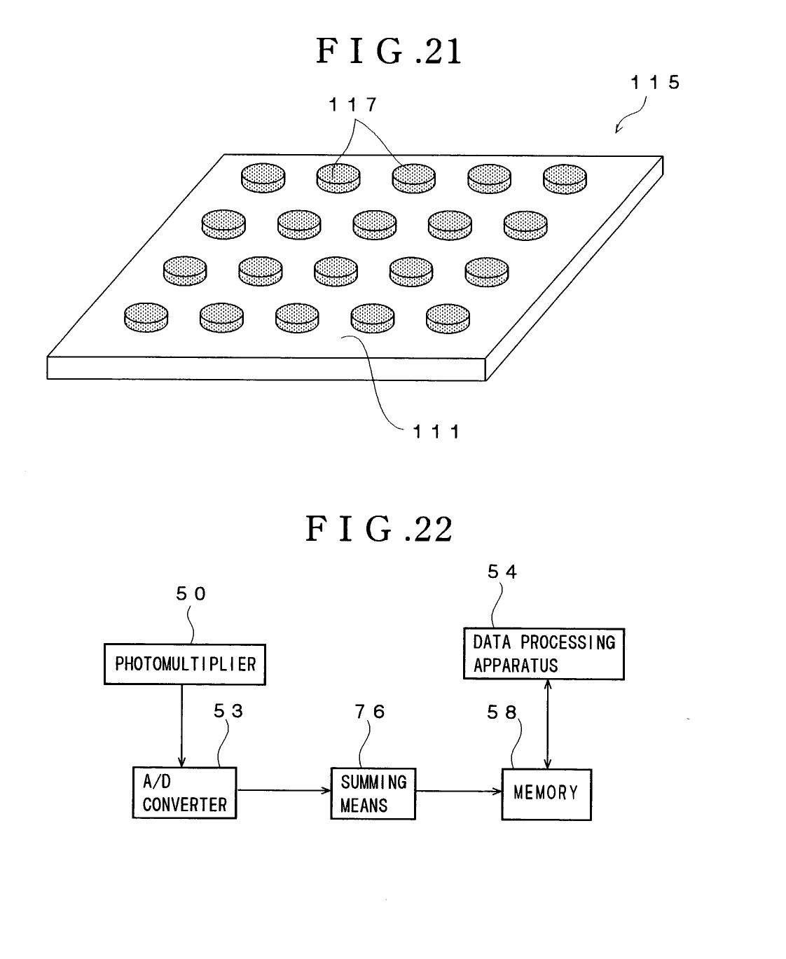

FIG. 21 is a schematic perspective view showing a stimulable phosphor sheet onto which chemiluminescence data are to be transferred and used in a method for producing biochemical analysis data which is a further preferred embodiment of the present invention.

A stimulable phosphor sheet 115 shown in FIG. 21 has the same configuration as that of the stimulable phosphor sheet 110 shown in FIG. 17 except that a number of stimulable phosphor layer regions 117 containing SrS system stimulable phosphor capable of absorbing and storing light energy are formed on the surface of the support 111.

Chemiluminescence data recorded in a number of the absorptive regions 84 formed in the biochemical analysis unit 80 are transferred onto a number of the stimulable phosphor layer regions 117 of the stimulable phosphor 115 shown in FIG. 21.

In this embodiment, similarly to the previous embodiments, when chemiluminescence data recorded in a number of the absorptive regions 84 formed in the biochemical analysis unit 80 are to be transferred onto a number of the stimulable phosphor layer regions 105 of the stimulable phosphor 100, a number of the absorptive regions 84 of the biochemical analysis unit 80 are first brought into contact with a chemiluminescent substrate.

As a result, chemiluminescence emission in a wavelength of visible light is selectively released from a number of the absorptive regions 84 of the biochemical analysis unit 80.

Then, similarly to the previous embodiments, the stimulable phosphor sheet 115 is superposed on the biochemical analysis unit 80 formed of a number of the absorptive regions 84 selectively releasing chemiluminescence emission in such a manner that each of the stimulable phosphor layer regions 117 formed in the stimulable phosphor sheet 115 faces the corresponding absorptive region 84 formed in the biochemical analysis unit 80 and a number of the stimulable phosphor layer regions 117 of the stimulable phosphor sheet 115 are exposed to chemiluminescence emission released from a number of the absorptive regions 84 of the biochemical analysis unit 84, whereby chemiluminescence data recorded in a number of the absorptive regions 84 formed in the biochemical analysis unit 84 are transferred onto a number of the stimulable phosphor layer regions 117 of the stimulable phosphor sheet 115.

FIG. 22 is a block diagram of the vicinity of a photomultiplier and a data processing apparatus of a scanner for reading chemiluminescence data recorded in a number of the stimulable phosphor layer regions 117 formed in the stimulable phosphor sheet 115 and producing biochemical analysis data, which is a further preferred embodiment of the present invention.

As shown in FIG. 22, a scanner according to this embodiment has the same configuration as that of the scanner shown in FIGS. 11 and 12 except that it includes a summing means 76 for summing digital data produced by the A/D converter 53 and a memory 58 for storing digital data summed by the summing means 76.

When chemiluminescence data recorded in a number of the stimulable phosphor layer regions 117 of the stimulable phosphor sheet 115 are to be read to produce biochemical analysis data, similarly to the previous embodiment, the stimulable phosphor sheet 115 is placed on the sample stage 40 of the scanner and a drive signal is output from the control unit 70 to the fourth laser stimulating ray source 55, thereby activating the fourth laser stimulating ray source 55.

As a result, a laser beam 24 emitted from the fourth laser stimulating ray source 55 is led to a first stimulable phosphor layer region 117 among a number of the stimulable phosphor layer regions 117 formed in the stimulable phosphor sheet 115 by the optical fiber bundle 36 and stimulable phosphor contained in the first stimulable phosphor layer regions 117 of the stimulable phosphor sheet 115, thereby releasing stimulated emission from the first stimulable phosphor layer regions 117.

Stimulated emission released from the first stimulable phosphor layer regions 117 is received by the light receiving end portion 36a of the optical fiber bundle 36 and led by the optical fiber bundle 36 to the photomultiplier 50 to be photoelectrically detected by the photomultiplier 50.

In this embodiment, the control unit 70 is constituted so as to output a summing operation effecting signal to the summing means 76 simultaneously with outputting a drive signal to the fourth laser stimulating ray source 55. Therefore, analog data produced by photoelectrically detecting stimulated emission released from the first stimulable phosphor layer regions 117 by the photomultiplier 50 are converted to digital data by the A/D converter 53 and digital data are sequentially summed by the summing means 76 to be stored in the memory 58.

When a predetermined time period has passed after the fourth laser stimulating ray source 55 was activated, the control unit 70 outputs a drive stop signal to the fourth laser stimulating ray source 55, thereby turning it off.

Thus, chemiluminescence data recorded in the first stimulable phosphor layer region 117 of the stimulable phosphor sheet 115 are read to produce biochemical analysis data and the biochemical analysis data of the first stimulable phosphor layer region 117 are stored in the memory 58.

At the same time, the control unit 70 outputs a drive signal to the main scanning stepping motor 65, thereby causing it to move the light receiving end portion 36a of the optical fiber bundle 36 by one pitch equal to the distance between neighboring stimulable phosphor layer regions 117 formed in stimulable phosphor sheet 115.

When the control unit 70 determines based on a detection signal indicating the position of the light receiving end portion 36a of the optical fiber bundle 36 input from the linear encoder 67 that the light receiving end portion 36a of the optical fiber bundle 36 has been moved by one pitch equal to the distance between neighboring stimulable phosphor layer regions 117 and has reached a position where a laser beam 24 can be projected onto a second stimulable phosphor layer region 117 next to the first stimulable phosphor layer region 117 formed in the stimulable phosphor sheet 115, it outputs a drive signal to the fourth laser stimulating ray source 55 to turn it on, thereby causing the laser beam 24 to excite stimulable phosphor contained in the second stimulable phosphor layer region 117 formed in the stimulable phosphor sheet 115 next to the first stimulable phosphor layer region 117.

Stimulated emission released from the second stimulable phosphor layer regions 117 is received by the light receiving end portion 36a of the optical fiber bundle 36 and led by the optical fiber bundle 36 to the photomultiplier 50 to be photoelectrically detected by the photomultiplier 50.

Analog data produced by photoelectrically detecting stimulated emission released from the second stimulable phosphor layer regions 117 by the photomultiplier 50 are converted to digital data by the A/D converter 53 and digital data are sequentially summed by the summing means 76 to be stored in the memory 58.

When the second stimulable phosphor layer region 117 formed in the stimulable phosphor sheet 115 is irradiated with the laser beam 24 emitted from the fourth laser stimulating ray source 55 for a predetermined time, the control unit 70 outputs a drive stop signal to the fourth laser stimulating ray source 55, thereby turning it off.

Thus, radiation data recorded in the second stimulable phosphor layer region 117 of the stimulable phosphor sheet 115 are read to produce biochemical analysis data and the biochemical analysis data of the second stimulable phosphor layer region 117 are stored in the memory 58.

At the same time, the control unit 70 outputs a drive signal to the main scanning stepping motor 65, thereby moving the light receiving end portion 36a of the optical fiber bundle 36 by one pitch equal to the distance between neighboring stimulable phosphor layer regions 117.

In this manner, the on and off operation of the fourth laser stimulating ray source 55 is repeated in synchronism with the intermittent movement of the light receiving end portion 36a of the optical fiber bundle 36 and when the control unit 70 determines based on a detection signal indicating the position of the light receiving end portion 36a of the optical fiber bundle 36 input from the linear encoder 67 that the light receiving end portion 36a of the optical fiber bundle 36 has been moved by one scanning line in the main scanning direction and that chemiluminescence data recorded in the stimulable phosphor layer regions 117 included in a first line of the stimulable phosphor layer regions 117 formed in the stimulable phosphor sheet 115 have been read, it outputs a drive signal to the main scanning stepping motor 65, thereby returning the light receiving end portion 36a of the optical fiber bundle 36 to its original position and outputs a drive signal to the sub-scanning pulse motor 61, thereby causing it to move the movable base plate 63 by one scanning line in the sub-scanning direction.

When the control unit 70 determines based on a detection signal indicating the position of the light receiving end portion 36a of the optical fiber bundle 36 input from the linear encoder 67 that the light receiving end portion 36a of the optical fiber bundle 36 has been returned to its original position and determines that the movable base plate 63 has been moved by one scanning line in the sub-scanning direction, similarly to the manner in which the stimulable phosphor layer regions 117 included in the first line of the stimulable phosphor layer regions 117 formed in the stimulable phosphor sheet 115 were sequentially irradiated with the laser beam 24 emitted from the fourth laser stimulating ray source 55, the stimulable phosphor layer regions 117 included in a second line of the stimulable phosphor layer regions 117 formed in the stimulable phosphor sheet 115 are sequentially irradiated with the laser beam 24 emitted from the fourth laser stimulating ray source 55, thereby exciting stimulable phosphor contained in the stimulable phosphor layer regions 117 included in the second line and stimulated emission released from the stimulable phosphor layer regions 117 is sequentially and photoelectrically detected by the photomultiplier 50.

Analog data produced by photoelectrically detecting stimulated emission released from each of the stimulable phosphor layer regions 117 included in the second line of the stimulable phosphor layer regions 117 formed in the stimulable phosphor sheet 115 by the photomultiplier 50 are converted by the A/D converter 53 to digital data and the thus produced digital data are sequentially summed by the summing means 76 to be stored in the memory 58 as biochemical analysis data recorded in the stimulable phosphor layer region 117.

When all of the stimulable phosphor layer regions 117 formed in the stimulable phosphor sheet 115 have been scanned with the laser beam 24 emitted from the fourth laser stimulating ray source 55 to excite stimulable phosphor contained in the stimulable phosphor layer regions 117 and digital data produced by photoelectrically detecting stimulated emission released from the stimulable phosphor layer regions 117 by the photomultiplier 50 to produce analog data and digitizing the analog data by the A/D converter 53 have been sequentially summed by the summing means 76 to be stored in the memory 58, the control unit 70 outputs a drive stop signal to the fourth laser stimulating ray source 55, thereby turning it off.

As described above, chemiluminescence data recorded in a number of the stimulable phosphor layer regions 117 formed in the stimulable phosphor sheet 115 are read to produce biochemical analysis data.

According to this embodiment, since biochemical analysis data of each of the stimulable phosphor layer regions 112 of the stimulable phosphor sheet 110 are produced by photoelectrically detecting stimulated emission released from each of the stimulable phosphor layer regions 112 of the stimulable phosphor sheet 110 to produce analog data by the photomultiplier 50, digitizing the analog data by the A/D converter 53 to produce digital data and summing the digital data by the summing means 76, even in the case where radiation energy stored in a particular stimulable phosphor layer region 112 of the stimulable phosphor sheet 110 is low and the intensity of stimulated emission released from the stimulable phosphor layer region 112 is low, biochemical analysis data having sufficiently high signal intensity can be produced with high sensitivity.

Further, according to this embodiment, since biochemical analysis data of each of the stimulable phosphor layer regions 117 of the stimulable phosphor sheet 115 are produced by photoelectrically detecting stimulated emission released from each of the stimulable phosphor layer regions 117 of the stimulable phosphor sheet 115 to produce analog data by the photomultiplier 50, digitizing the analog data by the A/D converter 53 to produce digital data and summing the digital data by the summing means 76, even in the case where the energy of chemiluminescence emission stored in a particular stimulable phosphor layer region 117 of the stimulable phosphor sheet 115 is low and the intensity of stimulated emission released from the stimulable phosphor layer region 117 is low, biochemical analysis data having sufficiently high signal intensity can be produced with high sensitivity.

Furthermore, according to this embodiment, since biochemical analysis data of each of the absorptive regions 84 of the biochemical analysis unit 80 are produced by photoelectrically detecting fluorescence emission or chemiluminescence emission released from each of the absorptive regions 84 of the biochemical analysis unit 80 to produce analog data by the photomultiplier 50, digitizing the analog data by the A/D converter 53 to produce digital data and summing the digital data by the summing means 76, even in the case where the intensity of fluorescence emission or chemiluminescence emission released from a particular absorptive region 84 of the biochemical analysis unit 80 is low, biochemical analysis data having sufficiently high signal intensity can be produced with high sensitivity.

The present invention has thus been shown and described with reference to specific embodiments. However, it should be noted that the present invention is in no way limited to the details of the described arrangements but changes and modifications may be made without departing from the scope of the appended claims.

For example, in the above described embodiments, as specific binding substances, cDNAs each of which has a known base sequence and is different from the others are used. However, specific binding substances usable in the present invention are not limited to cDNAs but all specific binding substances capable of specifically binding with a substance derived from a living organism such as a cell, virus, hormone, tumor marker, enzyme, antibody, antigen, abzyme, other protein, a nuclear acid, cDNA, DNA, RNA or the like and whose sequence, base length, composition and the like are known, can be employed in the present invention as a specific binding substance.

Further, the biochemical analysis unit 1 includes a number of the absorptive regions 4 formed by charging nylon-6 in number of the through-holes 3 formed in the substrate 2 made of stainless steel in the embodiment shown in FIG. 1 and the biochemical analysis unit 80 includes a number of the absorptive regions 84 formed by pressing the absorptive membrane 83 formed of nylon-6 into a number of the through-holes 82 formed in the substrate 81 made of stainless steel. However, it is not absolutely necessary to form the absorptive regions 4, 84 of the biochemical analysis unit 1, 80 of nylon-6 and the absorptive regions 4, 84 of the biochemical analysis unit 1, 80 may be formed of other kinds of absorptive materials. A porous material or a fiber material may be preferably used as the absorptive material for forming the absorptive regions 4, 84 of the biochemical analysis unit 1, 80 and the absorptive regions 4, 84 of the biochemical analysis unit 1, 80 may be formed by combining a porous material and a fiber material. A porous material for forming the absorptive regions 4, 84 of the biochemical analysis unit 1, 80 may be any type of an organic material or an inorganic material and may be an organic/inorganic composite material. An organic porous material used for forming the absorptive regions 4, 84 of the biochemical analysis unit 1, 80 is not particularly limited but a carbon porous material such as an activated carbon or a porous material capable of forming a membrane filter can be preferably used. Illustrative examples of porous materials capable of forming a membrane filter include nylons such as nylon-6, nylon-6,6, nylon-4,10; cellulose derivatives such as nitrocellulose, acetyl cellulose, butyric-acetyl cellulose; collagen; alginic acids such as alginic acid, calcium alginate, alginic acid/poly-L-lysine polyionic complex; polyolefins such as polyethylene, polypropylene; polyvinyl chloride;

polyvinylidene chloride; polyfluoride such as polyvinylidene fluoride, polytetrafluoride; and copolymers or composite materials thereof. An inorganic porous material used for forming the absorptive regions 4, 84 of the biochemical analysis unit 1, 80 is not particularly limited. Illustrative examples of inorganic porous materials preferably usable in the present invention include metals such as platinum, gold, iron, silver, nickel, aluminum and the like; metal oxides such as alumina, silica, titania, zeolite and the like; metal salts such as hydroxy apatite, calcium sulfate and the like; and composite materials thereof. A fiber material used for forming the absorptive regions 4, 84 of the biochemical analysis unit 1, 80 is not particularly limited. Illustrative examples of fiber materials preferably usable in the present invention include nylons such as nylon-6, nylon-6,6, nylon-4, 10; and cellulose derivatives such as nitrocellulose, acetyl cellulose, butyric-acetyl cellulose.

Furthermore, in the above described embodiments, although the biochemical analysis unit 1, 80 includes the substrate 2, 81 made of stainless steel, it is not absolutely necessary to make the substrate 2, 81 of the biochemical analysis unit 1, 80 of stainless steel but the substrate 2, 81 of the biochemical analysis unit 1, 80 may be made of other kinds of material. It is preferable to make the substrate 2, 81 of the biochemical analysis unit 1, 80 of a material capable of attenuating light energy and radiation energy but a material for forming the substrate 2, 81 of the biochemical analysis unit 1, 80 is not particularly limited. The substrate 2, 81 of the biochemical analysis unit 1, 80 can be formed of either inorganic compound material or organic compound material and is preferably formed of a metal material, a ceramic material or a plastic material. Illustrative examples of inorganic compound materials usable for forming the substrate 2, 81 of the biochemical analysis unit 1, 80 and capable of attenuating light energy and radiation energy include metals such as gold, silver, copper, zinc, aluminum, titanium, tantalum, chromium, steel, nickel, cobalt, lead, tin, selenium and the like; alloys such as brass, stainless, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. High molecular compounds are preferably used as organic compound material for forming the substrate 2, 81 of the biochemical analysis unit 1, 80 and capable of attenuating light energy and radiation energy and illustrative examples thereof include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifluoroethylene; polycarbonate; polyesters such as polyethylene naphthalate, polyethylene terephthalate and the like; nylons such as nylon-6, nylon-6,6, nylon-4, 10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials. These may be a composite compound, and metal oxide particles, glass fiber or the like may be added thereto as occasion demands. Further, an organic compound material may be blended therewith.

Moreover, in the above described embodiments, although a number of the absorptive regions 4 of the biochemical analysis unit 1 are formed by charging nylon-6 in a number of the through-holes 3 formed in the substrate 2 in the embodiment shown in FIG. 1 and a number of the absorptive regions 84 of the biochemical analysis unit 80 are formed by pressing the absorptive membrane 83 into a number of the through-holes 82 formed in the substrate 81 in the embodiment shown in FIG. 13, a number of absorptive regions may be formed to be spaced apart from each other by closely contacting a perforated plate formed with a number of through-holes onto one surface of an absorptive substrate.

Further, in the embodiment shown in FIG. 4 and the embodiment shown in FIG. 10, the stimulable phosphor sheet 10, 15 includes the support 11 made of stainless steel and regularly formed with a number of the substantially circular through-holes 13 and a number of the stimulable phosphor layer regions 12, 17 are regularly formed by charging stimulable phosphor in a number of the through-holes 13, a number of the stimulable phosphor layer regions 12, 17 may be regularly formed by charging stimulable phosphor in a number of substantially circular recesses regularly formed in the support 11 instead of a number of the substantially circular through-holes 13.

Furthermore, in the embodiment shown in FIG. 14 and the embodiment shown in FIG. 17, a number of the stimulable phosphor layer regions 95, 105 of the stimulable phosphor sheet 90, 100 are formed by pressing the stimulable phosphor membrane 91, 101 into a number of the through-holes 92 formed in the substrate 93 made of stainless steel using the calender processing apparatus, it is not absolutely necessary to form a number of the stimulable phosphor layer regions 95, 105 of the stimulable phosphor sheet 90, 100 by pressing the stimulable phosphor membrane 91, 101 into a number of the through-holes 92 formed in the substrate 93 using the calender processing apparatus but a number of the stimulable phosphor layer regions 95, 105 may be formed by pressing the stimulable phosphor membrane 91, 101 into a number of the through-holes 92 formed in the substrate 93 using other means. Further, a number of the stimulable phosphor layer regions 95, 101 can be formed by charging the stimulable phosphor membrane 91, 101 into a number of the through-holes 92 formed in the substrate 93 by a proper method instead of pressing.

Moreover, in the above described embodiments, a number of the stimulable phosphor layer regions 12, 17 of the stimulable phosphor sheet 10, 15 are formed by charging stimulable phosphor in a number of the through-holes 13 formed in the support 11 made of stainless steel in the embodiment shown in FIG. 4 and the embodiment shown in FIG. 10, a number of the stimulable phosphor layer regions 95, 105 of the stimulable phosphor sheet 90, 100 are formed by pressing the stimulable phosphor membrane 91, 101 into a number of the through-holes 92 formed in the substrate 93 made of stainless steel in the embodiment shown in FIG. 14 and the embodiment shown in FIG. 17, and a number of the stimulable phosphor layer regions 112, 117 of the stimulable phosphor sheet 110, 115 are formed on the surface of the support 111 made of stainless steel. However, it is not absolutely necessary to use the support 11 made of stainless steel, the substrate 93 made of stainless steel or the support 111 made of stainless steel but the support 11 of the stimulable phosphor sheet 10, 15, the substrate 93 of the stimulable phosphor sheet 90, 100 and the support 111 of the stimulable phosphor sheet 110, 115 can be formed of a plate-like member made of other kinds of material. It is preferable to make a plate-like member for forming the support 11 of the stimulable phosphor sheet 10, 15, the substrate 93 of the stimulable phosphor sheet 90, 100 and the support 111 of the stimulable phosphor sheet 110, 115 of a material capable of attenuating radiation energy and/or light energy but a material for forming the support 11 of the stimulable phosphor sheet 10, 15, the substrate 93 of the stimulable phosphor sheet 90, 100 and the support 111 of the stimulable phosphor sheet 110, 115 is not particularly limited. The support 11 of the stimulable phosphor sheet 10, 15, the substrate 93 of the stimulable phosphor sheet 90, 100 and the support 111 of the stimulable phosphor sheet 110, 115 can be can be formed of either inorganic compound material or organic compound material and is preferably formed of a metal material, a ceramic material or a plastic material. Illustrative examples of inorganic compound materials usable for forming the support 11 of the stimulable phosphor sheet 10, 15, the substrate 93 of the stimulable phosphor sheet 90, 100 and the support 111 of the stimulable phosphor sheet 110, 115 and capable of attenuating radiation energy and/or light energy include metals such as gold, silver, copper, zinc, aluminum, titanium, tantalum, chromium, steel, nickel, cobalt, lead, tin, selenium and the like; alloys such as brass, stainless, bronze and the like; silicon materials such as silicon, amorphous silicon, glass, quartz, silicon carbide, silicon nitride and the like; metal oxides such as aluminum oxide, magnesium oxide, zirconium oxide and the like; and inorganic salts such as tungsten carbide, calcium carbide, calcium sulfate, hydroxy apatite, gallium arsenide and the like. High molecular compounds are preferably used as organic compound material usable for forming the support 11 of the stimulable phosphor sheet 10, 15, the substrate 93 of the stimulable phosphor sheet 90, 100 and the support 111 of the stimulable phosphor sheet 110, 115 and capable of attenuating radiation energy and/or light energy and illustrative examples thereof include polyolefins such as polyethylene, polypropylene and the like; acrylic resins such as polymethyl methacrylate, polybutylacrylate/polymethyl methacrylate copolymer and the like; polyacrylonitrile; polyvinyl chloride; polyvinylidene chloride; polyvinylidene fluoride; polytetrafluoroethylene; polychlorotrifluoroethylene; polycarbonate; polyesters such as polyethylene naphthalate, polyethylene terephthalate and the like; nylons such as nylon-6, nylon-6,6, nylon-4,10 and the like; polyimide; polysulfone; polyphenylene sulfide; silicon resins such as polydiphenyl siloxane and the like; phenol resins such as novolac and the like; epoxy resin; polyurethane; polystyrene, butadiene-styrene copolymer; polysaccharides such as cellulose, acetyl cellulose, nitrocellulose, starch, calcium alginate, hydroxypropyl methyl cellulose and the like; chitin; chitosan; urushi (Japanese lacquer); polyamides such as gelatin, collagen, keratin and the like; and copolymers of these high molecular materials. These may be a composite compound, and metal oxide particles, glass fiber or the like may be added thereto as occasion demands. Further, an organic compound material may be blended therewith.

Moreover, in the above described embodiments, although correspondingly to the absorptive regions 4, 84 formed in the biochemical analysis unit 1, 80, about 10,000 substantially circular stimulable phosphor layer regions 12, 17, 95, 105, 112, 117 having a size of about 0.01 mm² are dot-like formed in a regular pattern at a density of about 5,000 per cm²in the stimulable phosphor sheet 10, 15, 90, 100, 110, 115, the shape of each of the stimulable phosphor layer regions 12, 17, 95, 105, 112, 117 is not limited to substantially a circular shape but may be formed in an arbitrary shape, for example, a rectangular shape.

Further, in the above described embodiments, although correspondingly to the absorptive regions 4, 84 formed in the biochemical analysis unit 1, 80, about 10,000 substantially circular stimulable phosphor layer regions 12, 17, 95, 105, 112, 117 having a size of about 0.01 mm² are dot-like formed in a regular pattern at a density of about 5,000 per cm² in the stimulable phosphor sheet 10, 15, 90, 100, 110, 115, the number or size of the stimulable phosphor layer regions 12, 17, 95, 105, 112, 117 may be arbitrarily selected in accordance with the purpose. Preferably, 10 or more of the stimulable phosphor layer regions 12, 17, 95, 105, 112, 117 having a size of 5 cm² or less are formed in the stimulable phosphor sheet 10, 15, 90, 100, 110, 115 at a density of 10/cm² or greater.

Furthermore, in the above described embodiments, although correspondingly to the absorptive regions 4, 84 formed in the biochemical analysis unit 1, 80, about 10,000 substantially circular stimulable phosphor layer regions 12, 17, 95, 105, 112, 117 having a size of about 0.01 mm² are dot-like formed in a regular pattern at a density of about 5,000 per cm² in the stimulable phosphor sheet 10, 15, 90, 100, 110, 115, it is not absolutely necessary to form the absorptive regions 4, 84 in a regular pattern in the biochemical analysis unit 1, 80 and, therefore, it is not necessary to form the stimulable phosphor layer regions 12, 17, 95, 105, 112, 117 in a regular pattern in the stimulable phosphor sheet 10, 15, 90, 100, 110, 115. It is sufficient for the stimulable phosphor layer regions 12, 17, 95, 105, 112, 117 to be formed in the stimulable phosphor sheet 10, 15, 90, 100, 110, 115 in the same pattern as that of the absorptive regions 4, 84 formed in the biochemical analysis unit 1, 80.

Moreover, in the above described embodiments, although the stimulable phosphor layer regions 12, 17, 95, 105, 112, 117 of the stimulable phosphor sheet 10, 15, 90, 100, 110, 115 are formed so that each of them has the same size as that of each of the absorptive regions 4, 84 formed in the biochemical analysis unit 1, 80, it is not absolutely necessary to form each of the stimulable phosphor layer regions 12, 17, 95, 105, 112, 117 so as to have the same size as that of each of the absorptive regions 4, 84 formed in the biochemical analysis unit 1, 80 and the size of each of the stimulable phosphor layer regions 12, 17, 95, 105, 112, 117 may be arbitrarily selected in accordance with the purpose. Preferably, each of the stimulable phosphor layer regions 12, 17, 95, 105, 112, 117 is formed in the stimulable phosphor sheet 10, 15, 90, 100, 110, 115 so as to be equal to or larger than the size of each of the absorptive regions 4, 84 formed in the biochemical analysis unit 1, 80.

Further, in the above described embodiments, a hybridization reaction solution 9 containing a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye is prepared. However, it is not absolutely necessary for the hybridization reaction solution 9 to contain a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye but it is sufficient for the hybridization reaction solution 9 to contain at least one kind of a substance derived from a living organism and labeled with a radioactive labeling substance, a substance derived from a living organism and labeled with a labeling substance which generates chemiluminescence emission when it contacts a chemiluminescent substrate and a substance derived from a living organism and labeled with a fluorescent substance such as a fluorescent dye.

Furthermore, in the above described embodiments, specific binding substances are hybridized with substances derived from a living organism and labeled with a radioactive labeling substance, a substance derived from a living organism and labeled with a labeling substance which generates chemiluminescence emission when it contacts a chemiluminescent substrate and a fluorescent substance. However, it is not absolutely necessary to hybridize substances derived from a living organism with specific binding substances and substances derived from a living organism may be specifically bound with specific binding substances by means of antigen-antibody reaction, receptor-ligand reaction or the like instead of hybridization.

Further, in the above described embodiments, a laser beam 24 is led to the stimulable phosphor sheet 10, 15, 90, 100, 110, 115 or the biochemical analysis unit 1, 80 and stimulated emission or fluorescence emission released from the stimulable phosphor sheet 10, 15, 90, 100, 110, 115 or the biochemical analysis unit 1, 80 is received and led to the photomultiplier 50 using the optical fiber bundle 36 constituted by a plurality of optical fibers. However, it is possible to lead a laser beam 24 to the stimulable phosphor sheet 10, 15, 90, 100, 110, 115 or the biochemical analysis unit 1, 80 and receive and lead stimulated emission or fluorescence emission released from the stimulable phosphor sheet 10, 15, 90, 100, 110, 115 or the biochemical analysis unit 1, 80 to the photomultiplier 50 using a single optical fiber instead of the optical fiber bundle 36.

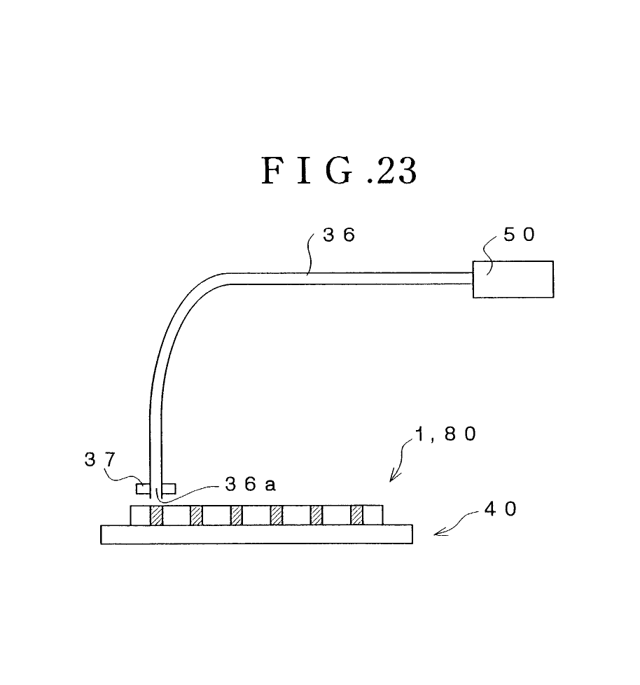

Moreover, in the above described embodiments, biochemical analysis data are produced by reading radiation data recorded in a number of the stimulable phosphor layer regions 12, 95, 112 formed in the stimulable phosphor sheet 10, 90, 110, fluorescence data recorded in a number of the absorptive regions 4, 84 formed in the biochemical analysis unit 1, 84 and chemiluminescence data recorded in a number of the absorptive regions 4, 84 formed in the biochemical analysis unit 1, 84 using the scanner shown in FIGS. 6 to 9, the scanner shown in FIG. 16 or the scanner shown in FIG. 20. However, it is not absolutely necessary to read radiation data, fluorescence data and chemiluminescence data using a single scanner to produce biochemical analysis data and biochemical analysis data may be produced by reading chemiluminescence data recorded in a number of the absorptive regions 4, 84 formed in the biochemical analysis unit 1, 84 using a dedicated scanner shown in FIG. 23, which is provided with no laser stimulating ray source and in which a light receiving surface of the photomultiplier 50 is connected to one end portion of the optical fiber bundle 36.

Further, in the embodiment shown in FIGS. 6 to 9, the embodiment shown in FIG. 16 and the embodiment shown in FIG. 20, the on and off operation of the first laser stimulating ray source 21 or the second laser stimulating ray source 22 is controlled by the control unit 70 in synchronism with the intermittent movement of the light receiving end portion 36a of the optical fiber bundle 36. However, if the moving speed of the light receiving end portion 36a of the optical fiber bundle 36 in the main scanning direction is determined so that the laser beam 24 quickly passes portions between neighboring stimulable phosphor layer regions 12, 95, 105 or neighboring absorptive regions 4, 84 in the main scanning direction, biochemical analysis data may be produced by merely intermittently moving the light receiving end portion 36a of the optical fiber bundle 36 while the first laser stimulating ray source 21 or the second laser stimulating ray source 22 is kept on, thereby sequentially scanning a number of the stimulable phosphor layer regions 12, 95, 112 or a number of the absorptive regions 4, 84 with the laser beam 24 and photoelectrically detecting stimulated emission released from the stimulable phosphor layer regions 12, 95, 112 or fluorescence emission released from the absorptive regions 4, 84.

Furthermore, in the embodiment shown in FIGS. 11 and 12, the embodiment shown in FIG. 18 and the embodiment shown in FIG. 22, the on and off operation of the fourth laser stimulating ray source 55 is controlled by the control unit 70 in synchronism with the intermittent movement of the light receiving end portion 36a of the optical fiber bundle 36. However, if the moving speed of the light receiving end portion 36a of the optical fiber bundle 36 in the main scanning direction is determined so that the laser beam 24 quickly passes portions between neighboring stimulable phosphor layer regions 17, 105, 117 in the main scanning direction, biochemical analysis data may be produced by merely intermittently moving the light receiving end portion 36a of the optical fiber bundle 36 while the fourth laser stimulating ray source 55 is kept on, thereby sequentially scanning a number of the stimulable phosphor layer regions 17, 105, 117 with the laser beam 24 and photoelectrically detecting stimulated emission released from the stimulable phosphor layer regions 17, 105, 117.

Moreover, in the above described embodiments, the scanner shown in FIGS. 6 to 9, the scanner shown in FIG. 16 and the scanner shown in FIG. 20 includes the first laser stimulating ray source 21, the second laser stimulating ray source 22 and the third laser stimulating ray source 23, and the scanner shown in FIGS. 11 and 12, the scanner shown in FIG. 18 and the scanner shown in FIG. 22 includes the first laser stimulating ray source 21, the second laser stimulating ray source 22 and the fourth laser stimulating ray source 55. However, it is not absolutely necessary for any scanner to include three laser stimulating ray sources for emitting laser beams having different wavelengths from each other.

Further, in the above described embodiments, the scanner shown in FIGS. 6 to 9, the scanner shown in FIG. 16 and the scanner shown in FIG. 20 includes the first laser stimulating ray source 21 for emitting a laser beam having a wavelength of 640 nm, the second laser stimulating ray source 22 for emitting a laser beam having a wavelength of 532 nm and the third laser stimulating ray source 23 for emitting a laser beam having a wavelength of 473 nm, and the scanner shown in FIGS. 11 and 12, the scanner shown in FIG. 18 and the scanner shown in FIG. 22 includes the first laser stimulating ray source 21 for emitting a laser beam having a wavelength of 640 nm, the second laser stimulating ray source 22 for emitting a laser beam having a wavelength of 532 nm and the fourth laser stimulating ray source 55 for emitting a laser beam having a wavelength of 980 nm. However, it is not absolutely necessary to employ a laser stimulating ray source as a stimulating ray source and an LED (light emitting diode) light source may be employed as a stimulating ray source instead of a laser stimulating ray source. Further, it is possible to employ a halogen lamp as a stimulating ray source and to provide a spectral filter to cut wavelength components which cannot contribute to the excitation of stimulable phosphor.

Furthermore, in the above described embodiments, the scanner is constituted so that all of the stimulable phosphor layer regions 12, 17, 95, 105, 112, 117 of the stimulable phosphor sheet 10, 15, 90, 100, 110, 115 or all of the absorptive regions 4, 84 of the biochemical analysis unit 1, 80 are scanned with a laser beam 24 to excite stimulable phosphor or a fluorescent substance such as a fluorescent dye by moving the light receiving end portion 36a of the optical fiber bundle 36 using a scanning mechanism in the main scanning direction indicated by the arrow X direction and the sub-scanning direction indicated by the arrow Y in FIG. 8. However, all of the stimulable phosphor layer regions 12, 17, 95, 105, 112, 117 of the stimulable phosphor sheet 10, 15, 90, 100, 110, 115 or all of the absorptive regions 4, 84 of the biochemical analysis unit 1, 80 may be scanned with a laser beam 24 to excite stimulable phosphor or a fluorescent substance such as a fluorescent dye by moving the stage 40 in the main scanning direction indicated by the arrow X direction and the sub-scanning direction indicated by the arrow Y in FIG. 8, while holding the light receiving end portion 36a of the optical fiber bundle 36 stationary, or moving the light receiving end portion 36a of the optical fiber bundle 36 in the main scanning direction indicated by the arrow X direction or the sub-scanning direction indicated by the arrow Y in FIG. 8 and moving the stage 40, 160 in the sub-scanning direction indicated by the arrow Y or the main scanning direction indicated by the arrow X in FIG. 8. In the case where the stage 40 is constituted so as to be moved in the main scanning direction, it is possible to detect the position of the stage relative to the light receiving end portion 36a of the optical fiber bundle 36 by providing a linear encoder in a moving mechanism of the stage 40 or to detect the position of the stage relative to the light receiving end portion 36a of the optical fiber bundle 36 by detecting the rotational position of a motor for driving the stage 40 by a rotary encoder.

Moreover, in the above described embodiments, although the position of the light receiving end portion 36a of the optical fiber bundle 36 in the main scanning direction is detected using the linear encoder 67, the position of the light receiving end portion 36a of the optical fiber bundle 36 in the main scanning direction may be detected by detecting the rotational position of the main scanning stepping motor 65.

Further, in the above described embodiments, the scanner employs the photomultiplier 50 as a light detector to photoelectrically detect stimulated emission or fluorescence emission. However, it is sufficient for the light detector used in the present invention to be able to photoelectrically detect stimulated emission or fluorescence emission and it is possible to employ a light detector such as a line CCD, a two-dimensional CCD and the like instead of the photomultiplier 50.

Furthermore, in the above described embodiments, a solution containing specific binding substances such as cDNAs are spotted using the spotting device 5 including an injector 6 and a CCD camera 7 so that when the tip end portion of the injector 6 and the center of the absorptive region 4, 84 into which a solution containing specific binding substances is to be spotted are determined to coincide with each other as a result of viewing them using the CCD camera 7, the solution containing the specific binding substances such as cDNA is ejected from the injector 6. However, the solution containing specific binding substances such as cDNAs can be spotted by detecting the positional relationship between a number of the absorptive regions 4, 84 formed in the biochemical analysis unit 1, 80 and the tip end portion of the injector 6 in advance and two-dimensionally moving the biochemical analysis unit 1, 80 or the tip end portion of the injector 6 so that the tip end portion of the injector 6 coincides with each of the absorptive regions 4, 84.

According to the present invention, it is possible to provide a method for producing biochemical analysis data and a scanner used therefor which can produce biochemical analysis data having high quantitative characteristics by photoelectrically detecting light emitted from a plurality of spot-like regions even in the case where the plurality of spot-like regions labeled with a labeling substance are formed in a biochemical analysis unit at high density.

1. A method for producing biochemical analysis data by photoelectrically detecting light released from a plurality of light releasable regions two-dimensionally formed so as to be spaced apart from each other in a sample placed on a sample stage, the method for producing biochemical analysis data comprising steps of intermittently moving a light guide member for leading light released from the plurality of light releasable regions to a light detector and the sample stage relative to each other in a main scanning direction and a sub-scanning direction perpendicular to the main scanning direction, leading light released from the plurality of light releasable regions two-dimensionally formed so as to be spaced apart from each other in the sample to a light detector through the light guide member, and photoelectrically detecting light by the light detector.

2. A method for producing biochemical analysis data in accordance with claim 1 wherein the light guide member has flexibility.

3. A method for producing biochemical analysis data in accordance with claim 2 wherein the light guide member is formed of at least one optical fiber.

4. A method for producing biochemical analysis data in accordance with claim 1 wherein the sample is regularly formed with the plurality of light releasable regions at a predetermined pitch in the main scanning direction and the sub-scanning direction and which comprises a step of intermittently moving the light guide member and the sample stage relative to each other by the predetermined pitch to photoelectrically detect light released from the plurality of light releasable regions two-dimensionally formed to be spaced form each other in the sample, thereby producing biochemical analysis data.

5. A method for producing biochemical analysis data in accordance with claim 1 which comprises a step of moving the light guide member in the main scanning direction and the sub-scanning direction to photoelectrically detect light released from the plurality of light releasable regions two-dimensionally formed to be spaced form each other in the sample, thereby producing biochemical analysis data.

6. A method for producing biochemical analysis data in accordance with claim 1 which comprises a step of moving the light guide member in the main scanning direction and the sample stage in the sub-scanning direction to photoelectrically detect light released from the plurality of light releasable regions two-dimensionally formed to be spaced form each other in the sample , thereby producing biochemical analysis data.

7. A method for producing biochemical analysis data in accordance with claim 1 wherein the sample is constituted as a stimulable phosphor including a support two-dimensionally formed with a plurality of stimulable phosphor layer regions spaced apart from each other and selectively storing radiation energy and which comprises steps of leading a stimulating ray through the light guide member, irradiating the individual stimulable phosphor layer regions with the stimulating ray, leading stimulated emission released from the individual stimulable phosphor layer regions through the light guide member to the light detector and photoelectrically detecting the stimulated emission by the light detector to produce biochemical analysis data.

8. A method for producing biochemical analysis data in accordance with claim 7 wherein radiation energy is selectively stored in the plurality of stimulable phosphor layer regions of the stimulable phosphor sheet by forming a plurality of spot-like regions selectively containing a radioactive labeling substance and spaced apart from each other in a biochemical analysis unit in the same pattern as that of the plurality of stimulable phosphor layer regions formed in the stimulable phosphor sheet, superposing the stimulable phosphor sheet on the biochemical analysis unit in such a manner that each of the plurality of stimulable phosphor layer regions formed in the stimulable phosphor sheet faces the corresponding spot-like region of the biochemical analysis unit, and exposing the plurality of stimulable phosphor layer regions of the stimulable phosphor sheet to a radioactive labeling substance selectively contained in the plurality of spot-like regions of the biochemical analysis unit.

9. A method for producing biochemical analysis data in accordance with claim 1 wherein the sample is constituted as a stimulable phosphor including a support two-dimensionally formed with a plurality of stimulable phosphor layer regions spaced apart from each other and selectively storing the energy of chemiluminescence emission and which comprises a steps of leading a stimulating ray through the light guide member, irradiating the individual stimulable phosphor layer regions with the stimulating ray, leading stimulated emission released from the individual stimulable phosphor layer regions through the light guide member to the light detector and photoelectrically detecting the stimulated emission by the light detector to produce biochemical analysis data.

10. A method for producing biochemical analysis data in accordance with claim 9 wherein the energy of chemiluminescence emission is selectively stored in the plurality of stimulable phosphor layer regions of the stimulable phosphor sheet by forming a plurality of spot-like regions selectively containing a labeling substance which generates chemiluminescence emission when it contacts a chemiluminescent substrate and spaced apart from each other in a biochemical analysis unit in the same pattern as that of the plurality of stimulable phosphor layer regions formed in the stimulable phosphor sheet, bringing the plurality of spot-like regions of the biochemical analysis unit into contact with a chemiluminescent substrate, thereby causing the spot-like regions of the biochemical analysis unit to selectively release chemiluminescence emission, superposing the stimulable phosphor sheet on the biochemical analysis unit in such a manner that each of the plurality of stimulable phosphor layer regions formed in the stimulable phosphor sheet faces the corresponding spot-like region of the biochemical analysis unit, and exposing the plurality of stimulable phosphor layer regions of the stimulable phosphor sheet to chemiluminescence emission selectively released from the plurality of spot-like regions of the biochemical analysis unit.

11. A method for producing biochemical analysis data in accordance with claim 7 wherein the support of the stimulable phosphor sheet has a property of attenuating light and/or radiation energy.

12. A method for producing biochemical analysis data in accordance with claim 9 wherein the support of the stimulable phosphor sheet has a property of attenuating light and/or radiation energy.

13. A method for producing biochemical analysis data in accordance with claim 11 wherein the support of the stimulable phosphor sheet has a property of reducing the energy of light and/or radiation to ⅕ or less when the light and/or radiation travels in the support by a distance equal to that between neighboring stimulable phosphor layer regions.

14. A method for producing biochemical analysis data in accordance with claim 12 wherein the support of the stimulable phosphor sheet has a property of reducing the energy of light and/or radiation to ⅕ or less when the light and/or radiation travels in the support by a distance equal to that between neighboring stimulable phosphor layer regions.

15. A method for producing biochemical analysis data in accordance with claim 7 wherein the support of the stimulable phosphor sheet is made of a material selected from a group consisting of a metal material, a ceramic material and a plastic material.

16. A method for producing biochemical analysis data in accordance with claim 9 wherein the support of the stimulable phosphor sheet is made of a material selected from a group consisting of a metal material, a ceramic material and a plastic material.

17. A method for producing biochemical analysis data in accordance with claim 7 wherein the plurality of stimulable phosphor layer regions of the stimulable phosphor sheet are formed by charging stimulable phosphor in holes formed in the support.

18. A method for producing biochemical analysis data in accordance with claim 9 wherein the plurality of stimulable phosphor layer regions of the stimulable phosphor sheet are formed by charging stimulable phosphor in holes formed in the support.

19. A method for producing biochemical analysis data in accordance with claim 17 wherein the plurality of stimulable phosphor layer regions of the stimulable phosphor sheet are formed by pressing a stimulable phosphor membrane containing stimulable phosphor in through-holes formed in the support.

20. A method for producing biochemical analysis data in accordance with claim 18 wherein the plurality of stimulable phosphor layer regions of the stimulable phosphor sheet are formed by pressing a stimulable phosphor membrane containing stimulable phosphor in through-holes formed in the support.

21. A method for producing biochemical analysis data in accordance with claim 7 wherein the support of the stimulable phosphor sheet is formed with 10 or more stimulable phosphor layer regions.

22. A method for producing biochemical analysis data in accordance with claim 9 wherein the support of the stimulable phosphor sheet is formed with 10 or more stimulable phosphor layer regions.

23. A method for producing biochemical analysis data in accordance with claim 7 wherein each of the plurality of stimulable phosphor layer regions is formed in the stimulable phosphor sheet to have a size of less than 5 mm².

24. A method for producing biochemical analysis data in accordance with claim 9 wherein each of the plurality of stimulable phosphor layer regions is formed in the stimulable phosphor sheet to have a size of less than 5 mm².

25. A method for producing biochemical analysis data in accordance with claim 7 wherein the plurality of stimulable phosphor layer regions are formed in the stimulable phosphor sheet at a density of 10 or more per cm².

26. A method for producing biochemical analysis data in accordance with claim 9 wherein the plurality of stimulable phosphor layer regions are formed in the stimulable phosphor sheet at a density of 10 or more per cm².

27. A method for producing biochemical analysis data in accordance with claim 1 wherein the sample is constituted as a biochemical analysis unit including a substrate two-dimensionally formed with a plurality of absorptive regions formed of an absorptive material to be spaced apart from each other and selectively containing a fluorescent substance fixed therein and which comprises steps of leading a stimulating ray through the light guide member, irradiating the individual absorptive regions with the stimulating ray, leading fluorescence emission released from the individual absorptive regions through the light guide member to the light detector and photoelectrically detecting the fluorescence emission by the light detector to produce biochemical analysis data.

28. A method for producing biochemical analysis data in accordance with claim 1 wherein the sample is constituted as a biochemical analysis unit including a substrate two-dimensionally formed with a plurality of absorptive regions formed of an absorptive material to be spaced apart from each other and selectively containing a labeling substance which generates chemiluminescence emission when it contacts a chemiluminescent substrate fixed therein and which comprises steps of leading chemiluminescence emission released from the individual absorptive regions through the light guide member to the light detector and photoelectrically detecting the chemiluminescence emission by the light detector to produce biochemical analysis data.

29. A method for producing biochemical analysis data in accordance with claim 27 wherein the substrate of the biochemical analysis unit has a property of attenuating light energy.

30. A method for producing biochemical analysis data in accordance with claim 28 wherein the substrate of the biochemical analysis unit has a property of attenuating light energy.

31. A method for producing biochemical analysis data in accordance with claim 27 wherein the substrate of the biochemical analysis unit has a property of reducing the energy of light to ⅕ or less when the light travels in the substrate by a distance equal to that between neighboring absorptive regions.

32. A method for producing biochemical analysis data in accordance with claim 28 wherein the substrate of the biochemical analysis unit has a property of reducing the energy of light to ⅕ or less when the light travels in the substrate by a distance equal to that between neighboring absorptive regions.

33. A method for producing biochemical analysis data in accordance with claim 27 wherein the substrate of the biochemical analysis unit is made of a material selected from a group consisting of a metal material, a ceramic material and a plastic material.

34. A method for producing biochemical analysis data in accordance with claim 28 wherein the substrate of the biochemical analysis unit is made of a material selected from a group consisting of a metal material, a ceramic material and a plastic material.

35. A method for producing biochemical analysis data in accordance with claim 27 wherein the plurality of absorptive regions of the biochemical analysis unit are formed by charging an absorptive material in holes formed in the substrate.

36. A method for producing biochemical analysis data in accordance with claim 28 wherein the plurality of absorptive regions of the biochemical analysis unit are formed by charging an absorptive material in holes formed in the substrate.

37. A method for producing biochemical analysis data in accordance with claim 35 wherein the plurality of absorptive regions of the biochemical analysis unit are formed by pressing a absorptive membrane containing an absorptive material in through-holes formed in the substrate.

38. A method for producing biochemical analysis data in accordance with claim 36 wherein the plurality of absorptive regions of the biochemical analysis unit are formed by pressing a absorptive membrane containing an absorptive material in through-holes formed in the substrate.

39. A method for producing biochemical analysis data in accordance with claim 27 wherein the plurality of absorptive regions are formed by a porous material.

40. A method for producing biochemical analysis data in accordance with claim 28 wherein the plurality of absorptive regions are formed by a porous material.

41. A method for producing biochemical analysis data in accordance with claim 27 wherein the plurality of absorptive regions are formed by a fiber material.

42. A method for producing biochemical analysis data in accordance with claim 28 wherein the plurality of absorptive regions are formed by a fiber material.

43. A method for producing biochemical analysis data in accordance with claim 27 wherein the substrate of the biochemical analysis unit is formed with 10 or more absorptive regions.

44. A method for producing biochemical analysis data in accordance with claim 28 wherein the substrate of the biochemical analysis unit is formed with 10 or more absorptive regions.

45. A method for producing biochemical analysis data in accordance with claim 27 wherein each of the plurality of absorptive regions formed in the substrate of the biochemical analysis unit has a size of less than 5 mm².

46. A method for producing biochemical analysis data in accordance with claim 28 wherein each of the plurality of absorptive regions formed in the substrate of the biochemical analysis unit has a size of less than 5 mm².

47. A method for producing biochemical analysis data in accordance with claim 27 wherein the plurality of absorptive regions are formed in the substrate of the biochemical analysis unit at a density of 10 or more per cm².

48. A method for producing biochemical analysis data in accordance with claim 28 wherein the plurality of absorptive regions are formed in the substrate of the biochemical analysis unit at a density of 10 or more per cm².

49. A scanner comprising a sample stage on which a sample two-dimensionally formed with a plurality of light releasable regions spaded apart from each other for releasing light, a light detector for photoelectrically detecting light released from the plurality of light releasable regions, a light guide member for leading light released from the plurality of light releasable regions to the light detector and a scanning mechanism for intermittently moving the light guide member and the sample stage relative to each other in a main scanning direction and a sub-scanning direction perpendicular to the main scanning direction.

50. A scanner in accordance with claim 49 wherein the light guide member has flexibility.

51. A scanner in accordance with claim 49 wherein the light guide member is formed of at least one optical fiber.

52. A scanner in accordance with claim 49 wherein the sample is regularly formed with the plurality of light releasable regions by a predetermined pitch in the main scanning direction and the sub-scanning direction and the scanning mechanism is constituted so as to intermittently move the light guide member and the sample stage relative to each other by the predetermined pitch to photoelectrically detect light released from the plurality of light releasable regions two-dimensionally formed to be spaced form each other in the sample, thereby producing biochemical analysis data.

53. A scanner in accordance with claim 49 which further comprises a stimulating ray source for emitting a stimulating ray and a stimulating ray cut filter having a property of cutting light having a wavelength of the stimulating ray and transmitting light having a wavelength of stimulated emission and wherein the sample is constituted by a stimulable phosphor including a support two-dimensionally formed with a plurality of stimulable phosphor layer regions spaced apart from each other and selectively storing radiation energy and the light guide member is constituted so as to lead a stimulating ray emitted from the stimulating ray source to the individual stimulable phosphor layer regions of the stimulable phosphor sheet placed on the sample stage and to lead stimulated emission released from the individual stimulable phosphor layer regions in response to the excitation with the stimulating ray to the light detector.

54. A scanner in accordance with claim 49 which further comprises a stimulating ray source for emitting a stimulating ray and a stimulating ray cut filter having a property of cutting light having a wavelength of the stimulating ray and transmitting light having a wavelength of stimulated emission wherein the sample is constituted by a stimulable phosphor including a support two-dimensionally formed with a plurality of stimulable phosphor layer regions spaced apart from each other and selectively storing the energy of chemiluminescence emission and the light guide member is constituted so as to lead a stimulating ray emitted from the stimulating ray source to the individual stimulable phosphor layer regions of the stimulable phosphor sheet placed on the sample stage and to lead stimulated emission released from the individual stimulable phosphor layer regions in response to the excitation with the stimulating ray to the light detector.

55. A scanner in accordance with claim 49 which further comprises a stimulating ray source for emitting a stimulating ray and a stimulating ray cut filter having a property of cutting light having a wavelength of the stimulating ray and transmitting light having a wavelength longer than that of the stimulating ray and wherein the sample is constituted as a biochemical analysis unit including a substrate two-dimensionally formed with a plurality of absorptive regions formed of an absorptive material to be spaced apart from each other and selectively containing a fluorescent substance fixed therein and the light guide member is constituted so as to lead a stimulating ray emitted from the stimulating ray source to the individual absorptive regions of the biochemical analysis unit placed on the sample stage and to lead fluorescence emission released from the individual absorptive regions in response to the excitation with the stimulating ray to the light detector.

56. A scanner in accordance with claim 49 which further comprises a position detecting means for detecting the relative positional relationship between the light guide member and the sample stage.

57. A scanner in accordance with claim 49 wherein the scanning mechanism is constituted so as to move the light guide member in the main scanning direction.

58. A scanner in accordance with claim 57 wherein the scanning mechanism includes a stepping motor for intermittently moving the light guide member in the main scanning direction.

59. A scanner in accordance with claim 49 wherein the scanning mechanism is constituted so as to move the sample stage in the main scanning direction.

60. A scanner in accordance with claim 59 wherein the scanning mechanism includes a stepping motor for intermittently moving the sample stage in the main scanning direction.

61. A scanner in accordance with claim 49 wherein the stimulating ray source is constituted as a laser stimulating ray source for emitting a laser beam.
